(19) United States
(12) Patent Application Publication
(10) Pub. No.: US 2025/0077615 A1
(43) Pub. Date: Mar. 6, 2025

(54) METHOD AND APPARATUS FOR WEIGHT-STATIONARY DIRECT CONVOLUTION CALCULATION

(71) Applicant: NVIDIA Corporation, Santa Clara, CA (US)

(72) Inventors: Manan PATEL, Santa Jose, CA (US); Jack CHOQUETTE, Palo Alto, CA (US); Alexander L. MINKIN, Los Altos, CA (US); Maciej Tyrlik, Santa Clara, CA (US)

(21) Appl. No.: 18/458,638

(22) Filed: Aug. 30, 2023

(51) Int. Cl. G06F 17/15; G06F 17/16

(52) U.S. Cl. CPC G06F 17/153; G06F 17/16

(57) ABSTRACT

Systems and methods for efficient convolution based on matrix multiply and add (MMA) are described. An example processor having a plurality of processing lanes is configured to perform convolution of a matrix of activation elements and a filter matrix in accordance with a configurable series of instructions including a plurality of MMA instructions and shift instructions while reusing activation elements already loaded to the processor or associated memory over a plurality of MMA operations. The filter elements are held stationary at inputs to the processor for multiple cycles for multiple MMA operations while activations are streamed in. Associated methods are also described.

### CROSS-REFERENCES TO RELATED APPLICATIONS

This application is related to the commonly-assigned copending U.S. patent application Ser. No. 18/449,381 titled “Method and Apparatus for Direct Convolution Calculation” and filed Aug. 14, 2023, the entire contents of which is incorporated by reference.

### FIELD

This technology generally relates to improving processing efficiency. More particularly, the technology herein relates to specialized circuitry for handling convolutions using matrix multiply operations.

### BACKGROUND

Convolutional neural networks (CNN) are one of the key applications in the deep learning domain. A CNN is a class of artificial neural network that uses convolutional layers to filter inputs for useful information. A CNN is composed of an input layer, an output layer, and one or more hidden layers, and is different than other neural networks in that the neurons in its layers are arranged in three dimensions (width, height, and depth dimensions). This allows a CNN to transform an input volume in three dimensions to an output volume. CNNs may use multiple convolution layers to filter input volumes to greater levels of abstraction.

The convolution operation in a CNN involves combining (convolving) input data (feature map) with a convolution kernel (filter) to form a transformed feature map. The filters in the convolutional layers (conv layers) may be modified based on learned parameters to extract the most useful information for a specific task. Convolutional networks adjust automatically to find the best feature based on the task.

Example applications of CNNs include image (image recognition, image classification, video labeling, text analysis) and speech (speech recognition, natural language processing, text classification) processing systems, along with state-of-the-art AI systems such as robots, virtual assistants, and self-driving cars.

In CNNs, one-dimensional (1D), two-dimensional (2D), and three-dimensional (3D) convolution layers contribute to most of the floating-point operations per second (flops). As a result, it is important for deep learning (DL) hardware to provide efficient acceleration mechanisms for convolutions.

To accelerate convolution layers, previous approaches have proposed dedicated hardware units or application specific integrated circuit (ASIC) designs to natively support convolutions. While these designs can accelerate all convolution kernels, they cannot support other types of deep neural networks (DNNs), such as recurrent neural networks (RNNs), transformers, recommendation systems, etc., without having the user modify the original DNN algorithm to use these convolution units, which would likely result in less efficient systems.

Instead, commercial DL accelerators adopt tiled matrix-multiplication hardware accelerators, such as the systolic array in Google Tensor Processing Units® (TPUs) or the Tensor Core® in some NVIDIA GPUs to accelerate all DNNs, since most compute-intensive kernels in DNNs can be transformed into general matrix-matrix multiplications (GEMM). Convolutions in CNNs can be transformed into GEMMs by a process called “image-to-column”, or “im2col”, which replicates some pixels in the input image to form a new input matrix to be used in the multiplication.

A potential downside of the im2col transformation is that it increases the required memory footprint and data movement traffic when compared to performing convolutions directly. Therefore, the existing approaches with tiled GEMM accelerators suffer from the extra memory footprint and memory traffic due to the im2col transformation. Some state-of-the-art solutions attempt alleviate this issue by performing im2col transformation on-demand (e.g., implicit GEMM in NVIDIA Hopper® GPUs), through software-based solutions (e.g., cuDNN for NVIDIA Volta®/Ampere® GPUs) or hardware-based im2col unit (the im2col mode of the TMA unit in NVIDIA Hopper GPU and the im2col unit in Google TPU®). While they avoid the extra traffic at some of the levels in the memory hierarchy by performing the transformation on-the-fly, they do not eliminate the problem completely.

FIG. 1A illustrates the concept of convolution in a CNN. A convolution is performed by multiplying a first matrix 102, which may be referred to as an “input activations matrix” or “activations matrix”, with a second matrix 104, which may be referred to as a “weights matrix”, to produce a third matrix 106. The third matrix 106 is referred to as a “results matrix” or “output matrix”. The convolution operation comprises performing matrix multiply and add (MMA) operations to obtain the output matrix 106 from the dot product of the activations matrix 102 and the weights matrix 104.

In essence, DL convolutions (that are also known as cross-correlations) are linear operations involving a set of input activations (IA) and filters. More specifically, convolution involves multiplying multiple sets of weights (e.g., K weight matrices 104) with an input (e.g., activation matrix 102), conceptually like a traditional neural network (NN) layer. Each weights matrix 104 may also be referred to as a “filter”.

The calculation proceeds by applying a filter (the weight matrix 104, which is smaller than the input matrix) to the input activations matrix in a dot product (e.g., element-wise multiplication, and accumulated in the results matrix as a sum) to obtain a scalar output. The filter is applied systematically to each of overlapping regions or filter-sized patches of the input data. When considering the input activations matrix in 2D, the applying of the filter starts at the top left of the input activations matrix 102 and proceeds left to right, and top to bottom. The applying of the filter may be affected by one or more parameters such as dilation, stride, and padding that may be configurable.

In some examples, an input may be an “image” of H×W×C (height×width×channels) dimensions. The height and width may represent the height and width of the image in pixels, and the channels may each represent some property (e.g., red, green, blue components) of the image. The entire input to a convolution may comprise N number of images, where N is any number greater than 0. The weights may be referred to as a R×S×C (R and S being spatial dimensions, and the number of channels matching the number of channels in the input) filter. K weight matrices may be involved in the convolution, with each of K features being considered being represented by a respective weight matrix. The output is an “image” of P×Q×K, where P and Q are spatial dimensions and K represents the number of filters (K is also referred to as the convolution dimension). P and Q dimensions depend on the dimensions of the input activations matrix and the dimensions of the filter(s). For example, H,W==P,Q if input has [R/2]×[S/2] image halo and stride=1. An “image halo” is a region surrounding a tile that contains shared elements due to overlap.

The highlighted portions 108 and 110 in FIG. 1A illustrates that the value of output element 108 in the output matrix 106 is affected by block 110 in the input matrix 102 the filter 104. That is, when a filter 104 of the size 3×3 as shown is used, each input element in the area 110 of the activation matrix 102 contributes to the value of the output matrix element 108. When N input images 102, each having H×W×C dimensions, are multiplied with K 3×3 filters 104, each having R×S×C dimensions, N output images 106 are produced, each having P×Q×K dimensions.

FIG. 1B shows another conceptual example of a convolution operation setup with multiple (K) filters and an input image that is 6×6 including a 1-pixel wide halo being illustrated. The input image comprises 4×4 image pixels surrounded on the sides, top and bottom by a 1-pixel wide halo, thus yielding H×W dimensions 6×6. The K filters are of the fixed dimensions R×S being 3×3. The input activations matrix and the filters each have C channels. The output matrix is of dimensions P×Q×K where P=Q=4. As noted in the figure, H=P+2 and W=Q+2, where 2 is the number of halo pixels in the input activation matrix in each dimension.

FIGS. 2A-2B illustrates a sequence of snapshots in an example convolution process as a 3×3-pixel filter 208 is applied with a stride of 1 to the 7×7 pixel input activations matrix 206 which comprises a 5×5 pixel image 202 and a 1-pixel wide image halo 204. The sequence begins with filter 208 being positioned at the top left pixel of the input activations matrix 206. In this position, since the input image has a 1-pixel image halo, the middle of the 3×3 filter 208 is positioned directly over the top left pixel of 5×5 input image 202. As illustrated, when filter 208 is positioned at the top left pixel of input image 202, each of the elements in the input activations matrix 206 that are overlapped by the filter 208 contributes to the value of element 212 in the output matrix 210. The sequence in FIGS. 2A-2B illustrates how, as the filter 208 moves from left to right and top to bottom of the input activations matrix 206 with a stride of 1, each element (e.g., 212) in the output matrix 210 is affected by a set of elements in the input activation matrix 206 that includes the input image 202 and the image halo 204.

The first five instances of the sequence shown in FIG. 2A illustrate filter 208 being moved from the left end of the top row in the input activations matrix 206, one column at a time, to the right end of the top row. After the filter reaches the right end of the top row, conceptually, the filter is moved (shifted) 1 row down over input activations matrix 206. This shifting is conceptually illustrated in the transition between the fifth and sixth snapshots of the sequence as shown in FIG. 2A.

The second and third snapshots in the portion of the sequence shown in FIG. 2B, illustrate the filter reaching the right-most end of one row before the last row of the input activations matrix 206 and then moving (shifting) a row down to left end in the last row of the input activations matrix 206. Subsequently, as illustrated by the last snapshot of the sequence shown in FIG. 2B, filter 208 reaches the bottom right element of the input activations matrix 206.

As can be seen in the sequence shown in FIG. 2A-2B, each element in output matrix 210 is affected by a particular set of elements in the input activations matrix 206 and that the particular set of determined by the dimensions of the filter 208.

Although existing hardware-supported MMA operations enabled significant speed and scale improvements in previous GPU generations, further improvements are desired including in, for example, MMA used in convolution.

### BRIEF DESCRIPTION OF THE DRAWINGS

FIG. 1A shows a conceptual view of a convolution operation implemented as a matrix multiplication in an example application running on a GPU.

FIG. 1B shows a conceptual view of a convolution operation using multiple filters.

FIGS. 2A-2B show a sequence of snapshots illustrating an example application of a filter to an input activations matrix in a convolution operation.

FIGS. 3A-3D illustrate example convolution MMA operation in accordance with some embodiments of this disclosure.

FIG. 4 conceptually illustrates the evolution of aspects of memory traffic in MMA operations including in some example embodiments of this disclosure.

FIGS. 5A-5C illustrate a processor including a plurality of datapath lanes according to some embodiments of this disclosure.

FIGS. 5D-5H graphically illustrate the handling of operands at the two input interfaces of an example datapath processor, in accordance with some embodiments of this disclosure.

FIG. 6A illustrates reusing of input activations in the datapath, according to some embodiments of this disclosure.

FIG. 6B shows a sequence of instructions in pseudocode for performing weight-stationary convolution MMA, according to some embodiments of this disclosure.

FIG. 6C graphically illustrates the status of inputs to the datapath (e.g., datapath shown in FIGS. 5A-5C) during the sequence of instructions shown in FIG. 6B, according to some embodiments of this disclosure.

FIG. 6D illustrates an example programming model according to some example embodiments of this disclosure.

FIGS. 7A-7C illustrate a convolution MMA operation in accordance with some example embodiments of this disclosure.

FIGS. 8A-8J illustrate an example of the input activation layouts in global memory, shared memory, and tensor memory, and further illustrates a result matrix during execution of a sequence of instructions according to some embodiments of this disclosure.

FIG. 9A illustrates input tensor layouts in 3D space and its mapping to 2D space according to some embodiments of this disclosure.

FIG. 9B illustrates two example layouts of an example input activation vector according to some example embodiments of this disclosure.

FIG. 9C illustrates an example input activation vector layout in global memory and in shared memory according to some example embodiments of this disclosure.

FIGS. 9D-9E illustrate a first mode in which the input data is obtained from global memory and written to shared memory and then to tensor memory according to some example embodiments of this disclosure.

FIG. 9F illustrates an activation vector as a convolution MMA operation proceeds according to some example embodiments this disclosure.

FIGS. 9G-9H illustrate a second mode in which the input data is obtained from global memory and written to shared memory and then to tensor memory according to some example embodiments of this disclosure.

FIGS. 9I-9J illustrate a third mode in which the input data is obtained from global memory and written to shared memory and then to tensor memory according to some example embodiments of this disclosure.

FIGS. 9K, 9L (A) and 9L (B) illustrate a fourth mode in which the input data is obtained from global memory and written to shared memory and then to tensor memory according to some example embodiments of this disclosure. FIG. 9L (A) and FIG. 9L (B) are collectively referred to as FIG. 9L.

FIG. 10 illustrates an example parallel processing unit of a GPU, according to some embodiments.

FIG. 11A illustrates an example general processing cluster (GPC) within the parallel processing unit of FIG. 10, according to some embodiments.

FIG. 11B illustrates an example memory partition unit of the parallel processing unit of FIG. 10.

FIG. 12A illustrates an example streaming multiprocessor (SM) of FIG. 11A with MMA state machine circuitry, according to some embodiments.

FIG. 12B conceptually illustrates four subpartitions implemented in an SM such as the SM shown in FIG. 12A, according to some embodiments.

FIG. 13A is an example conceptual diagram of a processing system implemented using the parallel processing unit (PPU) of FIG. 10.

FIG. 13B is a block diagram of an exemplary system in which the various architecture and/or functionality of the various previous embodiments may be implemented.

### DETAILED DESCRIPTION OF EXAMPLE NON-LIMITING EMBODIMENTS

This disclosure is directed, in some embodiments, to improving the energy efficiency and performance, in computer systems, of convolutions that include MMA operations of the form D=A*B+C, where A, B, C and D are matrices (Equation #1). Application programs that utilize Equation #1 typically perform a number of matrix multiply operations where result (D) of one matrix multiply is used as input (C) to a subsequent matrix multiply.

Embodiments of this disclosure allow tiled GEMM accelerators, like, but not limited to, NVIDIA tensor cores, to perform direct convolutions. Specifically, some embodiments provide for certain data movement operations required in a systolic-array-based tiled GEMM accelerator to perform convolutions natively. It is expected that embodiments of the present disclosure can provide substantial performance improvement over existing technologies. For example, in a 3×3 convolution layer, about a 9-fold traffic reduction for input activations and a 30% end-to-end performance improvement for DNN inference can be achieved on future NVIDIA tensor core GPUs according to some embodiments of this disclosure, when compared to previous NVDIA GPUs that used the so-called im2col-based method. Additionally, some embodiments provide improved power efficiencies by taking into consideration the differences in spatial continuity of activations and weights in the assigning of the inputs of the datapath processor.

In some embodiments, data movement operations that are provided for enabling direct convolution in a processor that includes a systolic array include:
1. Peer-to-peer data transfer (e.g., a shift operation, provided by, for example, shift instruction) in a particular hardware dimension (e.g., the hardware dimension for the GEMM-M dimension) between hardware units in the systolic array;
2. Parametrized data transfer from an external memory unit to specific sets of hardware units in the systolic array, including copy to all units (e.g., provided by copy instruction to load entire activation vector) in the systolic array, to just one hardware unit (e.g., provided by copy instruction to load one or more individual elements of activation vector) in the systolic array (in particular (and common) cases, and, optionally, load instructions can be associated with an offline-determined bitmask that controls whether a hardware unit updates its corresponding output, which reduces the overhead (instructions and re-accessing halos) of the load operations), or optionally to a subset of units with a particular stride pattern (e.g., load instruction specifying a plurality of elements to be copied); and
3. Optionally, data transformation of the original input image into a particular layout in the external memory unit, such that the parametrized data copy can be more efficient (e.g., W128 mode of the Tensor Memory Access unit (TMAU) 1141).

In example embodiments, along with the GEMM operation supported by the tiled GEMM accelerator, these data movement operations are used to form a sequence of operations that perform direct convolution without the extra data movement traffic and memory footprint that was required in other processors, including, for example, the previous versions of NVIDIA Tensor Core GPUs (e.g., NVIDIA Hopper and NVIDIA Ampere GPUs) that perform im2col-based methods. U.S. application Ser. Nos. 17/691,422, 17/691,422 and 17/691,406, which are hereby incorporated by reference in their respective entireties, describe the tiled and im2col-based methods in some existing implementations.

Some example embodiments also provide for extending the above operation sequence to support 2D convolutions in use cases when the image width is smaller than the GEMM-M dimension of the tiled GEMM accelerator, and for use cases requiring support for convolutions with stride and dilation larger than one. Consequently, a tiled GEMM accelerator according to example embodiments can perform any convolutions natively with no extra transformation and data movement.

### Overview of Convolution

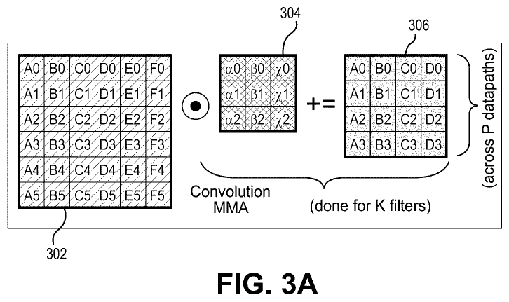

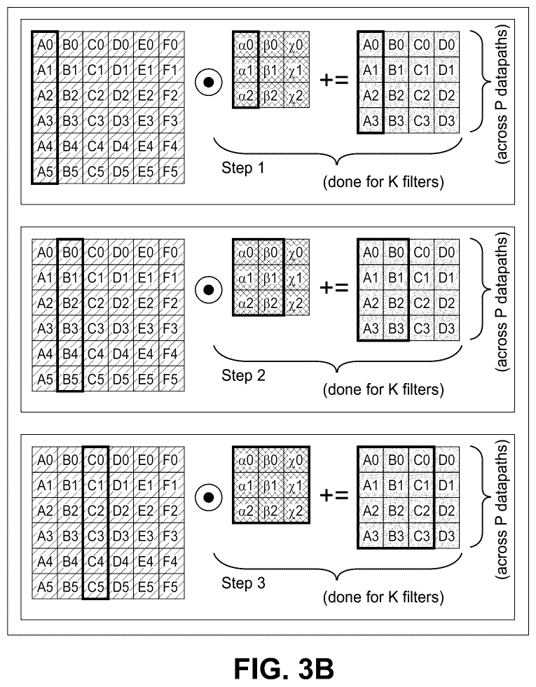

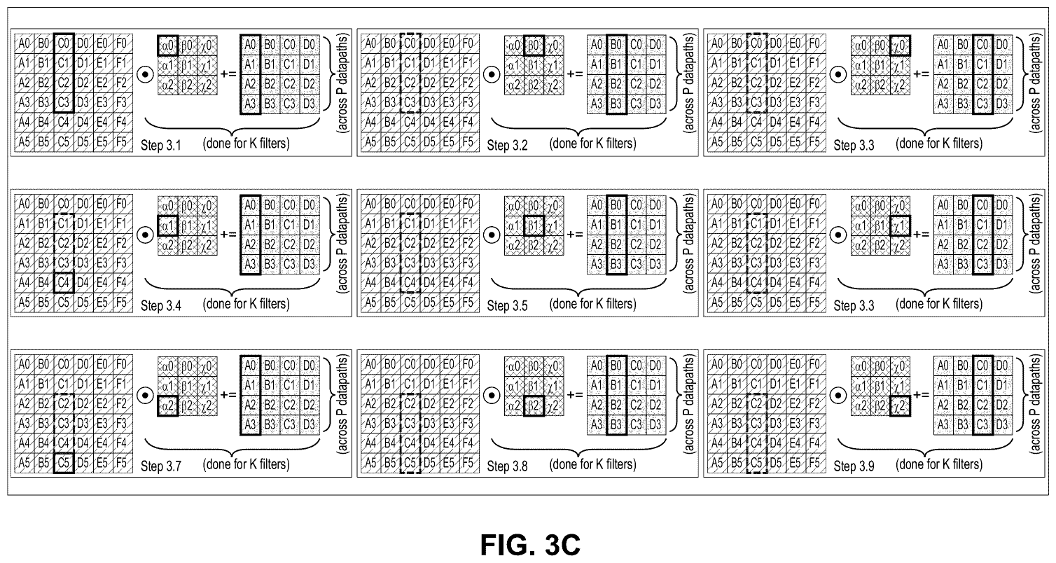

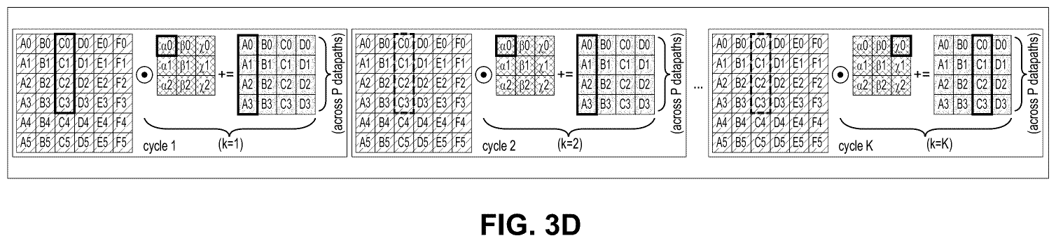

FIGS. 3A-3D illustrate a high-level conceptual walkthrough of a convolution operation according to some embodiments.

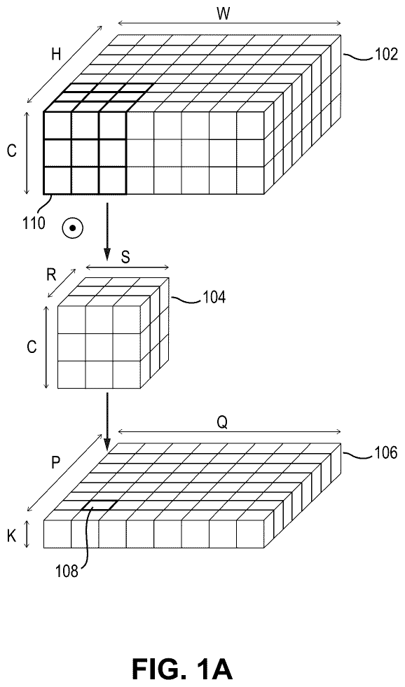

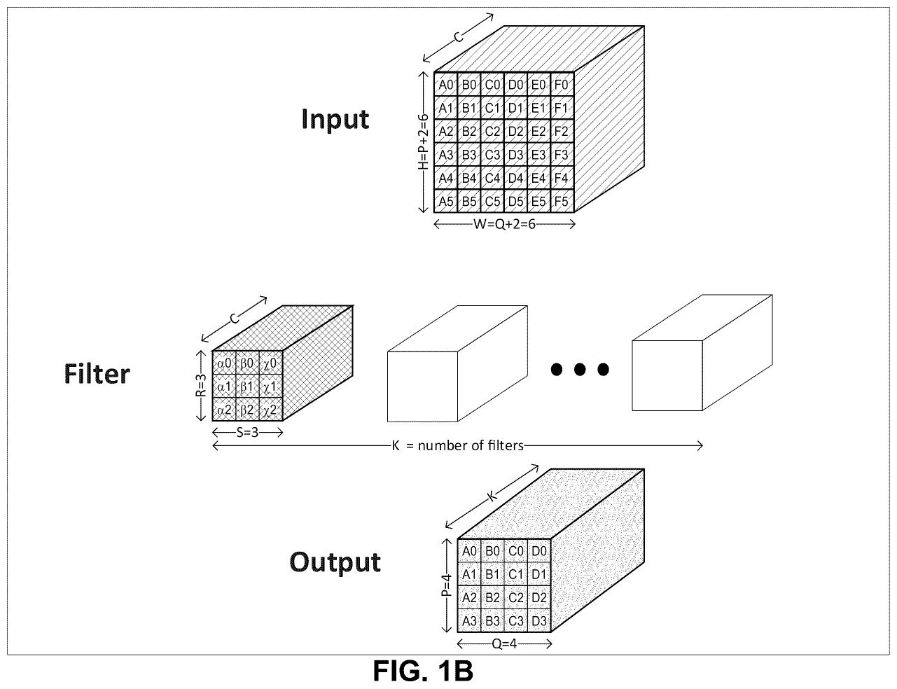

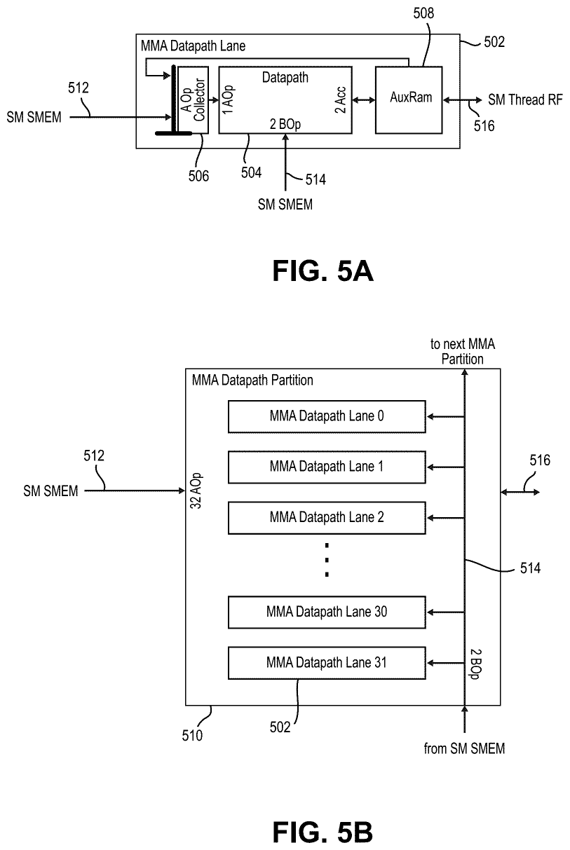

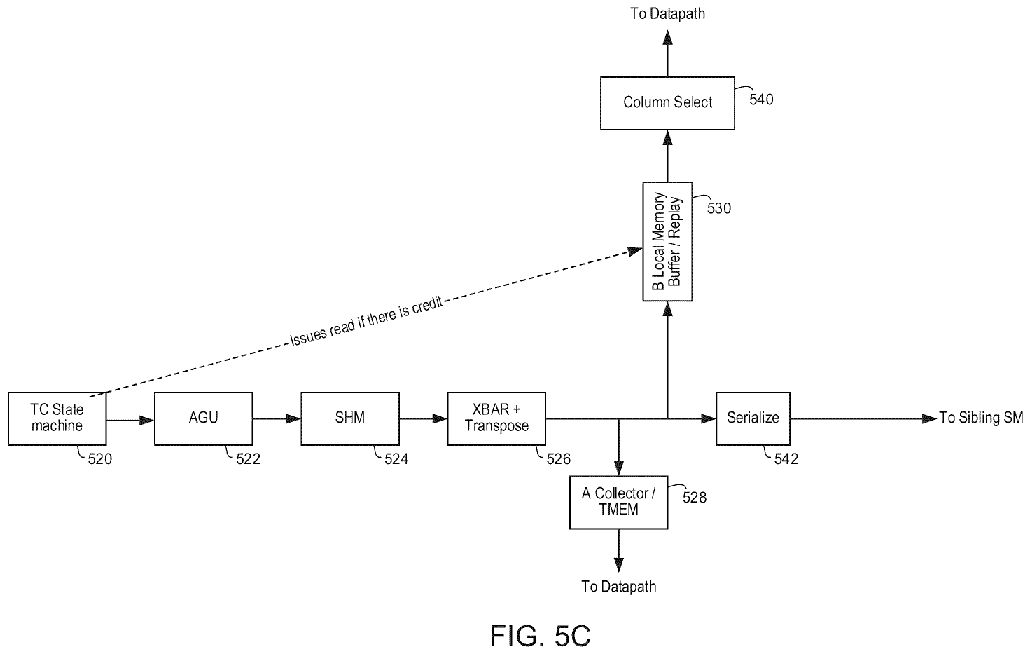

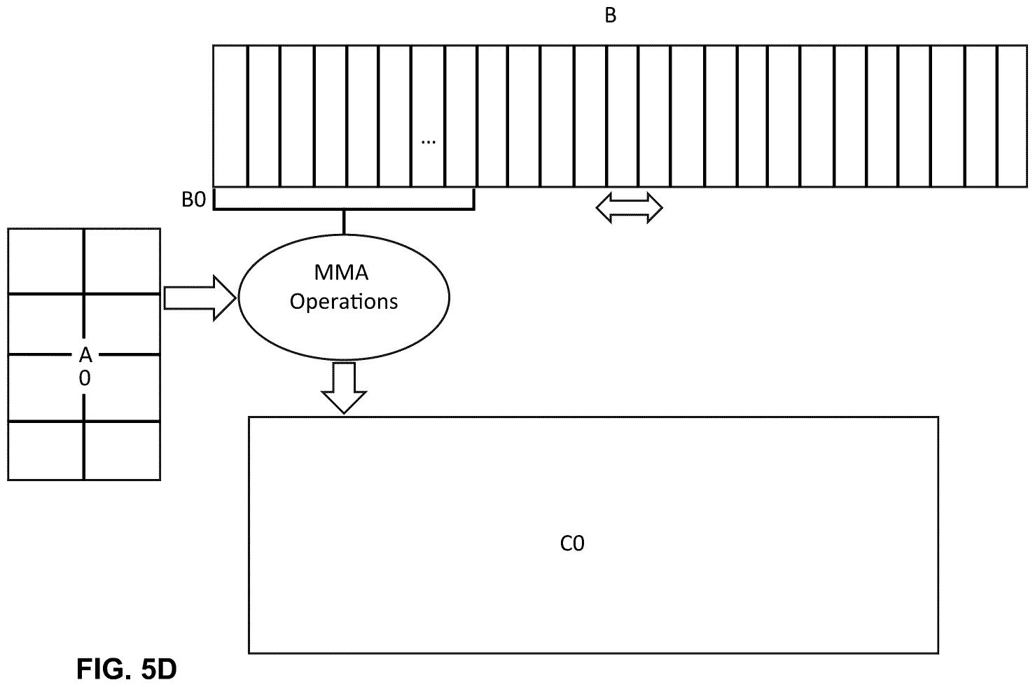

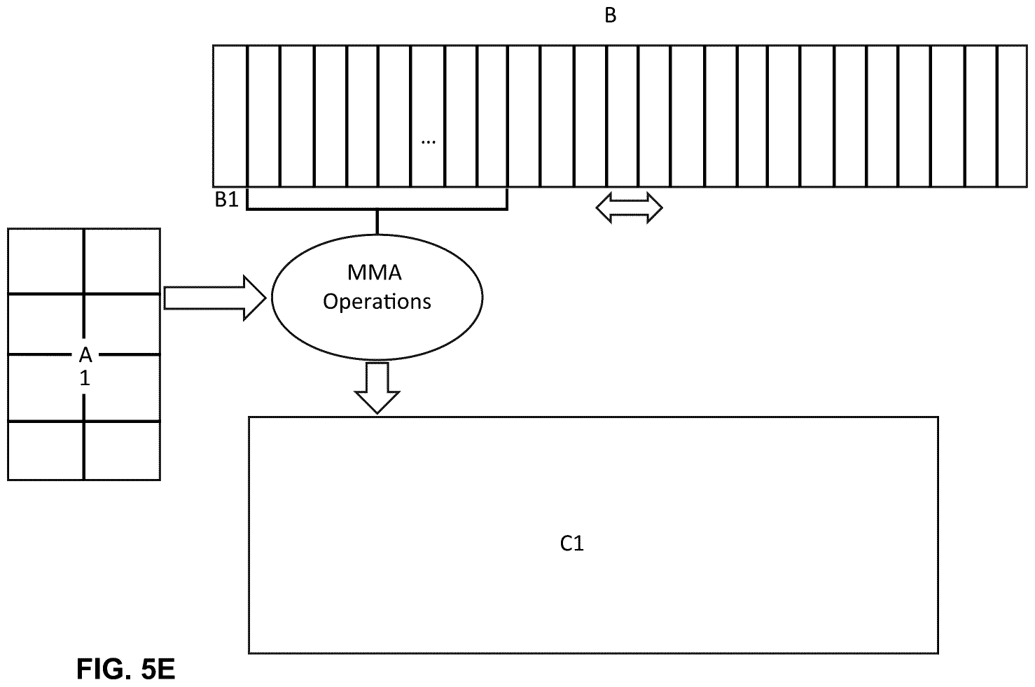

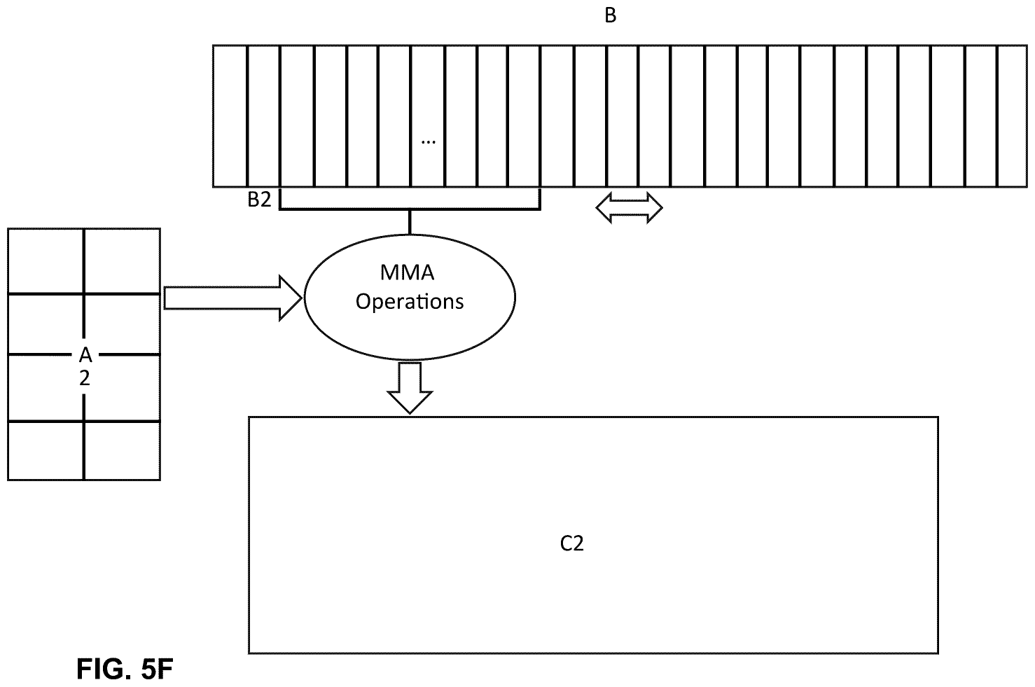

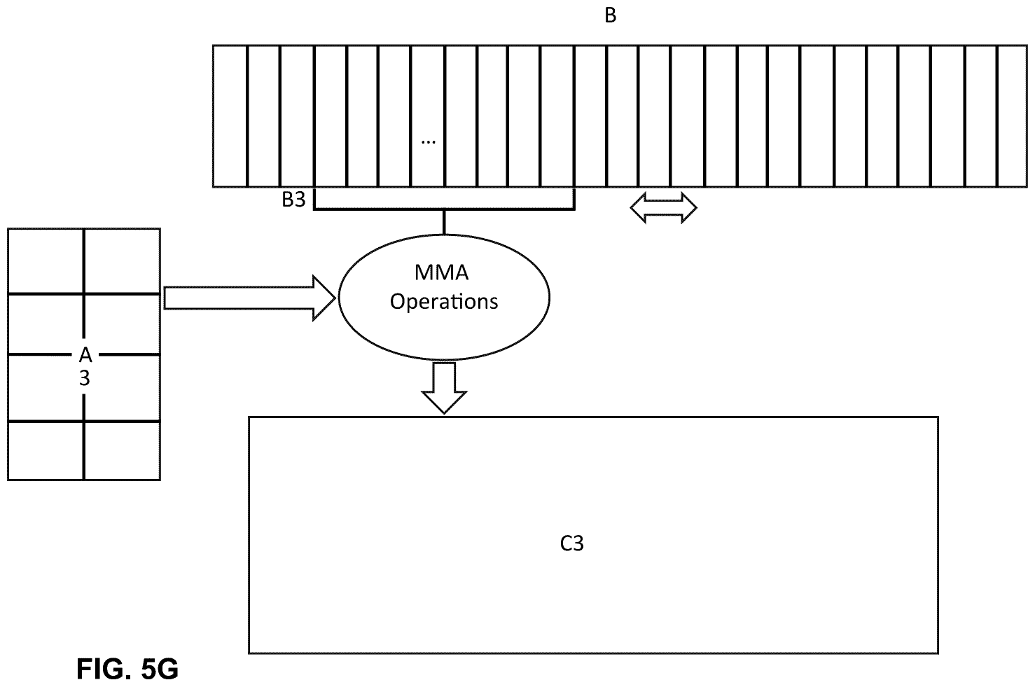

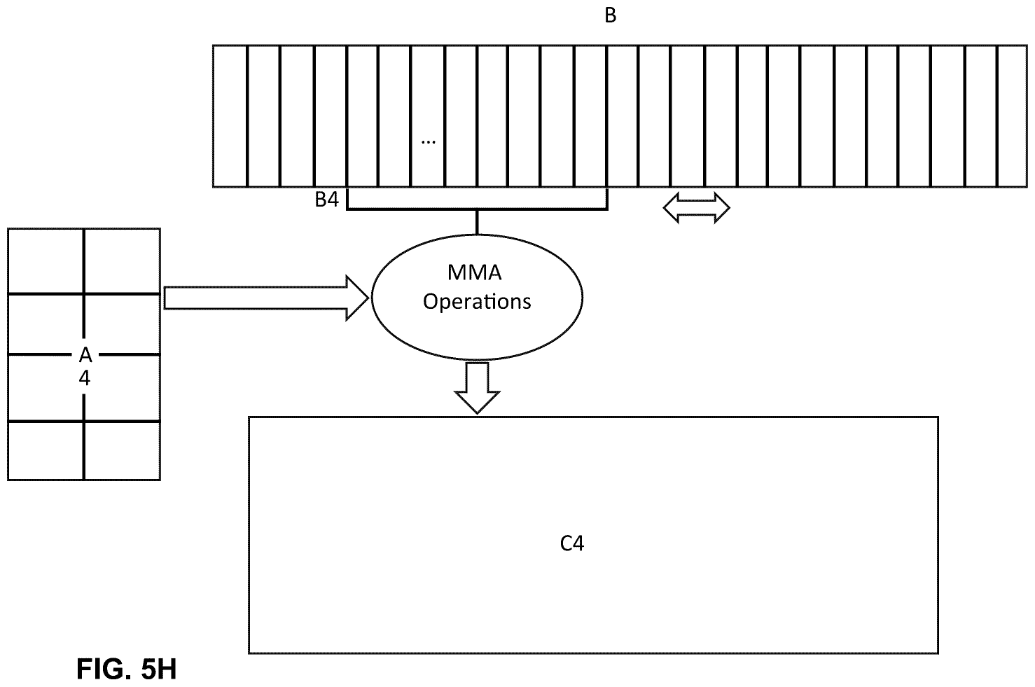

As described above, a convolution operation comprises, for a set of input activations 302, performing matrix multiplication (e.g., dot product) with a weights matrix (also referred to as “filter matrix”) 304, and accumulating the result in an accumulator 306. The view shown in FIG. 3A is a 2D representation of the 3D convolution operation shown in FIG. 1B in that what is shown in FIG. 3A is the convolution operation for one input (e.g., an input activation, an input image), one filter (e.g., a convolution filter), and one output. An example processing of the convolution in datapath circuitry according to some example embodiments is described below in relation to FIGS. 5A-5C.

FIGS. 1C-1D above visually illustrated the movement of a filter matrix across an input activations matrix during a dot product computation of the input activations matrix and the weights matrix in a convolution operation. FIG. 3B illustrates a dissection of the convolution operation shown in FIG. 3A, with three suboperations (Step 1-3) of the dissection being shown. Each of the solid line rectangles within the input activations, filter and accumulator matrices represent matrix elements (e.g., pixels) that are either involved in or are affected by the respective suboperation. Suboperation Step 1 shows that the dot product computation of the leftmost column of the input activations matrix and the leftmost column of the weights matrix affects (e.g., modifies values in) the leftmost column of the accumulator matrix. It should be noted that the first column of the input activation matrix can affect the accumulator matrix values only when the left column of the filter matrix is aligned with the left column of the input activations matrix.

Suboperation Step 2 shows that the dot product of the second column of the input activations matrix and the leftmost two columns of the weights matrix result in affecting the first two columns in the accumulator matrix. That is, the second column of the input activations contributes to the accumulator matrix values when the weights matrix is such that its left column is aligned with the left column of the input activations matrix and when the weights matrix is shifted horizontally one column such that its left column is aligned with the second column of the input activations matrix.

Suboperation Step 3 shows the dot product of the third column of the input activations matrix and the first three columns of the weights matrix (this happens to be the entire example weights matrix, which is a 3×3 matrix), affects the first three columns from the left in the accumulator matrix. That is, the third column of the input activations contributes to the accumulator matrix values when the filter matrix is such that its left column is aligned with any of the first three columns (from the left) of the input activations matrix.

As described above, FIG. 3B shows, for a given column in the input activations matrix and weights matrix, the accumulator matrix elements that are affected when all the weights are considered. It may be noted that this representation is in contrast with the representation in FIG. 1A, where the solid line rectangles were used to indicate which of the input matrix elements were involved in producing the one highlighted element in the output matrix.

Steps 1-2, which illustrate the impact of boundary columns, may be considered corner cases in the convolution operation, whereas Step 3 is illustrative of the steady state. Example embodiments, for the illustrated sizes of matrices (e.g., 3×3 weights matrix), can achieve 3× and 6× reuse for boundary columns of the input activations, and 9× (perfect reuse for the illustrated matrix dimensions) reuse for the internal columns.

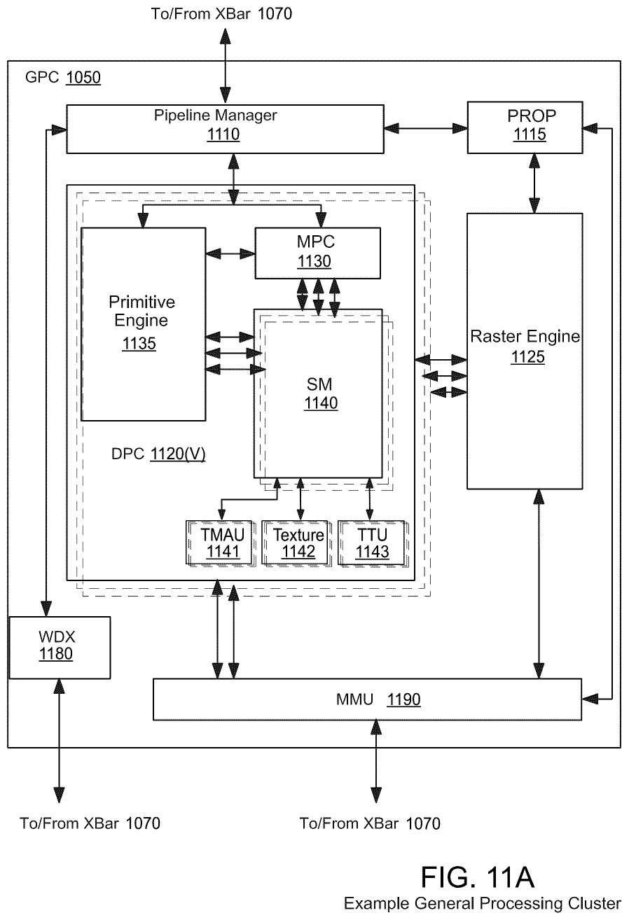

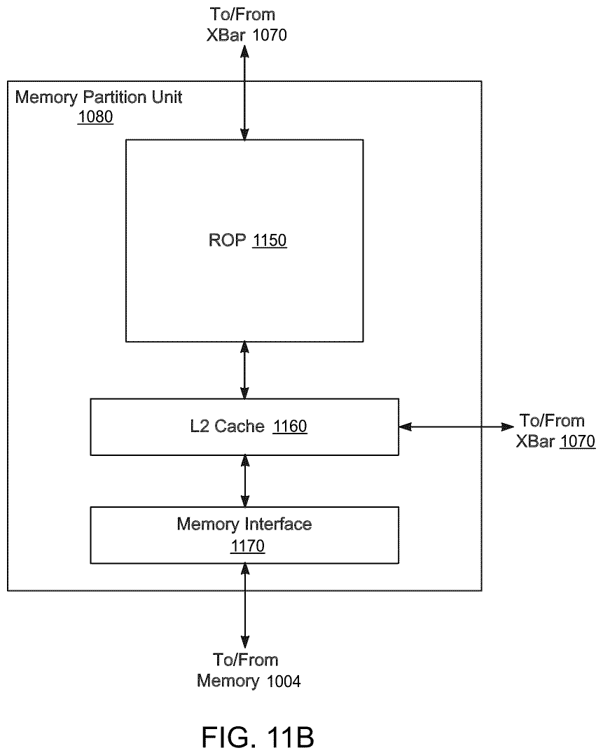

In an embodiment, the convolution operation of the activation matrix and filter(s) shown in FIGS. 3A-3D is performed in a system such as the streaming multiprocessor (SM) 1140 shown in FIG. 11A by a processing core 1250 which includes datapath processing circuitry such as the datapath processor 504 shown in FIG. 5B. The datapath processor 504 may access shared memory (SMEM) 1270, an optional tensor memory (TMEM) 1251, and a register file (RF) 1220.

FIG. 3C illustrates step-by-step dissection of the Step 3 suboperation in FIG. 3B. The sub-steps (i.e., steps 3.1-3.9) show how the calculation of the multiplication of the third column of the input activation matrix with the filter is performed, and what elements of the accumulator are affected at each sub-step. It also illustrates the elements of the input activation that are reused from within the local memory buffer accessed by the datapath and those that are loaded or reloaded to the local memory buffer accessed by the datapath from another memory (e.g., SMEM, register file) during the progression of steps of the dissection—the solid-line rectangles within the matrices indicate elements being loaded/reloaded from another memory (e.g., SMEM, register file, etc.) and the dashed-line rectangles indicate elements that are reused. For example, elements C0-C3 are newly obtained from SMEM in sub-step 3.1 (and therefore a solid-line rectangle contains C0-C3 in sub-step 3.1 illustration), and in sub-step 3.2 the C0-C3 elements that were previously obtained from another memory in sub-step 3.1 is reused (and therefore a dashed-line rectangle contains C0-C3 in sub-step 3.2 illustration).

As noted above, it is assumed that at each sub-step of the dissection in this example a vector of 4 elements of the third column in the input activation matrix is multiplied with an element from a weight from the filter matrix. As shown in sub-step 3.1, the multiplication of C0-C3 elements of the input matrix with the α0 element of the weights affects (e.g., contributes to) the values in the A0-A3 elements in the accumulator. At sub-step 3.2, the same C0-C3 input activation elements are multiplied by β0 in the weights affecting B0-B3 in the accumulator. At sub-step 3.3, the same C0-C3 input activation elements are multiplied by χ0 in the weights affecting B0-B3 in the accumulator. The illustrations of sub-steps 3.1-3.3 show that as the selected portion of the third column of input activations is multiplied by elements across the first row of the weights, the input activation elements were newly loaded from another memory at sub-step 3.1 (as indicated by the solid-line rectangle) and then reused (i.e., were not required to be reread from another memory such as SMEM or register file) in sub-steps 3.2 and 3.3 (as indicated by the dashed-line rectangles). In an example embodiment, the weight elements used for sub-steps 3.1-3.3 are loaded once for each step and held constant at the A-input of the datapath for K filters in each step.

The next multiplication, however, is with the second row of the weights, and thus does not involve the C0 element. Therefore, in embodiments, the selected portion of the input activation column is shifted down one element-thereby causing a new element, C4, to be read from the other memory (e.g., SMEM or register file) and C0 to be shifted out. After new input activation element C4 is read, then sub-steps 3.4-3.6 proceeds in a similar manner to sub-steps 3.1-3.3, multiplying the selected input activation elements C1-C4 with the second row of weights α1, β1, χ1 affecting A0-A3, B0-B3 and C0-C3 at respective sub-steps 3.4-3.6. In an example embodiment, the weight elements used for sub-steps 3.4-3.6 are loaded once at the beginning of step 3.4 and held constant at the A-input of the datapath for sub-steps 3.4-3.6.

After sub-step 3.6, for sub-step 3.7, again the selected portion of the input elements is shifted down and another new element, C5, is read in from another memory and C1 is shifted out. After new input activation element C5 is read, then sub-steps 3.7-3.9 proceeds in a similar manner to sub-steps 3.1-3.3, multiplying the selected input activation elements C2-C5 with the third row of weights α2, β2, χ2 affecting A0-A3, B0-B3 and C0-C3 at respective sub-steps 3.7-3.9. In an example embodiment, the weight elements used for sub-steps 3.7-3.9 are loaded once at the beginning of step 3.7 and held constant at the A-input of the datapath for sub-steps 3.7-3.9.

From the above description, it is shown that at each step a weight is read and used. For the illustrated sub-steps 3.1-3.9, each weight is not used in more than one sub-step, and therefore each weight is read once and is not reused. The accumulator affected elements are read each step. It should be noted that the bandwidth savings compared to previous systems are primarily obtained from the reading and reusing of the input activations and also by reducing the bandwidth required to load the weight elements by holding loaded weights constant at the A-input of the datapath for several multiplication operations/clock cycles. Example embodiments, by receiving the weight elements at the A-input (which is configured as the stationary input) of the datapath while also having the capability to reuse activation elements, take advantage of the higher spatial continuity of activation elements when compared to the weight elements. For example, spatial continuity may result into less number of bits toggling between two activations next to each other compared to two consecutive weights.

It should be noted that the illustration of FIGS. 3A-3C is a 2D representation of the 3D representation of matrices shown in FIG. 1B. As such it should be noted that the 4×1 vector of input activations (e.g., C0-C3) is in an actual implementation a 4×1×C matrix for which the dot product is calculated with a 1×C weight matrix to contribute to a 4×1×C accumulator matrix, where C is the number of channels in the input activations.

It should be noted that the computations of sub-steps 3.1-3.9 are performed for each of the K filters. Thus, the reuse illustrated in FIG. 3C is effective for each of the K filters.

Sub-steps 3.1-3.9 may correspond to an instruction sequence such as the following:
Step 3.1: load activation elements C0-C3; execute convolution MMA operation using a 4-element activation vector C0-C3 and the first element of the first row of the filter (e.g., load instruction to load an input activation vector from SMEM to datapath input memory; weight-stationary convolution MMA instruction)
Step 3.2: execute convolution MMA operation using activation elements C0-C3 and the second element of the first row of the filter (e.g., weight-stationary convolution MMA instruction)
Step 3.3: execute convolution MMA operation using activation elements C0-C3 and the third element of the first row of the filter (e.g., weight-stationary convolution MMA instruction)
Step 3.4: shift the activation vector by one element (e.g., discarding C0), load C4 at the other end of the 4-element activation vector, and execute convolution MMA operation using activation elements C1-C4 and the first element of the second row of the filter (e.g., shift instruction to shift vector of input activations in datapath input memory); load instruction to load one input activation vector element from SMEM to datapath input memory; weight-stationary convolution MMA instruction).
Step 3.5: execute convolution MMA operation using activation elements C1-C4 and the second element of the second row of the filter (e.g., weight-stationary convolution MMA instruction)
Step 3.6: execute convolution MMA operation using activation elements C1-C4 and the third element of the second row of the filter (e.g., weight-stationary convolution MMA instruction)
Step 3.7: shift the activation vector by one element (e.g., discarding C1), load C5 at the other end of the 4-element activation vector, and execute convolution MMA operation using activation elements C2-C5 and the first element of the third row of the filter (e.g., shift instruction to shift vector of input activations in datapath input memory; load instruction to load one input activation vector element from SMEM to datapath input memory; weight-stationary convolution MMA instruction)
Step 3.8: execute convolution MMA operation using activation elements C2-C5 and the second element of the third row of the filter (e.g., weight-stationary convolution MMA instruction)
Step 3.9: execute convolution MMA operation using activation elements C2-C5 and the third element of the third row of the filter (e.g., weight-stationary convolution MMA instruction). This completes a traversal of the all elements of a filter with respect to an activation vector of C-elements.

Another type of instruction (e.g., UTMALDG, UTMALDG.w128) may cause a TMAU (e.g., TMAU 1141) to copy input activation data from external/global memory (GMEM) to SMEM, prior to step 3.1 above. This instruction may provide for transferring image elements within the bounding boxes defined for one or more images from GMEM to SMEM, plus additional pixels or vectors containing refresh pixels. These new values can be appended to the target shared memory region in a specific layout in order to compute the addresses efficient in software.

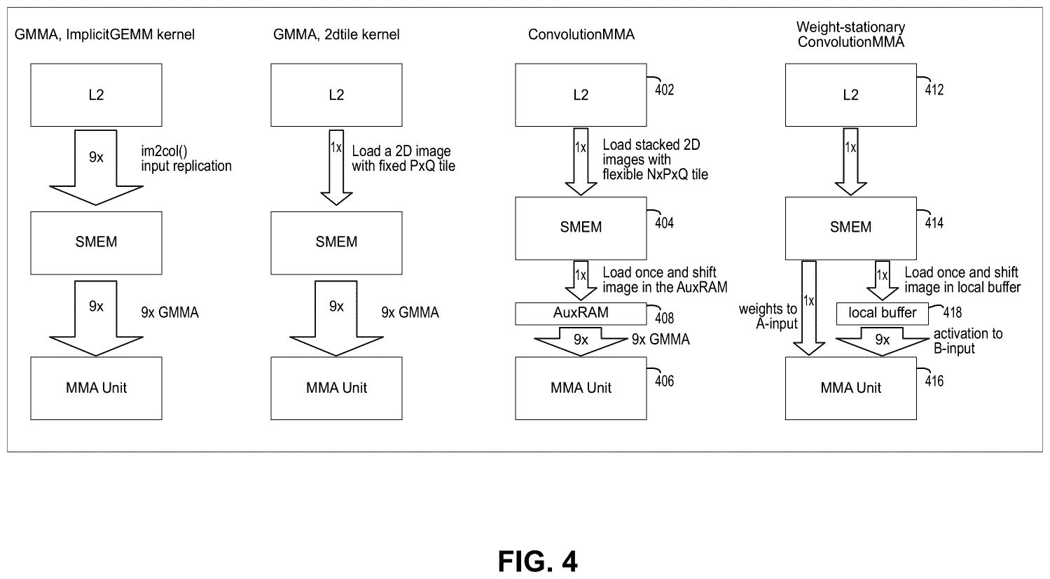

In a system such as that described below in relation to FIG. 4 (the system shown second from the left), each of the steps 3.1-3.9 would have been calculated as a separate MMA calculation that included their respective data loads, resulting in the same input activations being reloaded multiple times (e.g., reloaded from the SMEM to the datapath). In example embodiments, among other advantages, this multiple reloading of the same input activation data is avoided.

FIG. 3D illustrates the performance of K dot product operations between M×1 activation vectors and 1×1 filters which is similar in effect to looping over K filters (which is the GEMM_N dimension). The step result is equivalent to MMA between M×C activation vector and C×K filter matrix. As shown in cycles 2-3, the 4-element activation vector is marked with a dashed-rectangle indicating that those elements are being reused from the previous load.

Of the instructions illustrated in the instructions sequence above, the shift instruction and copy instructions are data movement instructions. Additionally, a disable mask instruction is another key instruction, and the disable mask instruction relates to the manner in which software would perform the above described convolution operations on multiple images.

The size of the input activation vector and the matrix shown in the above example is smaller than the input activations encountered in real-world applications. For example, an example datapath processor may be (e.g., 128 rows tall) capable of accepting 128 images of input. Thus, some instructions enable the stacking of multiple images so that they can be provided as input to the process illustrated in FIG. 3A-3C so that the resulting accumulator will have 128 rows that correspond to the outputs from the same operations.

### Matrix Multiplication Evolution in GPUs

FIG. 4 schematically illustrates memory bandwidth usage of two previous NVIDIA GPUs in comparison to that of example embodiments shown on the furthest right.

All convolution layers can be run as GEMM kernels. One of the most straightforward ways to run convolutions as GEMMs is to use the so called Toeplitz expansion by, for example, using a function such as “Image to Column” (im2col( )), to turn the 4D input activation tensor (NHWC) into a 2D matrix in the device memory, and then use standard GEMM kernels (e.g., from the cuBLAS library from NVIDIA) to compute the result. While this is straightforward, this method also replicates the input activation tensor when there are overlapped regions between the convolution filters (for example, a 3×3 filter with stride=1). This replication may expand the input tensor by up to filter_height (R)×filter_width (S) times. For example, a 5×5 input activation may be expanded by im2col( ) to 9×9 when a 3×3 filter is considered. To avoid this expansion in device memory, in NVDIA Ampere® and some previous GPUs, convolution layers in NVIDIA CUDA® deep neural networks (cuDNN) library and the like can use an implicit-GEMM kernel, where the convolution kernel is lowered into a GEMM kernel dynamically (see Chetler et al., “cuDNN: Efficient Primitives for Deep Learning”, arXiv: 1410.0759 [cs.NE], (3 Oct. 2014)) with on-chip buffers, such as SMEM and RF. This lowering prepares the GEMM input operands during kernel execution time and saves the device memory footprint. However, even though the Implicit-GEMM kernel saves the memory footprint, it still issues multiple requests to the same data in the device memory/L2 to replicate the input activation tensor into a GEMM operand, which wastes the bandwidth between SMEM and GMEM/L2. Thus, as shown on the left in FIG. 4, in the NVDIA AmpereR GPU where convolution layers were run with Implicit-GEMM kernels, a 9× replication of the input affected the memory bandwidth between L2 and SMEM and SMEM and the RF/datapath shown in FIG. 4 as the “MMA unit”.

In NVDIA Hopper® GPUs, shown in the middle of FIG. 4, the implicit-GEMM with 2dTile kernels was introduced for convolution layers. The 2dTile kernels avoids the bandwidth wastage between L2 and SMEM caused by the issuing of multiple requests to the same data in the device memory/L2 to replicate the input activation tensor into a GEMM operand as done in NVIDIA Ampere®. 2dTile achieves this reduction of bandwidth use between L2 and SMEM by delaying the replication a level more than Implicit-GEMM. Shown in the middle of FIG. 4, this can be achieved by loading a fixed 2D image (e.g., H×W=18×18 for P×Q=16×16, R×S=3×3) tile into the SMEM, and reusing this 2D sub-image within the SMEM. This optimization avoids the replicated requests to L2 and the replicated memory footprint in SMEM. However, it can also introduce a quantization issue when the original image size is not a multiple of the fixed 2D image tile.

To address these issues, copending U.S. application Ser. No. 18/449,381 titled “Method and Apparatus for Direct Convolution Computation (already incorporated by reference in its entirety) describes a technique referred to as “ConvolutionMMA” that supports convolution layers in a systematic way by providing a plurality of data movement instructions. Using these instructions, software kernels can construct efficient convolution kernels without any replicated data or memory requests. The third image from the left in FIG. 4 shows how ConvolutionMMA (also referred to here as “activation-stationary convolution MMA”) executes a convolution kernel. From L2 402 to SMEM 404, ConvolutionMMA loads multiple P×Q tiles in a flexible way by stacking different P×Q tiles together. This saves the traffic between SMEM 404 and L2 402, like 2dTile. Unlike 2dTile however, stacking of images avoids the quantization issue. Experiments have shown that ConvolutionMMA is able to reach the same datapath utilization of Implicit-GEMM.

In addition to this improvement of avoiding quantization while reducing bandwidth usage between SMEM and L2, in some embodiments, ConvolutionMMA also may utilize a Tensor Memory (TMEM) 408 that is local and/or is closely associated with the datapath. In some embodiments, TMEM 408 is an auxiliary RAM. The use of the TMEM 408 allows the MMA unit 406 to source the A operand from TMEM 408 to further reduce the traffic between SMEM 404 and the MMA unit 406. On top of the tensor memory feature, some embodiments using ConvolutionMMA also includes (1) a load path between SMEM 404 and TMEM 408 and (2) a shift operation in TMEM 408 to implement a sliding window dataflow. TMEM 408 may be an auxiliary RAM or other memory (e.g., registers, etc.) that is local to or is closely associated with the datapath and in which respective memory areas can be dedicated to the respective datapath lanes. ConvolutionMMA may be referred to as “activation-stationary MMA” because a set of activations, once loaded into TMEM that is associated with the A-input of the datapath (see FIGS. 5A-5B), is kept stationary and reused for multiplications over multiple cycles while new weights are streamed in for every multiplication. For example, considering Steps 3.1-3.3 shown in FIG. 3C, once the vector of activation elements C0-C3 is loaded to the stationary A-input of the datapath (e.g., datapath in FIG. 5A), the inputs at the A-input are maintained constant for multiplication with weights from the respective columns of the first row of the filter matrix.

Example embodiments of this disclosure provide an alternative technique referred to as “weight-stationary convolution MMA” that also supports convolution layers in a systematic way by providing a plurality of data movement instructions. Using these data movement instructions, software kernels can construct efficient convolution kernels without any replicated data or memory requests. In the same manner as ConvolutionMMA that is shown in the image third from the left in FIG. 4, the weight-stationary convolution MMA also, in example embodiments, executes a convolution kernel by loading multiple P×Q tiles from global memory to SMEM in a flexible way by stacking different P×Q tiles together.

The weight-stationary convolution MMA operation is illustrated in the image on the right in FIG. 4. L2 412, SMEM 414, and MMA unit 416 may be configured and/or operated similarly to the L2 402, SMEM 414, and MMA unit 406 described above in relation to the activation-stationary convolution MMA. Key differences in the weight-stationary approach shown in the rightmost image, and the activation-stationary technique shown in the image that is third from the left, include that in the weight-stationary approach weights are input to the datapath (e.g., MMA unit 416) at the stationary A-input to the datapath and the activations are input to the datapath at its B-inputs for the dot product operation, and that the activations are loaded from SMEM 414 to an intermediate buffer 418 (referred to herein as “local memory buffer” or “replay buffer”).

In contrast to ConvolutionMMA that holds the activations stationary in the datapath and streams in the weights, weight-stationary convolution MMA holds weights stationary in the datapath, A separate tensor memory (TMEM), e.g., such as TMEM 408 in ConvolutionMMA, may or may not be used in relation to the A-operand in example embodiments. The TMEM may be an auxiliary RAM or other memory (e.g., registers, etc.) that is local to or is closely associated with the datapath and in which respective memory areas can be dedicated to the respective datapath lanes. Some embodiments using weight-stationary convolution MMA may also include (1) a load path between SMEM 414 and local memory buffer 418 and (2) a shift operation in local memory buffer 418 to implement a sliding window dataflow.

### Example Datapath for MMA

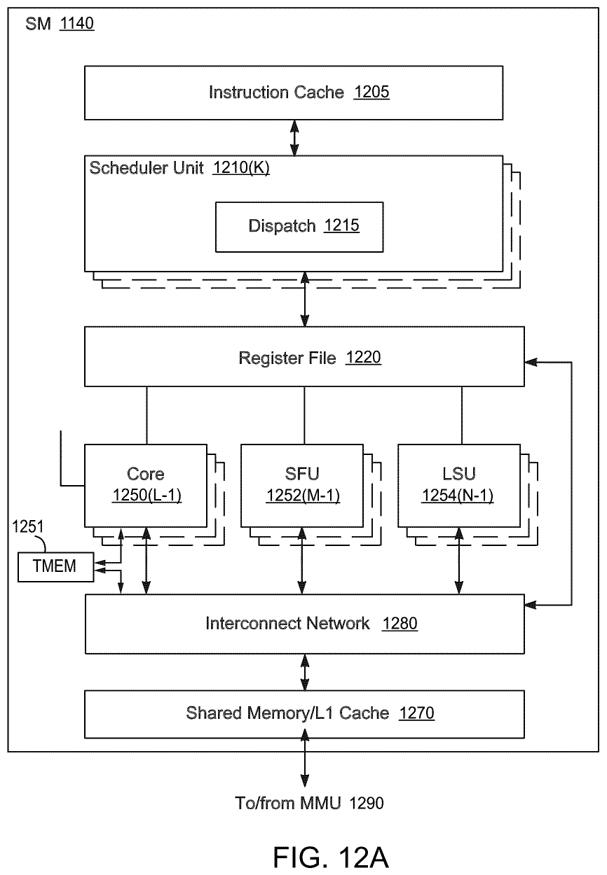

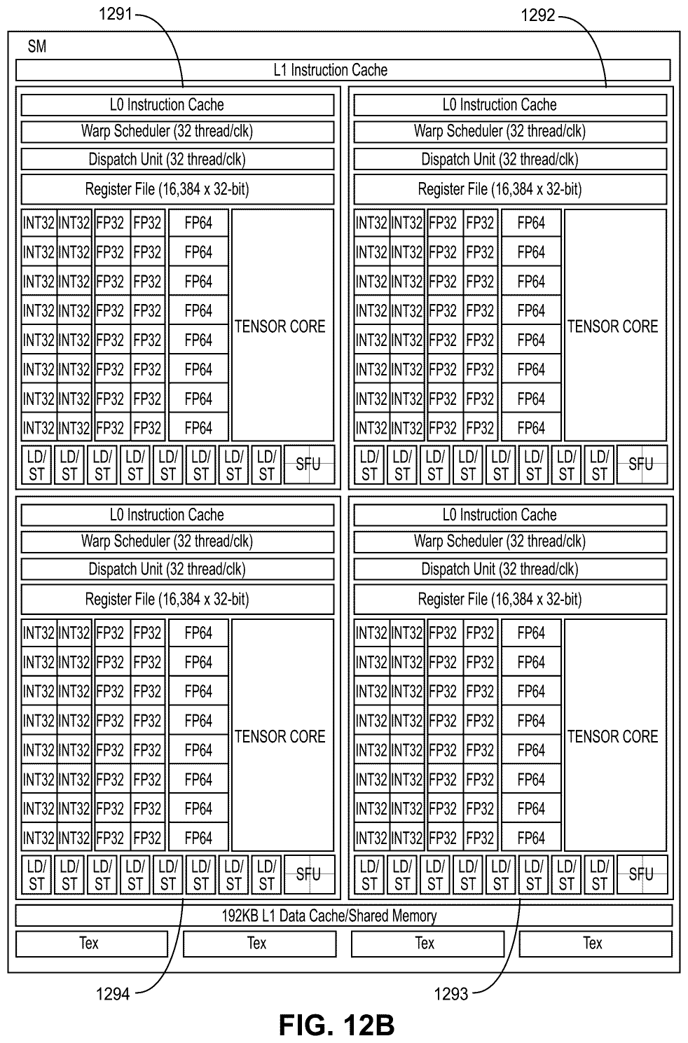

FIG. 5A and FIG. 5B illustrate a portion of a processor (a datapath processor) that includes a datapath configured to implement matrix operations according to some embodiments. In an example embodiment, the datapath processor 510 may be located in a streaming processor. For example, in the streaming multiprocessor (SM) 1140 illustrated in FIG. 12A, the plurality of processor cores 1250 may include one or more datapath processors 510.

The portion of a processor 510 includes a plurality of datapath lanes 502 that each comprises datapath processing circuitry 504 configured to implement matrix operations.

Each datapath processing circuitry 504 may be configured with a first memory component 506, such as, for example, a plurality of registers, and, optionally, a second memory component 508, such as, for example, an auxiliary RAM. In the above described example of convolution calculation, in order for a datapath processing circuitry 504 in a datapath lane 502 to perform its portion of a MMA calculation, the weights matrix (“B matrix”) elements are obtained from the first memory component 506, the elements of the activations matrix (“A matrix”) are obtained from a local buffer or SMEM (e.g., SM 1140 shared memory 1270) over an interface 514. The first memory component 506 is configured to receive weights matrix elements from a SMEM over an interface 512. In some embodiments, the SMEM from which weights matrix elements are obtained and the SMEM from which activations matrix elements are obtained are the same SMEM. For example, the SMEM 1270 on SM 1140 may be configured to receive data of both the activation matrix and the weights matrix from a global memory or L2 memory (e.g., interface 1290 shown in FIG. 12A), and to provide, via the interconnect network 1280, the activations matrix to the datapath processing circuitry 504 and the weights matrix to the second memory component 508. The second memory component 508 may be connected via an interface 516 to a register file, such as, for example, register file 1220 of SM 1140.

In an embodiment, the second memory component 508 is a local memory (sometimes referred to herein as “auxiliary memory”, “tensor memory” or TMEM (e.g., TMEM 408)) that is configured to store data of the weights matrix in a manner that is respectively accessible by each datapath lane. An example optional TMEM 1251 is shown in FIG. 12A.

In some embodiments, a bus 514 may be used to share the elements of the activations matrix among all datapath lanes. In some embodiments, the activations matrix elements may be obtained from the SMEM via bus 514.

In the illustrated embodiment, the portion 510 of the datapath processor comprises 32 datapath lanes 502, and a plurality of the portions 510 (also referred to as “partitions” or “sub-partitions”) are connected so that they can operate as one datapath processor. For example, in an embodiment, a 128-element activation vector is used as the B operands to the datapath processor such that each of the 128 elements of the activation vector is an B operand used by a respective one of the datapath lanes 502.

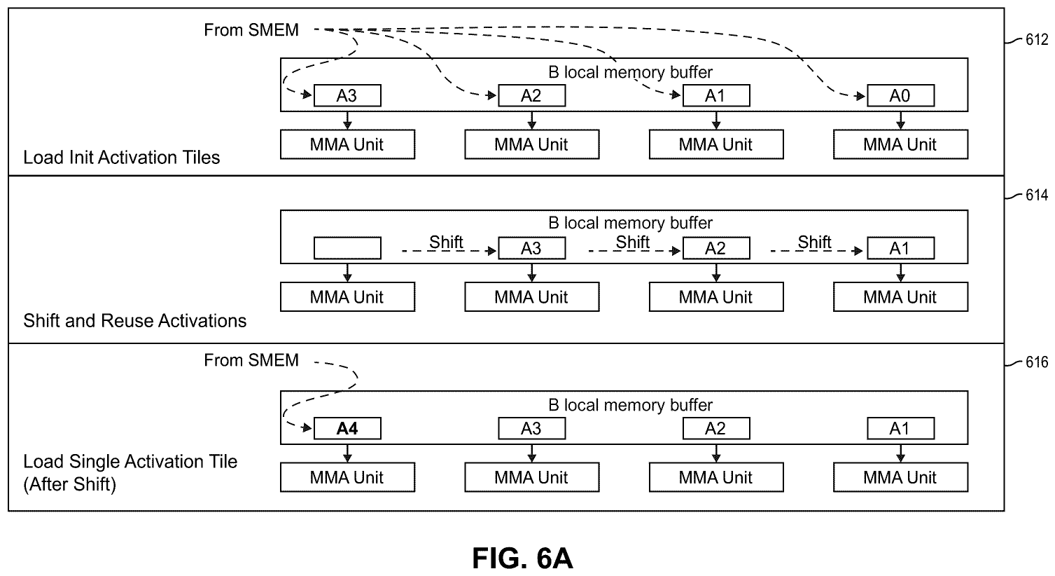

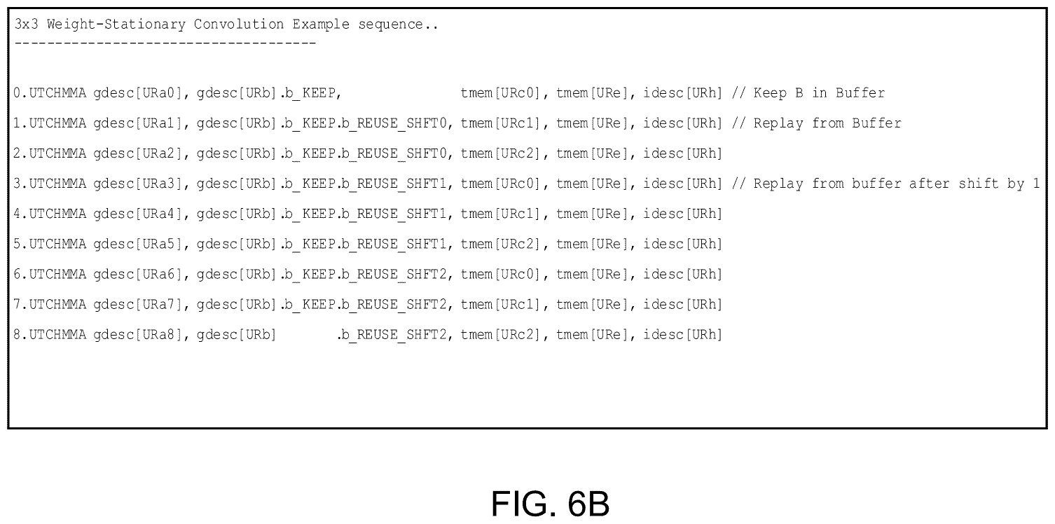

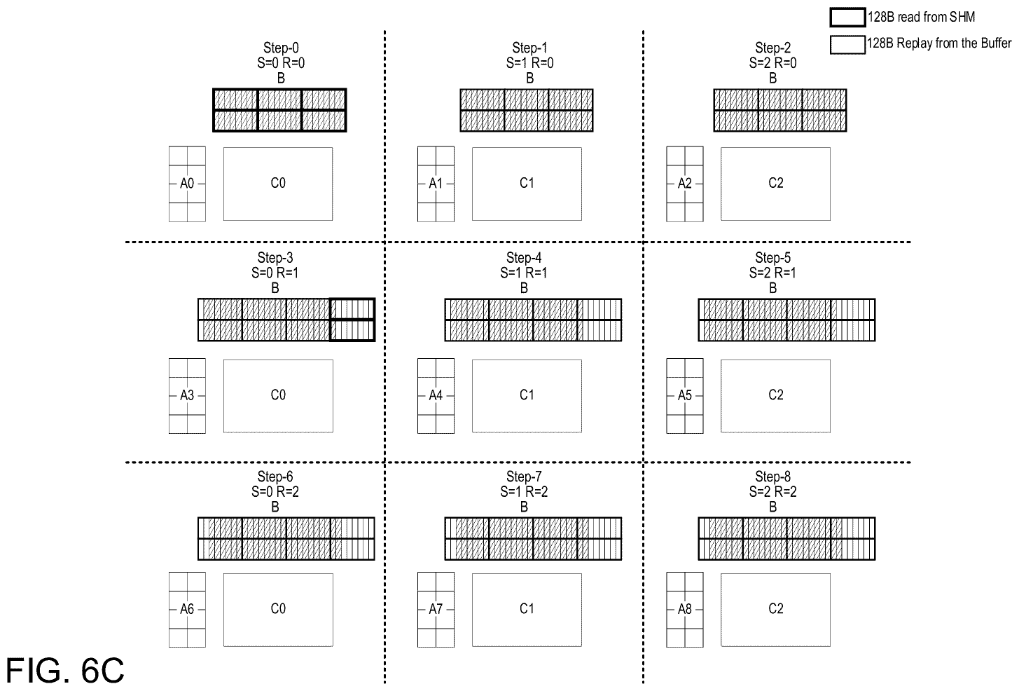

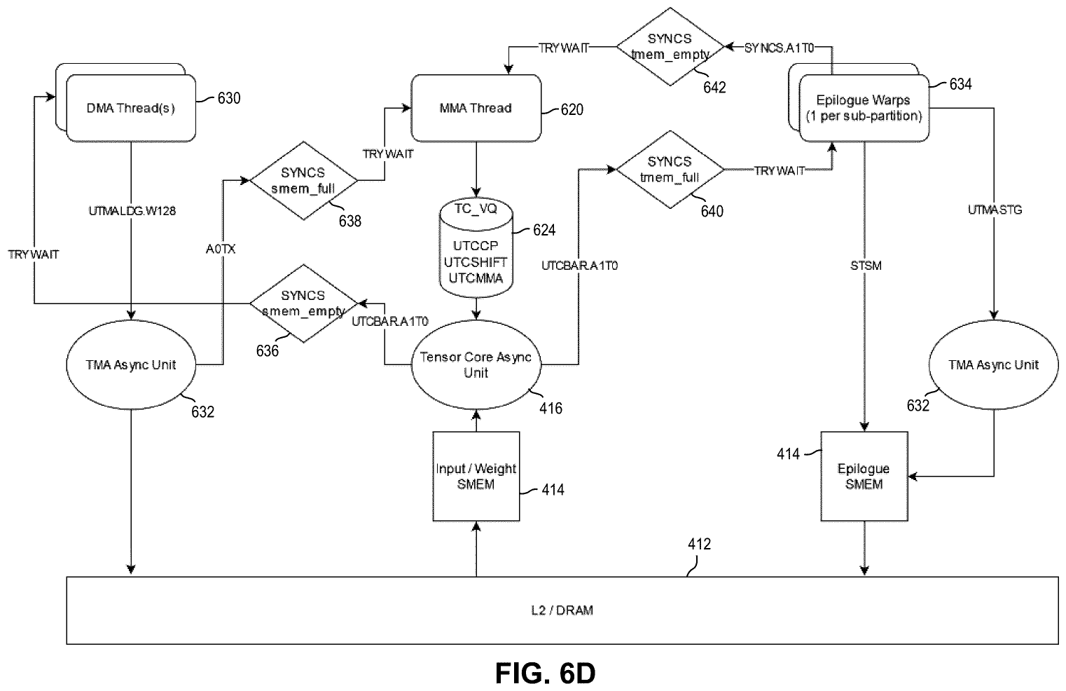

FIG. 5C shows an example hardware circuitry component arrangement in relation to the datapath circuitry of FIGS. 5A and 5B. A datapath state machine (tensor core state machine) 520 may control the operation of the datapath in response to instructions received from the CPU, or SM (e.g., SM 1140). The datapath state machine 520 issues an instruction (e.g., pseudocode of some example instructions is shown in FIG. 6B) to the accelerator graphics unit (AGU) 522 that may then cause the shared memory (SMEM) 524 to be accessed for requested data. The data is then sent through a crossbar/transpose components 526 towards either the A-input of the datapath (e.g., path 512 to A operand collector 506) or towards the B-input of the datapath (e.g., path 514 to B operand input). A serializer 542 may be included to serialize data that is sent from the SMEM 524 to other SMs.

The data (e.g., weight elements) sent towards the A-input of the datapath may be written to the A-input collectors of the datapath and/or optionally to another memory closely associated with the A-input collector, such as, for example, TMEM.

The data (e.g., activation elements) sent towards the B-input of the datapath may be written to a local memory buffer 530. The data in the local memory buffer 530 may be provided to respective datapath lanes by a column select component 540. In the example datapath shown in FIGS. 5A and 5B, the A-input is configured to be stationary (i.e., load inputs once and hold constant over multiple cycles) and the B-input is configured to receive inputs on every clock cycle.

The local buffer memory 530 may be a first-in-first-out (FIFO) buffer. In some embodiments, the local memory buffer 530 is similar to, or is the same as, the local buffer 418 described above. The local memory buffer 530 may be sized to hold all activation elements for a tile so that, for each tile, all activations required for calculating the dot product for the tile is obtained using one access to shared memory per element. In some embodiments, a vector of activation elements can be loaded from SMEM to local memory buffer 530 in one access, and the subsequent accesses necessary to complete the dot product may be for one or more activation elements for each access. The circuitry may be configured to “replay” the same data from the buffer 530 to the B-input so that the B-input receives data on every clock cycle (or p clock cycles, where p is >1). As described further below, buffer 530 is also configured to shift the vector of activation elements stored in the FIFO so that the q (q>=1) operands at the top are no longer available for dot product calculation and q new operands are obtained from SMEM and appended to the other end of the vector of activation elements. In some embodiments, the vector of activations in the FIFO may be shifted by 1. In some embodiments, the capability to shift the vector of activations in the FIFO by a configured number of columns (e.g., by 1 column) in one direction and to zero out one or more elements of the vector at the other end may be implemented by one or a combination of the local memory buffer 530 and column select component 540.

The datapath 502 is configured such that the A-input collector is kept stationary over multiple clock cycles, while the B-input collector receives new data every cycle. In some embodiments, the datapath 502 may be configured to hold the data in the A-input collector stationary for n clock cycles or until a new instruction of a particular instruction type is received, and to receive new data at the B-input collectors on each clock cycle or on every p clock cycles, where p is an integer smaller than n. In example embodiments, the datapath may be considered as having A-input as the stationary input and B-input as non-stationary.

In an example implementation, considering the convolution MMA operation described in relation to FIGS. 3A-3D, the activation vector 302 can be mapped to the datapath so that for each of a respective series of MMA operations a respective activation element is provided as input to each of the datapath lanes 502. Each column of the result matrix 306 is produced by a respective one of the datapath lanes 502. Thus, in this example implementation, considering a datapath having 4 datapath lanes 0-3, the illustrated first column (A0-A3) of the result matrix 306 are results obtained from datapath lane 0, the illustrated second row (B0-B3) are results obtained from datapath lane 1, etc. Note that the illustrated matrices are of small sizes, and example embodiments are not limited to a particular maximum size of the matrices that can be processed. In an example implementation the datapath comprises 128 datapath lanes.

The example implementation can be further described with respect to Steps 3.1-3.9 shown in FIG. 3C. In Step 3.1, each of the activation vector elements C0-C3 is provided to a respective input of a datapath lane 0-3. The scenario shown in Step 3.1 is when the 3×3 weights matrix is aligned with the top left of the activation matrix (e.g., the top left of the weights matrix is aligned with the top left of the activation matrix), and the first four elements of the third column of the activation matrix is to be multiplied by the weight that is at the first row and first column of the weights matrix. The result of the multiplication, is added to the first four elements of the first column in the result matrix.

In Step 3.2, the same elements C0-C3 from the activation matrix are multiplied with the weight at the second column of the first row of the weights matrix, and the result is added to the first four elements in the second column of the result matrix.

In Step 3.3, still the same elements C0-C3 from the activation matrix are now multiplied by the weight at the third column of the first row of the weights matrix, and the result is added to the first four elements in the third column of the result matrix.

Thus, after having loaded respective activation elements C0-C3 of the activation vector to datapath lanes 0-3 for Step 3.1, the elements C0-C3 are reused for Steps 3.2-3.3.

Then, at Step 3.4, the next weight element to multiply with is in the second row of the weights matrix. It can be seen that when obtaining the dot product, that weight element does not affect the very first element of the activation vector. The four-element sliding window of the activation vector is shifted downward one element so that it now starts at the second row of the third column and includes C1-C4. But the shifting of the sliding window means that the C0 is now excluded from the next calculation due to it being out of the sliding window at one end of the activation vector, and that the last element at the other end of the sliding window should be loaded to the corresponding datapath lane. Accordingly, one element, C4, may be loaded to the corresponding datapath lane, and the dot product between the current sliding window (i.e., C1-C4) and the element at first column of the second row in the weight matrix is performed and the results are accumulated in the first column of the result matrix. At each of Steps 3.5-3.6, the same sliding window of activation elements C1-C4 are used for the dot product with the elements at the second and third columns in the second row of weights, and the respective results are accumulated in the second and third columns on the result matrix.

FIG. 3C also shows Steps 3.7-3.9. At Step 3.6, the weight element used is the last element in the second row of the weights matrix. In Step 3.7, the weight element that is used is the element at the first column of the third row of weight elements. Thus, for reasons similar to that described above in relation to Step 3.4, the sliding window of activation elements is shifted down one row so that it now includes C2-C5, and while C1 is excluded at one end of the sliding window C5 is loaded to the corresponding datapath lane at the other end of the sliding window. The results of the dot product of the sliding window and the weight element at the first column of the third row of the weight matrix is calculated and the result is accumulated to the first column of the result matrix. At each of Steps 3.8-3.9, the same sliding window of activation elements are used for the dot product with the elements at the second and third columns in the third row of weights, and the respective results are accumulated in the second and third columns on the result matrix.

The dot product calculations of each of the Steps 3.1-3.9 are repeated for each of the K filters, as shown in FIG. 3D. Thus, some of the elements of the sliding window of activation inputs are loaded once from SMEM, and then reused for each of the dot product calculations for the entire weight matrix. That is, in the illustrated example that utilized a 3×3 weight matrix, activation elements C2 and C3 were each loaded once from SMEM and then reused for 9 dot products (actually 9×K, since the dot product calculation is performed for each of the K filters as shown in FIG. 3D). C0, C1, C4 and C5 are corner cases in the activation matrix, and thus have less reused than C2 and C3 which are middle elements. For larger matrices, such as those that occur in many real-world applications, most of the elements are not corner cases and thus benefits from maximal reuse resulting in loading once from SMEM and then being reused for each of the weight elements, thereby reducing the memory bandwidth utilization. Note that in FIG. 3C, the solid outlines of rectangles within the respective matrices are intended to illustrate loading from SMEM, and the dashed outlined rectangles indicate reuse from one step to the next.

FIGS. 5D-5H graphically illustrate the handling of operands at the two input interfaces to an example datapath processor, for example, datapath processor 510, in accordance with some embodiments of this disclosure. Each figure in the sequence of FIGS. 5D-5H conceptually illustrates the arrangement of the A-input (i.e., the stationary input) and the B-input (i.e., the non-stationary input) to the datapath processor 510 for a respective sequence of MMA operations. For example, FIG. 5D shows the A-input having loaded a first set of weights A0 and the local memory buffer 530 that is connected to the B input having a first set of activations B0 arranged to be streamed to the B-input at respective cycles during a first sequence of MMA operations. The results C0 are accumulated in the accumulator. FIG. 5E shows the next sequence of MMA operations with operands A1, B1 to produce C1. A1 is newly loaded from shared memory. B1 includes a subset of B0 and at least one new activation element. The at least one new element may have been already loaded to the local memory buffer 530 from the shared memory (e.g., the local memory buffer may be loaded with an entire tile's worth of activation elements), and thus B1 may be obtained by shifting the activation elements already in the local memory buffer. The shift may be implemented by hardware shifting (e.g., physical copying of data to a new location in the local memory buffer from the old location in the local memory buffer) or by pointer manipulation. FIGS. 5F, 5G, and 5H show the input operand arrangements for subsequent MMA sequences.

FIG. 6A shows how data is first loaded into local memory buffer 418 (or equivalently to local memory buffer 530), shifted for reuse, and a minimal load performed to reduce data movement. Using these data movement instructions, weight-stationary convolution MMA further saves MIO traffic for convolution layers, which is critical when the number of convolution filters (i.e., output channel size, CONV_K) is small.

FIG. 6A illustrates the loading of local memory buffer 418 from SMEM 404, and the subsequent shifting and reuse of the loaded elements in local memory buffer 418. Each row 612, 614 and 616 shown in FIG. 6A illustrates a state of the same four example MMA units 406 of 4 respective datapath lanes and a vector of activation elements in the local memory buffer 418, over several operations. At any point in time, the vector of activation elements in the local memory buffer 418 are activation elements that are to be used in the next MMA operation (dot product calculation). In the top row 612, the loading of initial activation elements from the SMEM to the local memory buffer 418 is performed such that in the illustrated datapath lanes, activation elements A0, A1, A2 and A3 can be available to the respective datapath lanes from the right to left. After the activation elements necessary for the next MMA operation are loaded, the respective datapath lanes can perform the MMA operation using the loaded activation elements A0-A3 and weight elements loaded from SMEM to first memory 506.

After some number of MMA operations are performed, as shown in the middle row 614, of FIG. 6A, the vector of activation elements of the local memory buffer 418 is shifted (e.g., shifted right) such that A0 is no longer available to any datapath lane (e.g., no longer within the vector of activation elements) and each of the other loaded activation elements (i.e. A1-A3) are shifted such that they are available to the respective neighboring datapath lanes. As can be seen in 614, this shift results in the activation element that was in the last datapath lane (in the illustration, the leftmost datapath lane) being made available to the adjacent datapath lane and the activation element in last datapath lane being either null or invalid.

As shown in the bottom row 616 of FIG. 6A, the next activation element (e.g., a single activation tile) is obtained and stored in the local memory buffer so that it may be available to the last datapath lane. In the illustrated example instance, activation element A4 from SMEM is stored in the local memory buffer so that it may be available to the last shown datapath lane.

Note that although this disclosure may refer to “activation columns” and “row slices” when describing how convolution MMA operations or weight-stationary convolution MMA operations work on a conceptual level, the processing in the datapath may sometimes be different. This difference may be related to how the input activations are laid out in global memory for the highest efficiency. If images are stored in NHWC layout, for instance, elements along a column are not contiguous and therefore require a stride along the WC dimension to travel between adjacent rows. Although the TMAU may be capable of handling this addressing style, in some embodiments, the input activations are loaded as rows instead, and map them onto columns (lanes) of the datapath. When a row shift is performed the visual is of sliding a window down one row (along filter-R dimension) in the local memory buffer, but, in reality, it is equivalent to sliding it to the right (along filter-S dimension) on the image.

It should be noted that the shift operation can be implemented by a hardware shift or by address manipulation. An example hardware shift operation was described in U.S. application Ser. No. 18/449,381 titled “Method and Apparatus for Direct Convolution Computation (already incorporated by reference) in relation to the activation element vector in TMEM. Shifting by address manipulation can be implemented by simply changing the starting address in the local memory buffer 530 for the first activation element.

### Example Convolution MMA Instructions

As noted above, several instructions may be provided in embodiments of this disclosure such that the instructions can be configured and sequenced by software to perform a desired convolution operation using a datapath such as, for example, the datapath shown in FIGS. 5A-5C. The instructions include instructions for copying tensor data from GMEM to SMEM, and other copy instructions copying from SMEM to a local memory buffer (e.g., local memory buffer 418 or 530). Copy instructions are also referred to as load instructions. Other instructions for convolution MMA include shift instructions, and MMA instructions.

The shift instruction may cause a one-row shift of elements (e.g., 32-byte elements) within an activation vector that is stored in the local memory buffer associated with the B-input of the datapath (e.g., local memory buffer 418). In some embodiments, the shift is implemented across the entire datapath. For example, the shift is effected for all datapath lanes (e.g., 128 lanes) as one operation. Alternatively in some embodiments, when the datapath comprises sub-partitions (e.g., a 128-lane datapath made up of 4 32-lane datapaths), the effect of the shift may be contained within each sub-partition, so that there are no copies or movements of data between SMs or sub-partitions in a cluster.

The load instruction (copy instruction) may bulk copy rows of data from SMEM to the local memory buffer 530 using fixed-size blocks. Conceptually, this is equivalent to loading an activation column where each element is itself a vector (e.g., a 32-byte vector) of packed values. The operation may implement addressing and swizzling modes through a descriptor. Software may be responsible for updating the descriptor fields in order to select different columns or channel offsets.

The copy instruction may support multiple modes. In a first mode, it copies an entire activation vector (e.g., activation vector of 128 elements) to the local memory buffer (e.g., local memory buffer 418).

In a second mode, the copy instruction copies a single element, or another specified number of elements less than the entire activation vector to the local memory buffer 530. In some embodiments, the source element location in SMEM and the destination position in local memory buffer (e.g., index in the activation vector in local memory buffer) may be specified.

The single element copy mode may be used by software to refresh halo elements after the shift instruction. When the datapath is sub-partitioned, the multiple element copy mode may be used to refresh sub-partition boundary elements after the shift.

In at least some embodiments, the copy instruction supports specifying a swizzle pattern in which the data is organized in SMEM and/or the local memory buffer.

The MMA instruction computes dot-products between elements of the input activations in local memory buffer storage and filters in the first memory 506.

This instruction in some embodiments may provide the ability to suppress local memory buffer writes to specific rows using a bitmask (sometimes referred to as “disable bitmask”). The bitmask may be a 128- or 256-bit (GEMM_M) mask passed via uniform registers. The purpose of this functionality is to allow software to skip image halo contributions when they are 0, or process tiles smaller than GEMM_M (e.g., 128). Note that suppressing writes is equivalent to ANDing the bitmask with local memory buffer write enables. In some embodiments, instead of implementing a bitmask, the suppressing of local memory buffer writes to specific rows can be used by adjusting the address/pointer to the next activation element to skip over the elements sought to be skipped.

The MMA instruction works by accumulating dot-products of the input activation vector (e.g., organized as a column) with the weights (e.g., organized as a row). If one starts with a simple image consisting of M activation rows (M×1 vector) and convolve it with a 1×1 filter (1×1 vector), each row in the output image is computed by multiplying the corresponding input row by the scalar weight.

This example can be extended to account for multiple channels by reshaping the input matrix to be M×C and the filter to be C×1, where C represents the number of channels. The output computation may be basically the same, except now instead of scalar multiplication, 1×C vectors can be taken from the input and dot them with the C×1 filter to sum all of the contributions across the channels.

Moving one step further, multiple outputs can be computed at the same time by reshaping the filter to be a C×K matrix, where K is the number of feature maps. The result may be exactly equivalent to a matrix multiplication between the M×C activations vector and the C×K filters matrix.

Another aspect benefiting weight stationary convolution MMA is allowing the MMA datapaths to reuse the B operand collectors between subsequent instructions. A younger instruction that loads B from SMEM to the local memory buffer may provide for an older instruction with the same parameters to skip loading B from SMEM.

The core operation of the MMA may be considered equivalent or similar to an M×C×K matrix multiplication using convolution terminology. The basic MMA operation is a 32B dot-product, performed “GEMM_M” times in parallel across the SMs/sub-partitions, then repeated “GEMM_N” times in sequence to fill the output columns. For simplicity, it is required the weight tensor to be in RSKC layout (i.e., a defined tensor format) in SMEM, so that the channel blocks are stored contiguously within each line without swizzling. Software may be responsible for updating the source operand descriptor to select which channel block will be loaded from the line (generally, starting_addr field). Each instruction therefore computes a 128×N×(32/16/8) matrix multiply and accumulates the results in tensor RAM with convolution PKQ layout. Conceptually, this accumulator contains output column “blocks” sized according to GEMM_M that are laid out contiguously, then striped according to the number of filters.

The weight-stationary convolution MMA requires multiple activation data loads from SMEM to the local memory buffer associated with the datapath B-input using dedicated copy instruction(s). Before any math operations could be started, a 128-long row of the input activation may be loaded to feed the MMA datapath. The row is a contiguous sequence of elements along W dimension from NDHWC tensor. In some embodiments, the TMAU is responsible for loading the row from global memory to SMEM.

The row can start at any location in the tensor space and cross multiple images in the batch (GEMM_N dimension). The length of the row is determined by the MMA datapath size (e.g., 128-wide). The copy instruction expects the row to be contiguous in SMEM space to avoid memory bank conflicts. At any given time, the instruction loads 32B of channel information per activation element. In some embodiments, this i the atom of data that MMA datapath handles per element. However, to make the loads to SMEM more efficient, a bigger block of the channel information per element could be loaded from the global memory.

In some embodiments, single provoking thread from one SM broadcasts an identical shift, copy and/or MMA instruction to all SMs (and thereby sub-partitions) in a cluster. There may be 1 or 2 SMs in a cluster.

A TMAU GMEM to SMEM load instruction, for example, an instruction such as UTMALDG or UTMALDG.W128 referred to in this disclosure, bulk copies the data for an activation vector from GMEM to SMEM. A number of additional elements may also be copied from the GMEM to SMEM based on the same instruction invocation. The additional elements are used to refresh the activation vector after shift operations.

In some embodiments, the instruction requires that the width of halos of the images as stored in GMEM be specified and may also require a starting location within the tensor in GMEM where the vector commences.

The instruction may optionally accept the specifying of a swizzle pattern for the data in the GMEM and/or SMEM.

FIG. 6B and FIG. 6C show a sequence of instructions in pseudocode and the corresponding datapath operations for an example 3×3 weight-stationary convolution MMA, in accordance with some embodiments.

FIG. 6B shows pseudocode for a sequence of 9 instructions (labeled as instructions 0-8) that may be issued by the tensor core state machine 520. The steps 0-8 shown in FIG. 6C correspond to the respective instructions 0-8.

Instruction 0 loads activation elements for an activation vector from SMEM (e.g., SMEM 524) to the local memory buffer (e.g., local memory buffer 530) and multiplies the first activation element in the vector with the weights (A input). For example, 128 activation elements may be read from shared memory 524 and stored in the local memory buffer 530 and respective elements may be provided to the B-input of the datapath for the dot product calculation. A modifier, such as, for example, a “keep” modifier (as shown in FIG. 6B), may be associated with instruction 0 to instruct the datapath and/or local memory buffer to load the requested data and to maintain it without change until another instruction is received. Step 0 in FIG. 6C corresponds to instruction 0. Step 0 shows that the first set of weights (represented as A0) is multiplied by the activation elements (represented as B) in a dot product operation and summed to the collector (shown as C0). The thick lined boxes for B operands illustrate that the B operand loaded new from SMEM in step 0.

Instruction 1 causes the next activation element to be multiplied with the corresponding weights, and the corresponding operation is shown as Step 1 in FIG. 6C. Instruction 1 includes the “keep” modifier indicating that the B-input operands are to be maintained, and a “reuse_shift0” modifier to indicate that the operands are reused without shifting. The thin-outlined boxes shown in Step 1 of FIG. 6C indicate that no B operands are loaded new from SMEM. In some embodiments, instruction 1 causes the same activation elements to be “replayed” from the local buffer to the B-input of the datapath.

Instruction 2 causes the next activation element to be multiplied with the corresponding weights, and the corresponding operation is shown as step 2 in FIG. 6C. Instruction 2 includes the “keep” modifier indicating that the B-input operands are to be maintained, and a “reuse_shift0” modifier to indicate that the operands are reused without shifting. The thin-outlined boxes shown in step 2 of FIG. 6C indicate that no B operands are loaded new from SMEM. In some embodiments, instruction 2 causes the same activation elements to be “replayed” from the local buffer to the B-input of the datapath.

Instruction 3 includes modifiers “keep” and “reuse_shift1” and indicates that the activation operands are to be replayed from the buffer (e.g., buffer 530) to the B-inputs after a shift. The shift operation may be considered as shifting a row in the array. The replayed elements are dot product multiplied with the weights. The corresponding operation is shown as Step 3 in FIG. 6C. The thick-outlined box shown in step 3 of FIG. 6C indicates that new activation elements are loaded from SMEM. The newly loaded activation elements are appended the end of the vector of activation elements for the next dot product operation with weights A3.

According to an embodiment, at Step 3, the shift is by one activation element. This shift is represented in Step 3 shown in FIG. 6C by showing that the first element in the FIFO (shown as smaller rectangles within the larger rectangles) is not filled in which all other small rectangles (each representing an activation element) are filled in in the thin-lined rectangle area. The thin-lined rectangles represent previously loaded activation elements that are being reused. The thick-lined rectangle represents that many activation elements were newly loaded from SMEM. In the illustrated embodiment, since the shift is by one activation element, from among all the newly loaded activation elements, only the leftmost element is being used for the calculation at Step 3. This is shown by showing only the leftmost smaller rectangle in the thick-lined rectangle as being filled in.

It should be noted that although in the illustrated example embodiment, the shift is by one activation element, embodiments are not limited in the number of elements that can be shifted per shift operation.

Instruction 4 and instruction 5 have modifiers “keep” and “reuse_shift1” indicating that the same elements as in Step 3 are being reused (replayed) from the local buffer (e.g., buffer 530) to the B-inputs of the datapath. Instructions 5 and 6 would perform the dot product operation on the next two activation elements. The scenarios associated with instructions 5 and 6 are shown in Steps 4 and 5 in FIG. 6C.

Instruction 6 includes modifiers “keep” and “reuse_shift2” and indicates that the activation operands are to be replayed from the buffer to the B-inputs after another shift. The shift operation may be considered as shifting another row in the array. The replayed elements are dot product multiplied with the weights. The corresponding operation is shown as Step 6 in FIG. 6C.

In Step 6, the shift operation shifts the leftmost activation element out of the vector of activation elements for the next dot product, and a new activation element should be added to the vector at the other end. However, since at Step 3 more than the number of activation elements needed for Steps 3-5 were loaded from SMEM, the newly element added to the vector would already be available in the buffer.

Instruction 7 and instructions have modifiers “keep” and “reuse_shift2” indicating that the same elements as in step 6 are being reused (replayed) from the local buffer to the B-inputs of the datapath. Instructions 7 and 8 would perform the dot product operation on the next two activation elements. The scenarios associated with instructions 7 and 8 are shown in Steps 7 and 8 in FIG. 6C.

It should be noted that each copy instruction may, in addition to source and destination information, may also include a descriptor specifying access patterns etc. Additionally, it should be noted that whereas certain example formats are shown in FIG. 6B for some instructions, the instructions in this disclosure are not limited to any particular format.

### Programming Model

The illustrated event flow of FIG. 6D represents the programming model of the weight-stationary convolution MMA operation according to some embodiments of this disclosure. A single thread that is either on an SM or a TPC is configured to control the entire MMA pipeline including the shift operations, the MMA math operations, the copy operations, etc. All this is implemented as an asynchronous pipeline with barriers (e.g., SYNCS barriers) and weight structures between them. A math thread, for example, the MMA thread, operates to wait for data required for the math operation, then issues a series of math operations, and then notifies one or more other threads that the math thread has completed. The notifying to one or more other threads can be achieved by the MMA thread arriving at a barrier, such that the one or more other threads that are waiting at that barrier are notified that the math operations performed by the MMA thread have completed.

The state machine (also referred to as the programming model) illustrated in FIG. 6D shows the interaction of various threads in a CTA. For example, the CTA comprises a math thread (MMA thread 620), one or more DMA threads 630, and one or more epilogue warps 634. The threads may execute on the SM (e.g., SM 1140 in FIG. 12A) or TPC (e.g., GPC 1050 in FIG. 11A). The MMA thread 620 issues instructions such as the copy instruction, shift instruction, and MMA instruction, and the issued instructions are enqueued in an instruction queue 624. The MMA unit 416 (e.g., datapath processor/tensor core 504) dequeues the instructions from queue 622 and performs the operations(s) identified by the respective instructions. Based on the type of instruction, the MMA unit 416 can pull the required data from the SMEM 414 (or optionally TMEM 408). For example, the A operand of the MMA may be obtained from TMEM 408 (or from the A collector) and the B operand from SMEM 414 or local memory buffer 530. This data may be initially loaded into the SMEM 414 and/or the MMA unit 416 from the L2/external memory 402.

When the MMA unit 416 completes the sequence of instructions, it arrives at barrier 640. The one or more epilogue warps 634 are waiting on this barrier 640 and, when the MMA unit arrives at barrier 640, can proceed to perform the various epilogue tasks such as loading the result of MMA operations from a datapath output/accumulator memory to SMEM.

The one or more DMA warps 630 causes the TMA asynchronous unit/TMAU 632 to copy data from L2/GMEM 412 to SMEM 414 and/or between SMEM 414 and local buffer memory 530 or the TMEM 408 to make that data available for consumption by the MMA unit 622. The MMA unit 622, when it has consumed the input data, performs an “arrive” on the barrier 636 to inform DMA thread(s) 630 that are waiting on the barrier 636 that the data has been consumed. DMA thread(s) 630, can then cause TMAU 632 to get the data for the next set of MMA unit 622 operations. TMAU 632 proceeds to copy the required data from the GMEM/L2 412 to SMEM 416, and if necessary, from SMEM 414 to TMEM 408 or other memory associated with the MMA unit 416. The TMA asynchronous unit 632, arrives at barrier 638, on which MMA thread 620 is waiting, when the data for the next set of operations has been copied. It should be noted that TMAU 632 may be similar to or identical to TMAU 1141 shown in FIG. 11A.

In the illustrated example, the threads shown in FIG. 6D, controls a plurality (e.g., four) computational units to perform the convolution MMA operation. In some embodiments, the four computational units may represent four subpartitions of an SM such as SM 1140. Each subpartition may have one or more tensor cores (see FIG. 12B) that are configured to perform multiplication, addition, and other operations on matrices. In the example, the threads of a group of threads, such as a CTA, are controlled/driven by one MMA thread (e.g., MMA thread 620) to collaboratively calculate a result matrix on each computational unit. The MMA thread 620 drives the sequence of operations shown in FIG. 6D, and threads on respective computational units may move operand data from the register file and/or SMEM to the inputs of the datapath, control respective tensor cores to execute the MMA operation using the operands in the inputs to the datapath, and subsequently write the results of the operation back to the register file or other memory. Threads on the respective computational units can then access the results in the respective register files or other memory.

As described above, the MMA thread 620 or other thread may cause the TMA async unit 622 (e.g., TMAU 1141 shown in FIG. 11A) to load the input data from external memory or L2 to SMEM. U.S. application Ser. No. 17/691,276, which is hereby incorporated by reference in its entirety, describes the TMAU unit 1141 and some of the associated swizzle patterns and bulk movement of block data to/from SMEM.

In many applications, the TMAU loads data in the SMEM in the same order as they are laid out in global memory. However, there are applications when extra data movements are required to avoid performance degradation. The TMAU supports a non-swizzled mode in which data is written to the SMEM in the same arrangement it is in global memory, and a swizzled mode in which data is written to SMEM in accordance with a predetermined or configurable swizzle pattern that that results in a different arrangement of the data than that in the global memory. The descriptor field may specify a register index, and the register may be configured with a bit pattern of one or more bits to indicate a particular predetermined pattern of layout selected from a plurality of possible layouts. In some embodiments, the location of the data in SMEM and also the layout is specified using the descriptor. In some embodiments, the descriptor may be used to provide additional information such as transpositions, leading edge calculations, strides etc. that are to be used in obtaining the data from the memory and loading to the datapath.

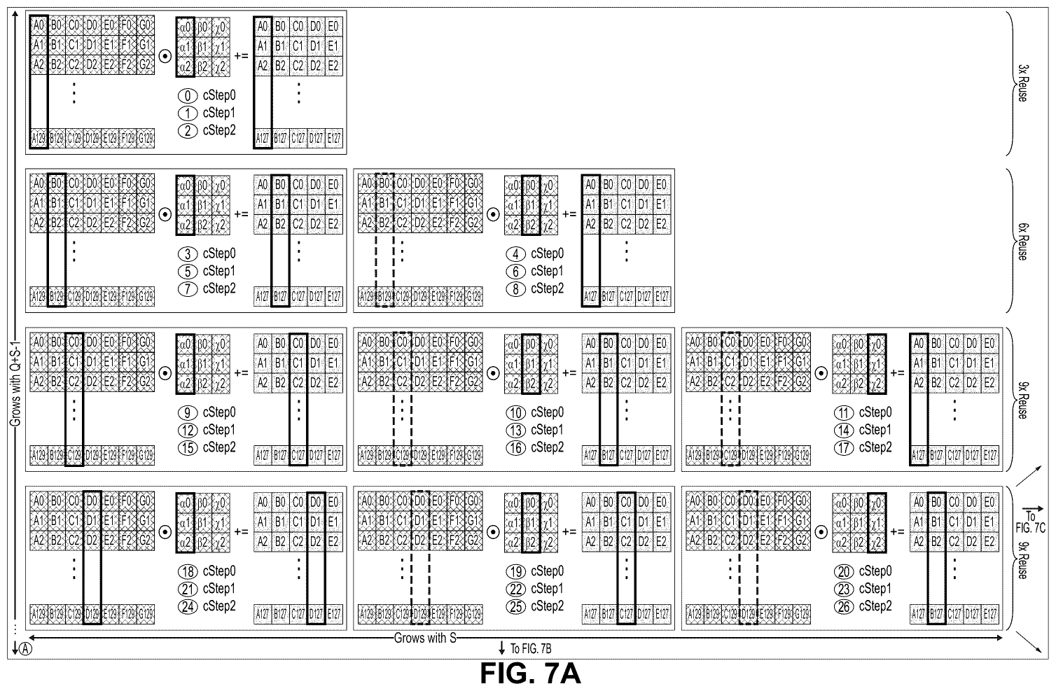

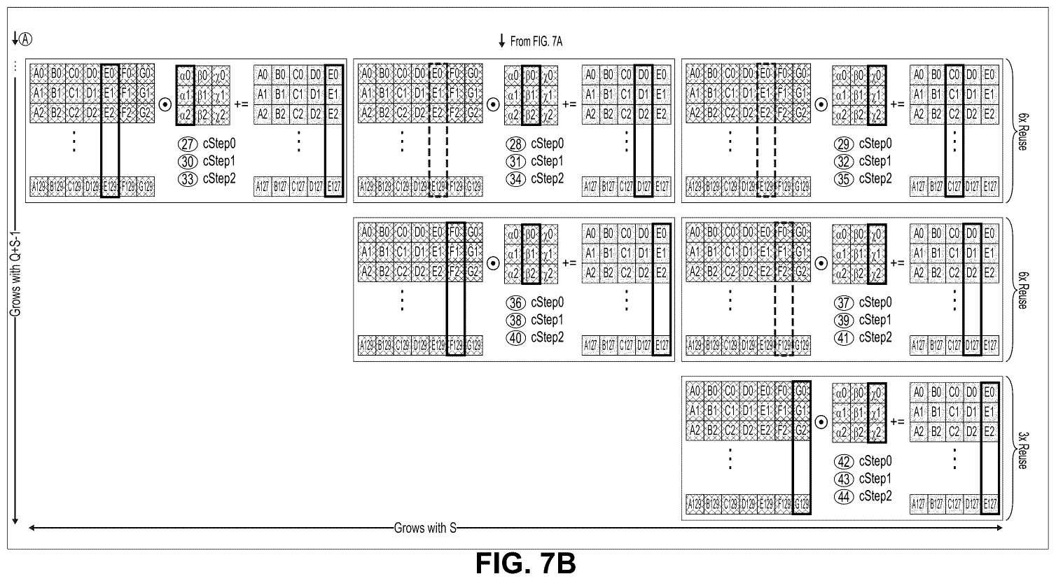

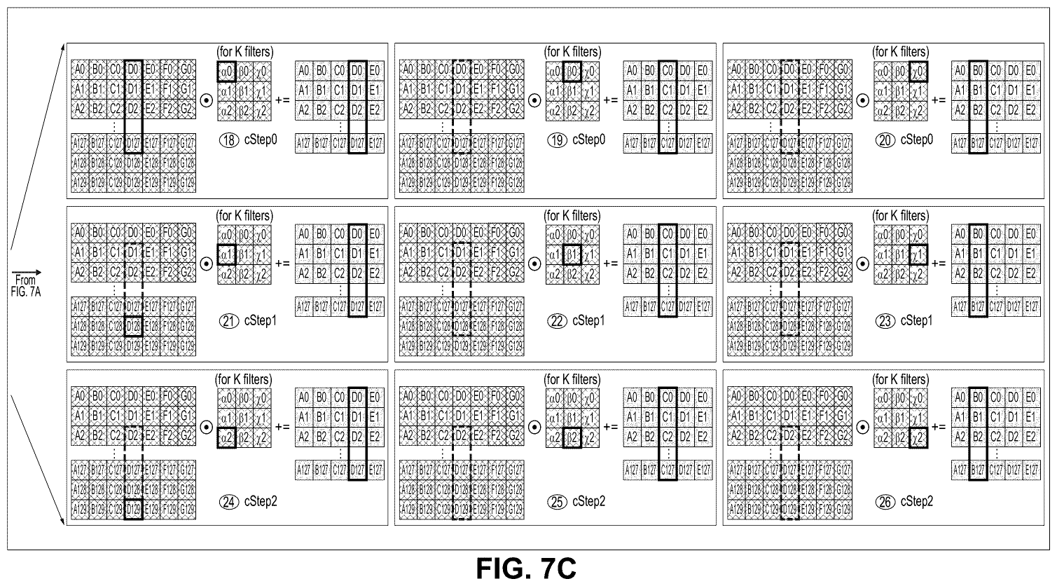

FIGS. 7A-7C illustrate the convolution operation on an input activation matrix having 128-element columns, 3×3 filters, and an accumulator matrix with a 5-element column. The convolution operation is similar to that described in relation to FIGS. 3A-3D.

As described above, example embodiments eliminate or reduce bandwidth consumption between SMEM and the datapath by reusing data over multiple MMA operations. FIG. 7A-7B show that the input activations in the first (left) column of the input activation matrix are reused 3× times for multiplication with each element in the filter matrix left column. The input activations in the second column of the input activation matrix are reused 6× times for multiplications with the first and second columns of the filter matrix. The input activations in the third, fourth, and fifth columns of the input activations matrix are reused 9× times.

The input activations of the sixth and seventh columns are, in a similar manner to the second and first columns respectively, reused 6× and 3× times respectively.

FIG. 7C illustrates, with respect to the multiplication of activation elements in the fourth column (D0-D127; see last row of images in FIG. 7A), how the same set of input activation elements are reused for each of the 3×3 filter elements, resulting in a 9× times reuse.

### Packing Multiple Images

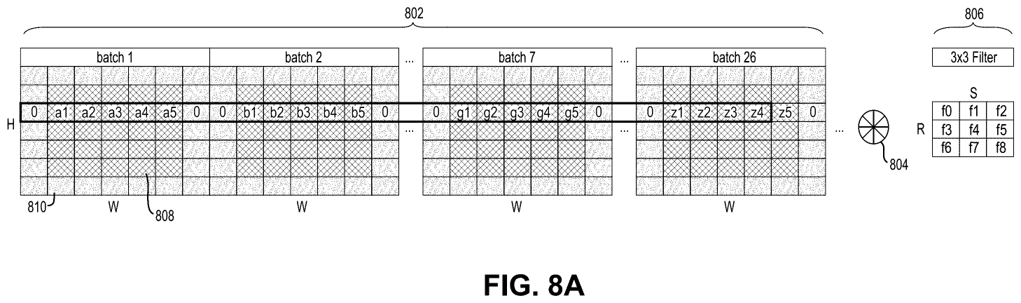

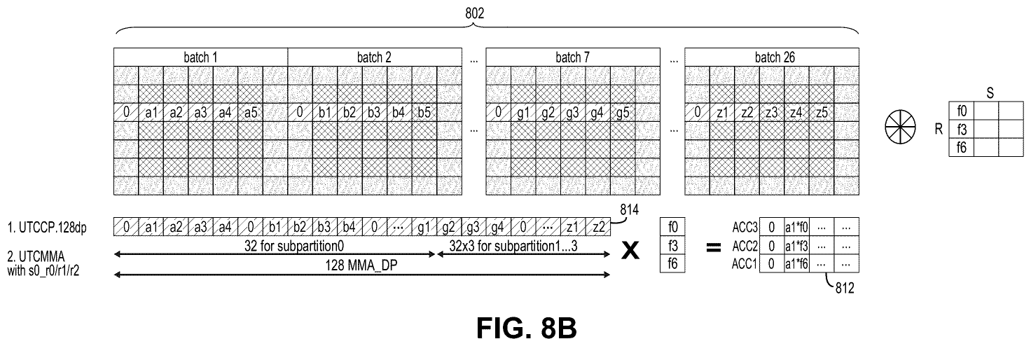

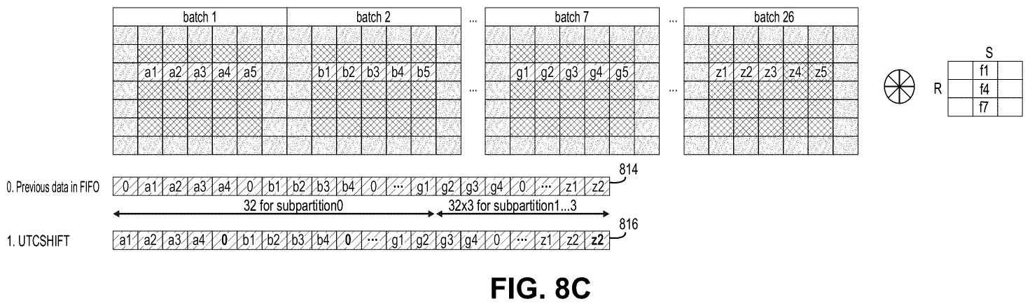

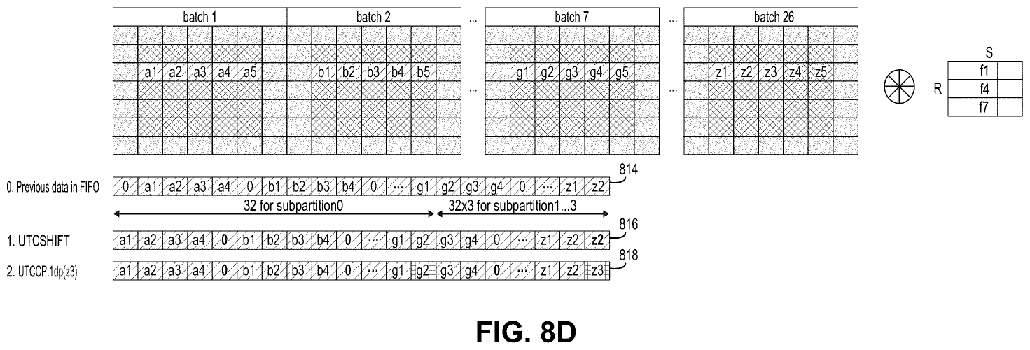

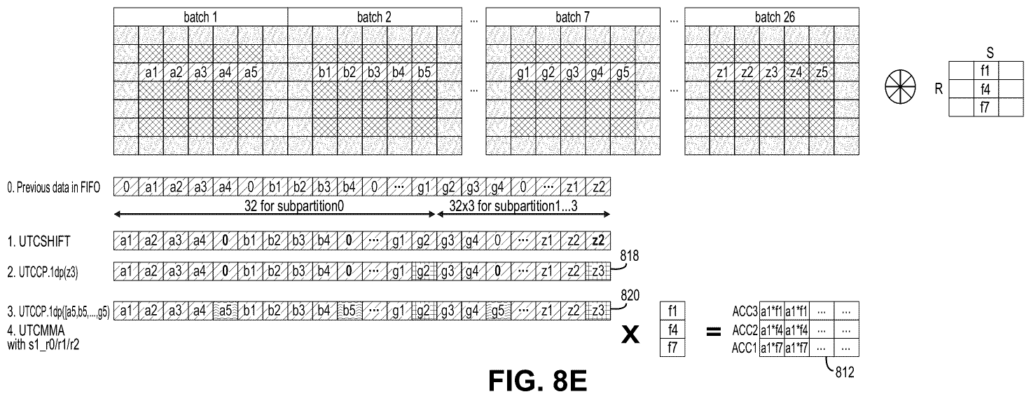

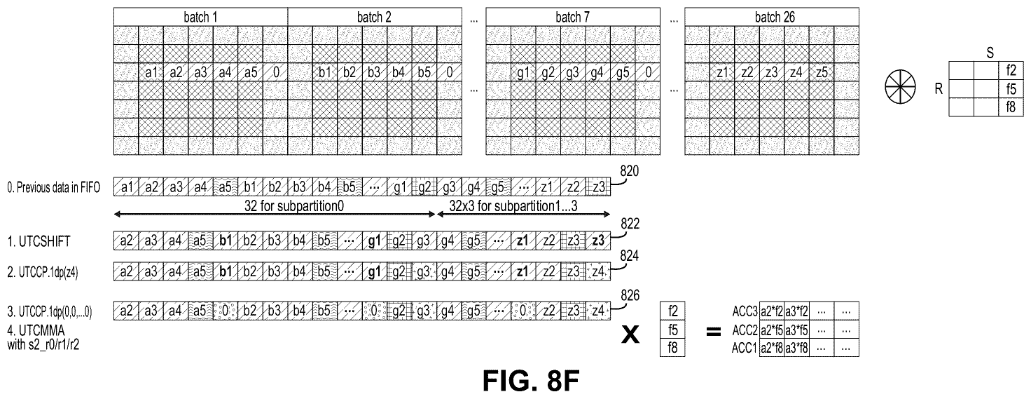

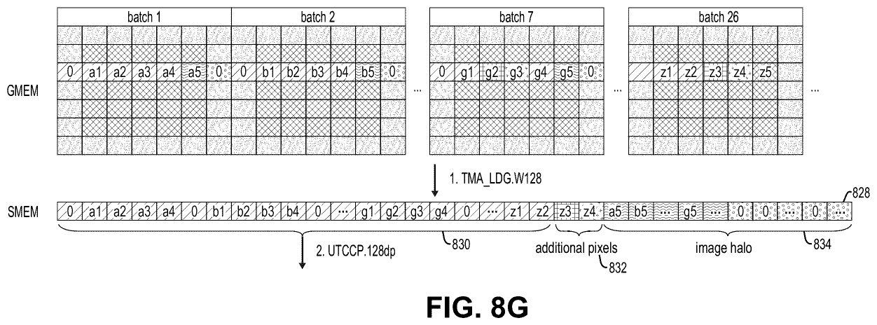

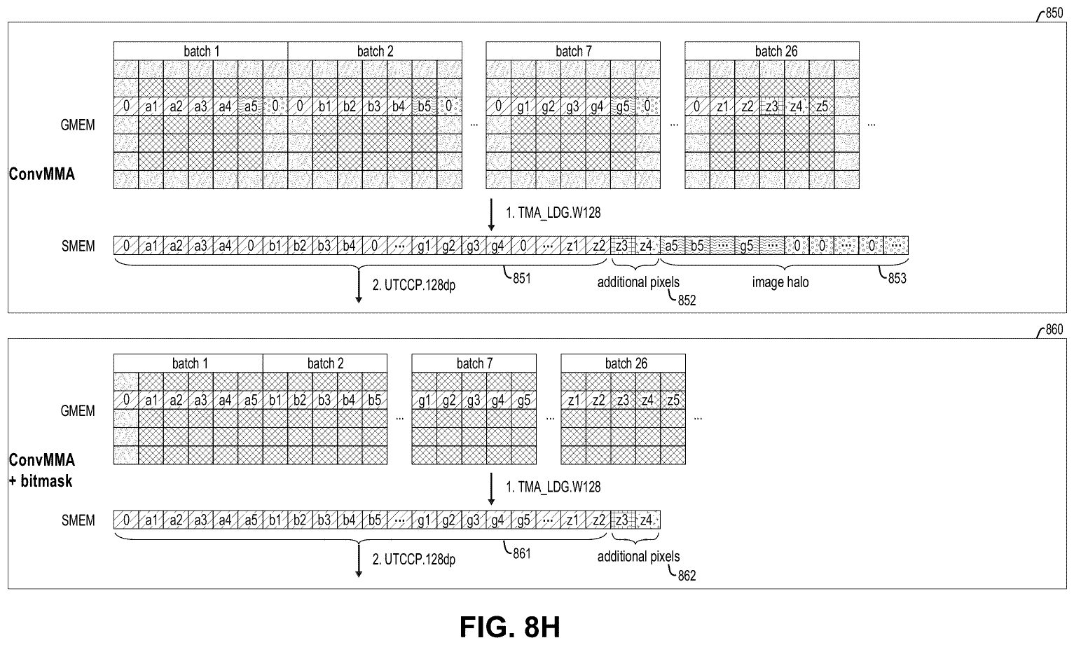

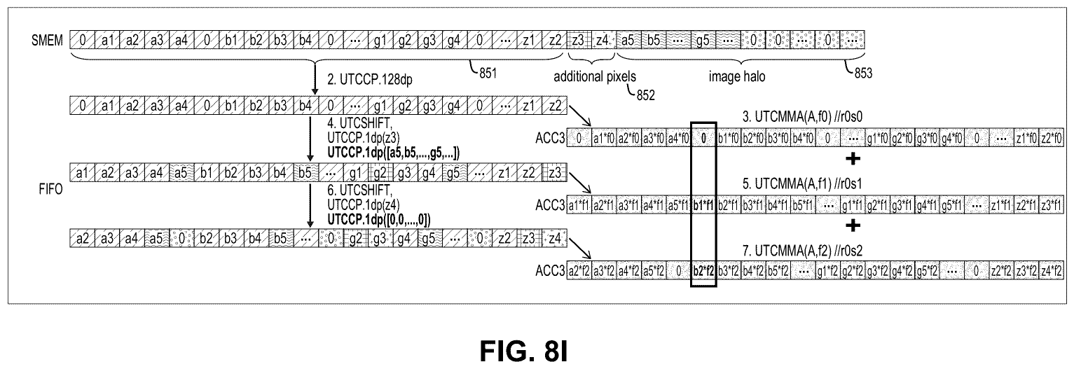

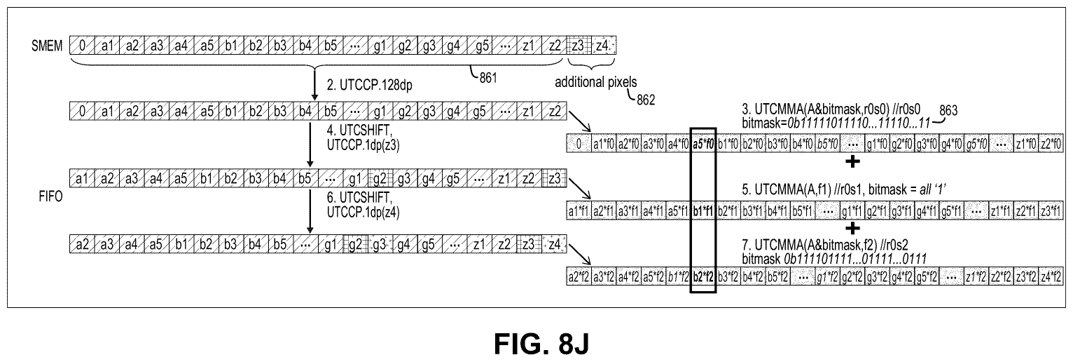

FIGS. 8A-8J illustrate a process for packing multiple images as input activations for providing to the datapath. As noted above in relation to FIG. 3C, in an example implementation, the process of dot product calculation of a vector of input activations and the vector of weights is performed on multiple input images packed one on top of another so that the result can be collected in an accumulator output corresponding to the multiple input images. For example, in each step shown in FIG. 3C, the accumulator elements of the illustrated vector would be affected for a respective row corresponding to each of the input images. That is, for example, if N=128 (i.e., 128 input images are to be packed to be provided to the datapath), then each of the vectors illustrated in step 3.1 for the input activations, weights and accumulator would have a height of 128. The process shown in FIGS. 8A-8J may be used in packing the multiple input images.

There may be multiple ways in which the multiple input images are packed so that the input vector can have a height representative of the number of images. For example, NQ-tiling, NP-tiling, etc., that corresponds to taking a slice from each image (in the P-direction or the Q-direction) and then tiling the slices one on top of another. The so-constructed slices can be then provided as input to the datapath processor. However, when packing the different images, steps are required to avoid certain issues that could arise at image boundaries.

FIG. 8A shows an example NQ tiling (N refers to the number of images and Q refers to that the images are being tiled along the Q-dimension of the subsequent output image). The illustrated example is for a plurality of H×W=5×5 images 802 to be arranged to produce a P×Q=5×5 image based on a dot product 804 with a R×S=3×3 filter 806.

Each of the 5×5 input images 802 is obtained by slicing a respective input image from the set of input images in the Q-dimension. Each 5×5 image 808 is arranged with a 1-pixel wide border (halo) 810. In the embodiment described in relation to FIG. 8A-8J, it is assumed that the halo comprises pixels of value 0 and that the border pixels (halo pixels) do not contribute to the value of the accumulator output resulting from the dot product operation.

A vector (an input activation vector) of 128 elements is to be formed from the 26 images 802.

The process may begin by issuing a copy instruction that copies the first 5 bytes from each of the first 25 images (i.e., image 1 to image 25) and the first 3 bytes from the last (26^{th}) image to obtain a total of 128 bytes. The data may be copied to a local memory of the datapath processor. For example, the data can be copied to a local memory buffer B (e.g., local memory buffer 530). The vector 814 in FIG. 8B illustrates the data as it is in the TMEM after the copy instruction. A diagonal line fill pattern in each of the plurality of images 802 shows the pixels from each image that are in the local memory buffer, i.e., currently in activation vector 814 in the local memory buffer.

The copy instruction may be followed by a MMA instruction for the dot product with the first column of the weights, and resulting in updates to the first column in accumulator 812. FIG. 8B shows the copy instruction and the MMA instruction's operation.

FIG. 8C shows the operation of a shift instruction. The shift instruction causes activation vector 814 in the local memory buffer to be shifted one pixel (e.g., to the left in the illustration) to result in vector 816. As can be seen, the leftmost 0 in vector 814 is no longer present in vector 816, and a stale z2 remains in the rightmost pixel position because the z2 value that was present in that position in vector 814 has now shifted one to the left. It should also be noticed that a boundary pixel of value 0 from each of the images (except for the first image) is still present in vector 816. The boundary pixels and the stale pixels in vector 816 are shown in a bold font in the illustration to indicate that they are intended to be replaced.

As shown in FIG. 8D, the stale value in the rightmost element position is replaced using a copy instruction to copy the next unread element z3 from the last image to the rightmost element position. Vector 818 is illustrative of the activation vector in the local memory buffer (e.g., local memory buffer 530) after the copy instruction to copy the element for the rightmost position.

In vector 818, it can be seen that the boundary elements, which are considered stale or invalid and hence marked in bold font in the figure, from several of the images are still present in vector 818. As shown in FIG. 8E, another copy instruction causes the boundary pixels in vector 818 to be replaced with the next unread element from each of the respective images. Thus, vector 820 illustrates that the first (from the left) boundary element (halo/padding) present in 818 is replaced with the next unread element a5 from the first image, the second (from the left) boundary element present in 818 is replaced with the next unread element b5 from the second image, etc.

Next, an MMA instruction causes the dot product to be calculated of vector 820 and the second column of the weights, causing the left most two columns of the accumulator 812 to be contributed to. FIG. 8F illustrates a situation when the input activations are to be shifted down one row.

The process proceeds by issuing a shift instruction to cause the leftmost element (in the illustrated scenario, a1) to be shifted out, resulting in vector 822 in which the rightmost position now is stale (because the value that was in that location is now located one element to the left). A copy instruction is issued to copy a new value to the rightmost element position. In this instance, the new element is the next unread element z4 of the last image. Vector 824 illustrates the local memory B (e.g., local memory buffer 530) after the rightmost position has the newly read value z4.

However, the shifting also results in the first pixel from an image being shifted into the position corresponding to the image on its left (in the illustration of the plurality of images 802). For example, in vector 824, it can be seen that “b1” from the second image has now shifted into the space of the first image.

The MMA operation, if performed using 824, would yield incorrect results, and therefore the locations in which one image runs into the space of another should be rectified before the MMA operation. The approach illustrated in FIG. 8F is a first approach to making this rectification.

The shifting of the input activations by one row requires that the input activation vector of each of the images is shifted down. Therefore, the first image element of each image (except for the first image for which a1 was already shifted out) is replaced with a value of 0, resulting in vector 826. This replacement can be performed by issuing a copy instruction that copies a specified value to each of a plurality of locations. Notice in vector 824 that the first image elements of each of the images except for the first image is shown in bold font, and that these elements have been replaced with a value of 0 in vector 826.

The dot product of vector 826 and the first column of the weights is calculated resulting in contributions to the first two columns of the accumulator.

FIG. 8G illustrates the 128-element activation vector layout in GMEM needed for the convolution operations described in relation to 8A-8F, and the also the layout of the activation vector data in SMEM subsequent to the TMA load instruction to copy data from GMEM to SMEM.

The activation vector, read in an NQ format from GMEM, is loaded with a single load instruction for reading 128 pixels, in to SMEM arranged so that the initial activation vector 830 of 128 pixels is in contiguous memory followed by the subpartition halo (in the illustrated example, pixels z3 and z4 from image 26) 832, and an image halo 834 component.

The subpartition halo elements 832 are added to the end of the activation vector, when a horizontal shift occurs. With the 3×3 filter matrix, only two shifts are required, hence two additional pixels are loaded for refreshing the vector after respective shift operations. The image halo pixels 834 are copied into positions to which the halo pixels are shifted in as a result of shifts.

FIG. 8H shows two approaches of carrying out the sequence of MMA instructions. The first approach 850, shown in FIG. 8I in more detail, involves copying halo pixels separately to SMEM and subsequently copying them in to the activation vector in the local memory buffer as needed for shift operations, and the second approach 860, shown in FIG. 8J in more detail, uses a bitmask (disable bitmask) to inform the processor that certain pixel locations do not contribute to the result being accumulated.

FIG. 8I shows the first approach. At the top, the activation vector layout in SMEM is shown as it is after the GMEM to SMEM copy instruction moves the 128 pixels of the activation vector 851 and additional pixels 852 to SMEM. As can be seen in 850 in FIG. 8H, in the first approach the halo pixels 853 are also either included in the initial 128 pixels copied 851 to SMEM or are loaded as image halo pixels 853. The additional pixels 852 to be shifted in at the end of the activation vector are also loaded into SMEM. FIG. 8I, on the left, illustrates the content of the 128-pixel activation vector in the local memory buffer after sequences of SMEM to local memory buffer copy instruction(s), shift instructions and MMA instructions. On the right, the accumulator contents in the result matrix are illustrated as they change in response to the sequence of instructions.

FIG. 8J shows the second approach. At the top, the activation vector layout in SMEM is shown as it is after the GMEM to SMEM copy instruction moves the 128 pixels of the activation vector 861 and additional pixels 862 to SMEM. As can be seen in 860 in FIG. 8H, in the second approach the halo pixels (except optionally the first halo pixel in the first image) are not included in the initial 128 pixels copied 861 to SMEM and are not loaded as image halo pixels. The additional pixels 862 to be shifted in at the end of the activation vector are also loaded into SMEM. FIG. 8J, on the left, illustrates the content of the 128-pixel activation vector in local memory buffer after sequences of SMEM to local memory buffer copy instruction(s), shift instructions and MMA instructions. On the right, the accumulator contents in the result matrix are illustrated as they change in response to the sequence of instructions in conjunction with bitmask 863.

The second approach allows for halo pixels 853 to not be loaded into SMEM, and instead to have the bitmask 863 indicate the pixel positions in the 128-element vector that should be ignored when the result of the dot product of a particular activation vector and filter element row/column is written to the accumulator.

### TMAU Support

In some embodiments, a specialized unit such as, for example, the TMA asynchronous unit (TMAU) 1141 (see FIG. 11A) provides the MMA datapath 1250 with the input data. More particularly, the TMAU 1141 may copy the input activation data from GMEM/L2 to SMEM 1270 and/or from SMEM 1270 to the datapath 1250. Some embodiments require multiple activation data loads from SMEM to the MMA tensor memory (TMEM) 1251 or from SMEM 1270 to the datapath 1250. TMAU may provide one set of instructions to move data between GMEM/L2 and SMEM, a second set of instructions to move data between SMEM and a local memory buffer (e.g., local memory buffer 530) associated with the B-input of the datapath, and a third set of instructions to move data between the local memory buffer and the MMA datapath 1250. Since the data layout in GMEM may be arranged in various manners (e.g., NHWC tensor layouts), the TMAU may perform the data loading from the GMEM to SMEM so that the data is arranged in SMEM in a manner that is more convenient/efficient for consumption by the MMA unit.

In some embodiments, the datapath 1250, also referred to as the MMA unit, comprises 128 datapath lanes. In such embodiments, before any math operations of the MMA are started, a 128-element long vector of the input activation elements is loaded to feed the datapath 1250. The vector may be a contiguous sequence of elements along the W dimension of a NHWC tensor of input activation matrix data. The vector of input activation elements may be referred to as an input activation vector. Each input activation vector element has one or more channels along the C dimension, each channel providing an amount of data, for example but not limited to, 128 bytes. As noted above, in some embodiments, the TMAU is responsible for loading the vector from the tensor of input activation matrix data in GMEM (or L2) to the local memory buffer.

When the input image is a large image, then all lanes of the entire datapath can be populated with elements of the same image and the construction of the vector of input activation elements may not involve complexities. For example, when the image has a number of pixels that is larger than the number of datapath lanes (e.g., datapath lane 502 shown in FIGS. 5A-5B) in the datapath processor, each datapath lane in the datapath processor can be loaded with a respective pixel from the image so that all datapath lanes are active simultaneously. However, when the input images are smaller (e.g., 16×16 or the like, smaller than the example, but non-limiting, datapath width of 128 pixels), then multiple images are required to be packed together to be provided as input to the datapath so that all lanes, or substantially all lanes, of the datapath can be active during the MMA computations. FIG. 8A-8J concerned packing several smaller images to construct a 128-element input activation vector.

In some previous MMA implementations, as already noted above, the tiled mode and the im2col mode were used to load image data for use by the MMA unit (also referred to as the “datapath” or “datapath processor)”. As noted above, U.S. application Ser. Nos. 17/691,422, 17/691,422 and 17/691,406, already incorporated by reference, describe tiled and im2col-based techniques in some existing implementations. However, the tiled mode of TMAU operation does not allow for continuous image crossings along a single dimension, and the im2col mode does not provide sufficient flexibility to allow a bounding box to be sized to a single row. Therefore, example embodiments introduce a third mode of TMAU load operation to load the data needed by the datapath from GMEM to SMEM. In this disclosure, this TMAU load mode is referred to as “w128”-“w” indicating that the row is along the W dimension (e.g., a dimension in the NHWC tensor format) and the “128” indicating that the row is 128 elements wide. It should be noted that embodiments are not limited to a particular dimension or width of the row of elements to be loaded.

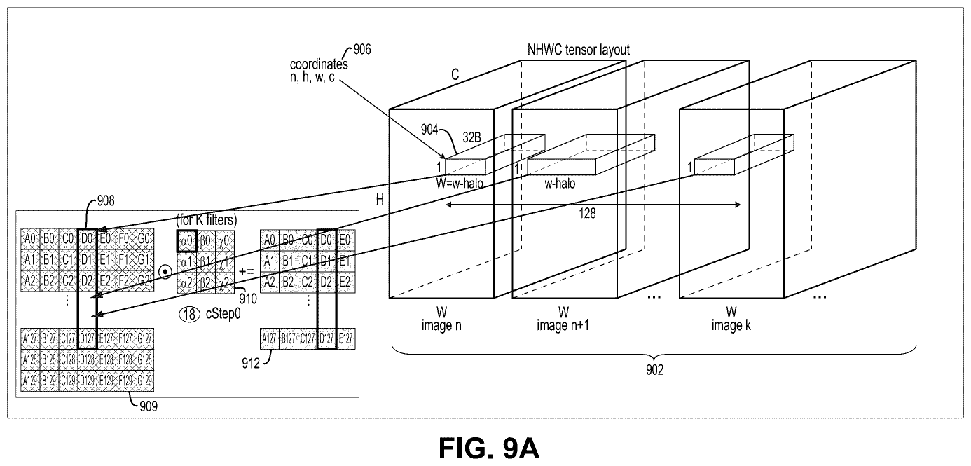

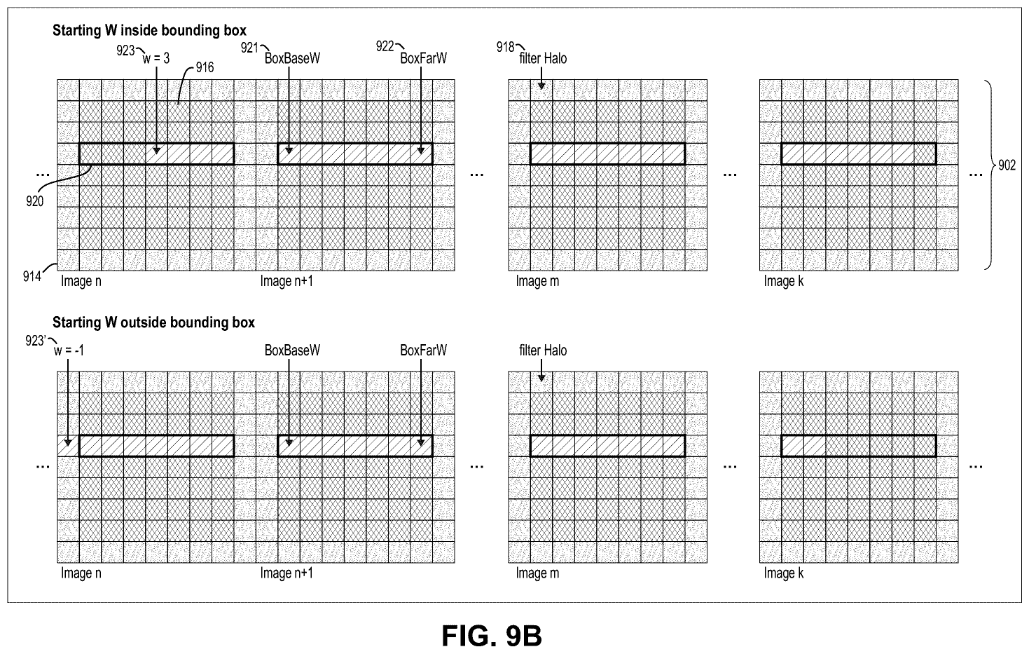

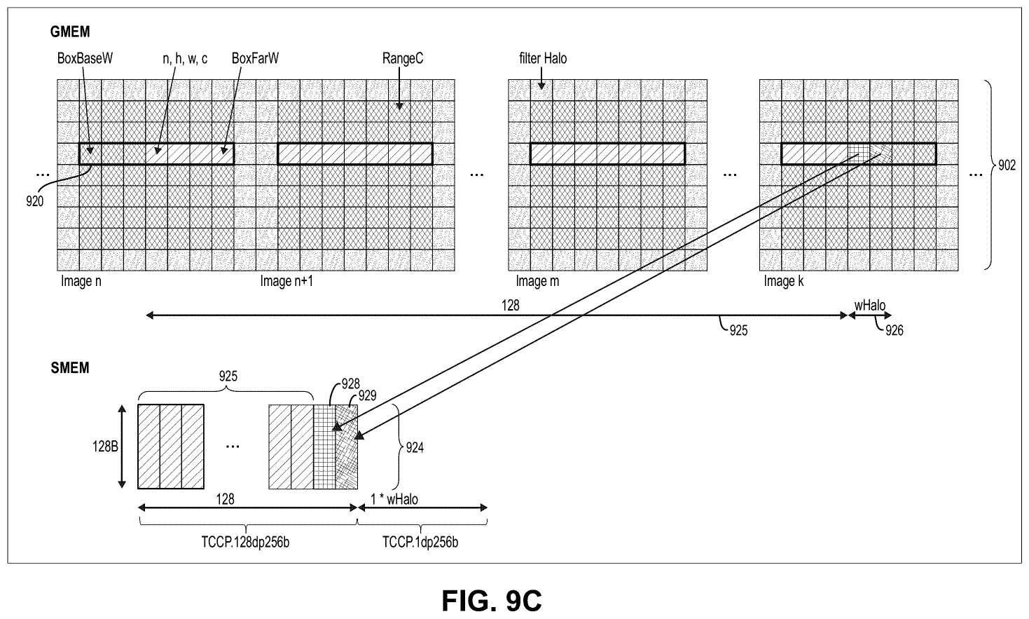

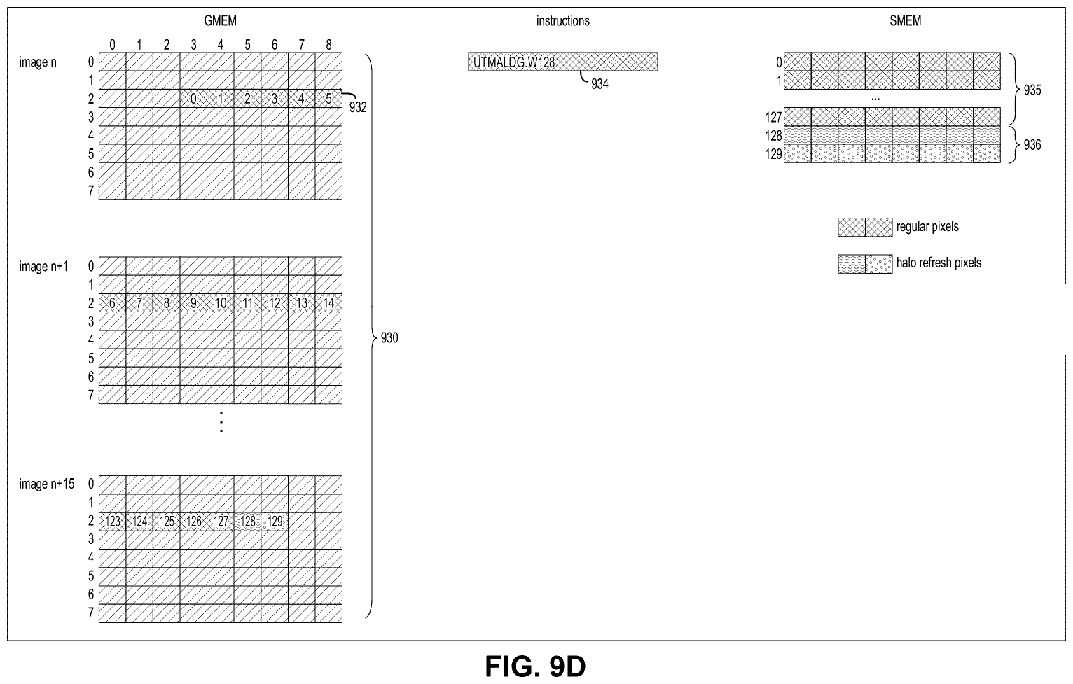

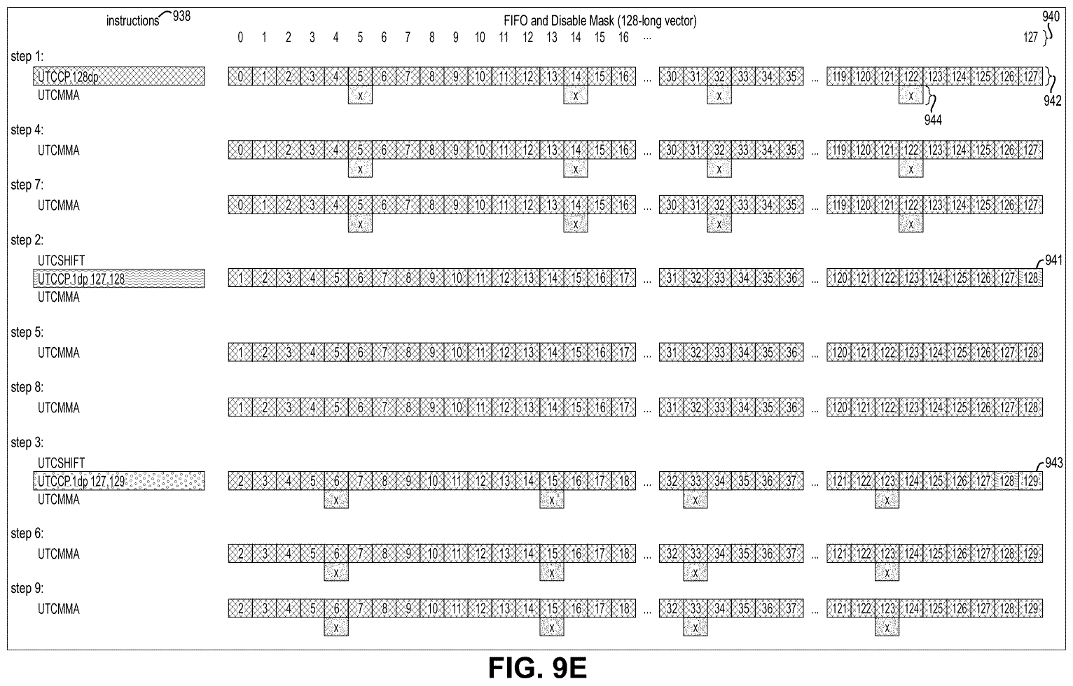

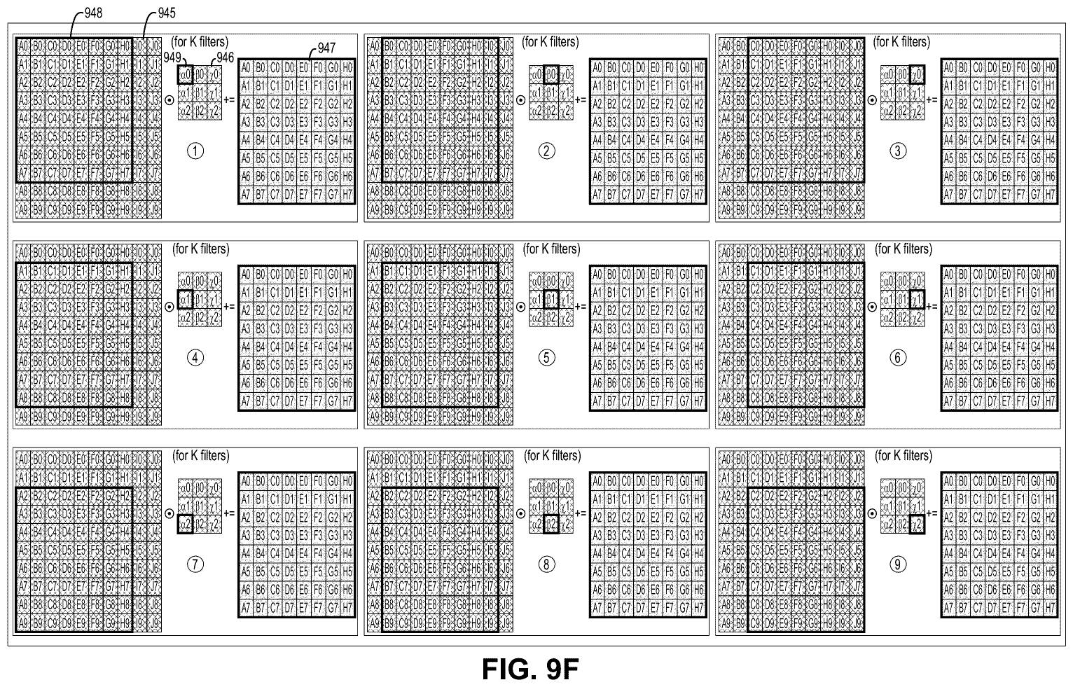

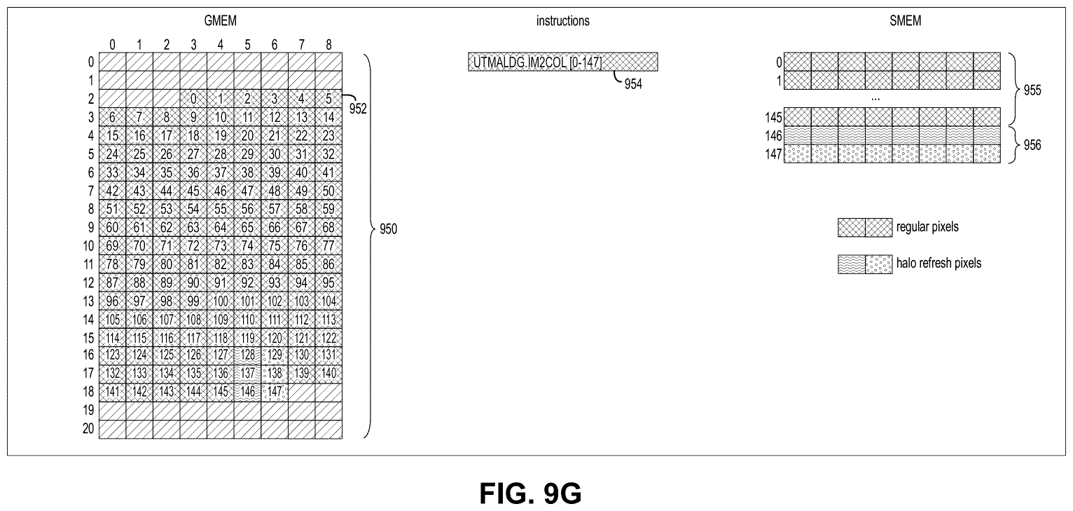

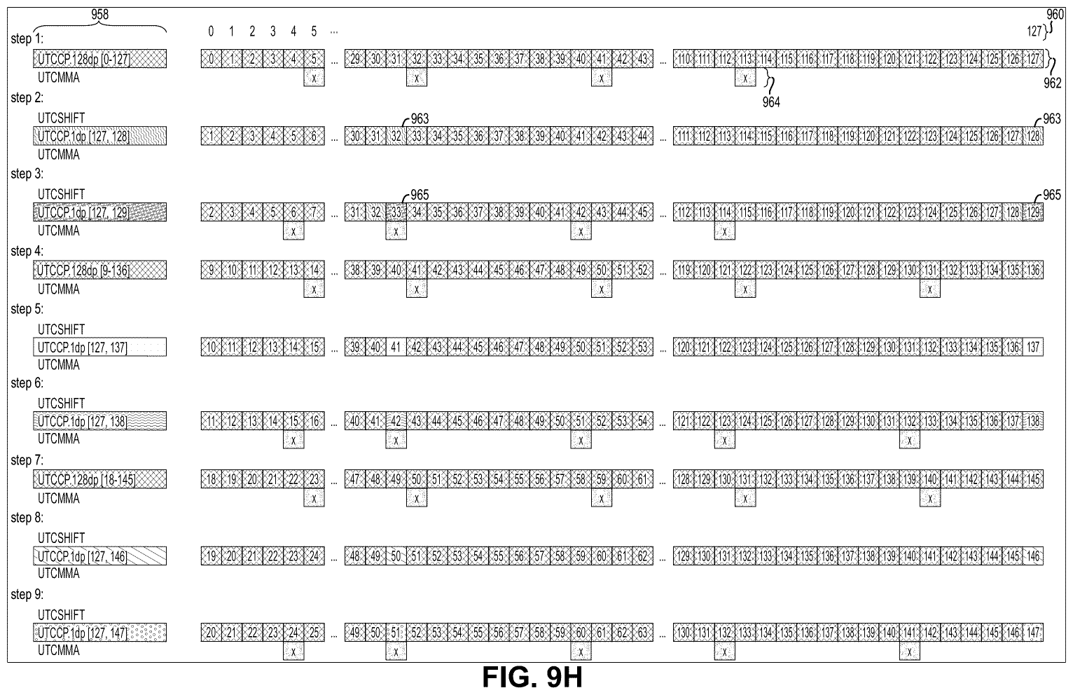

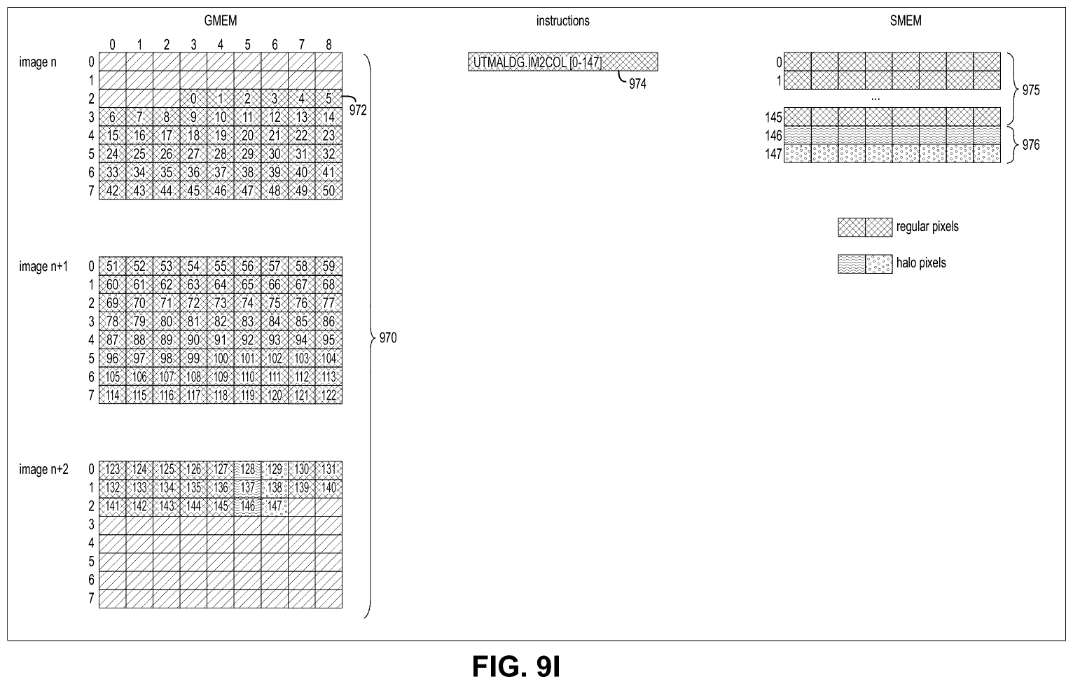

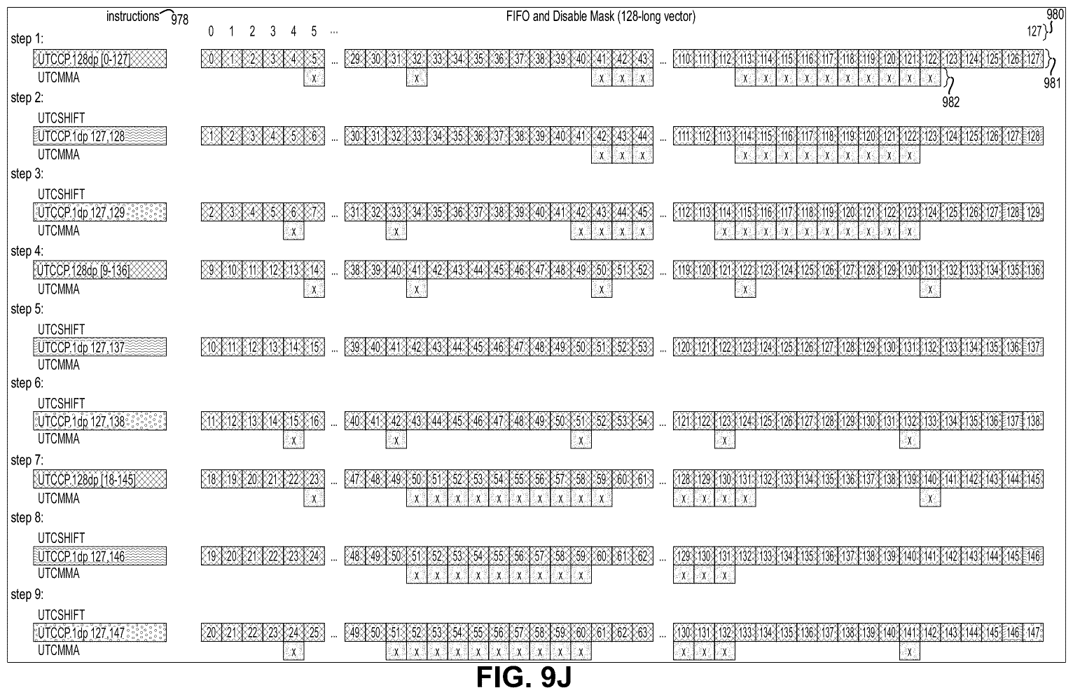

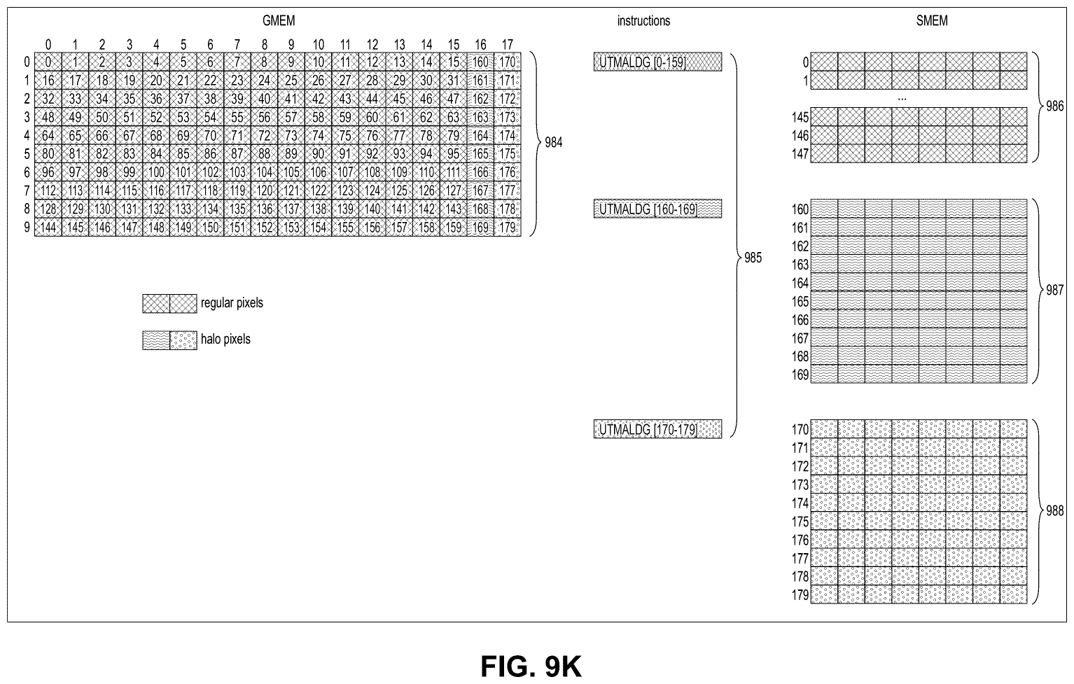

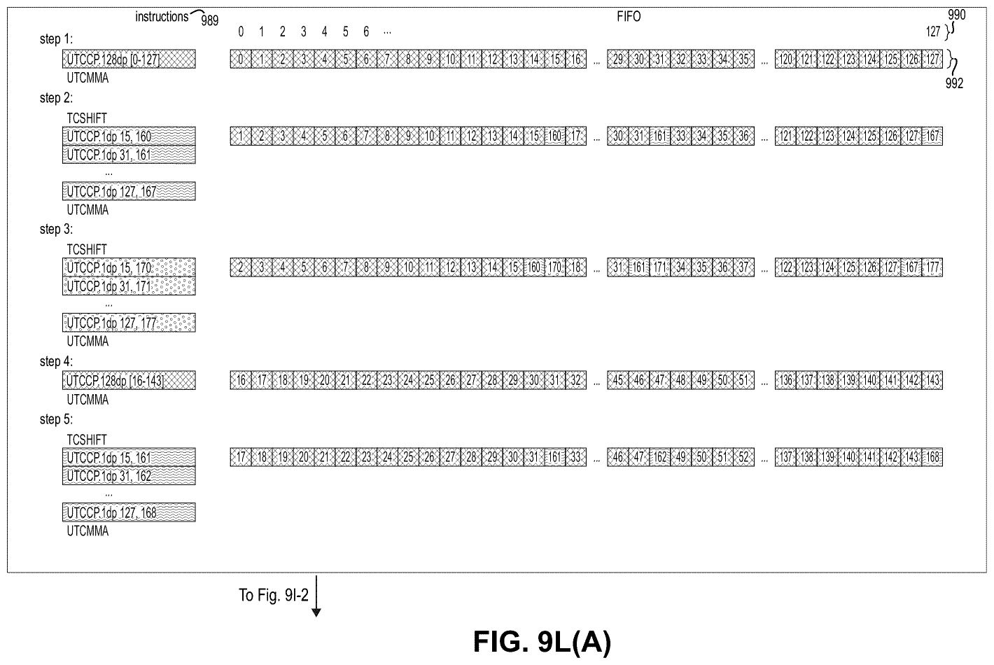

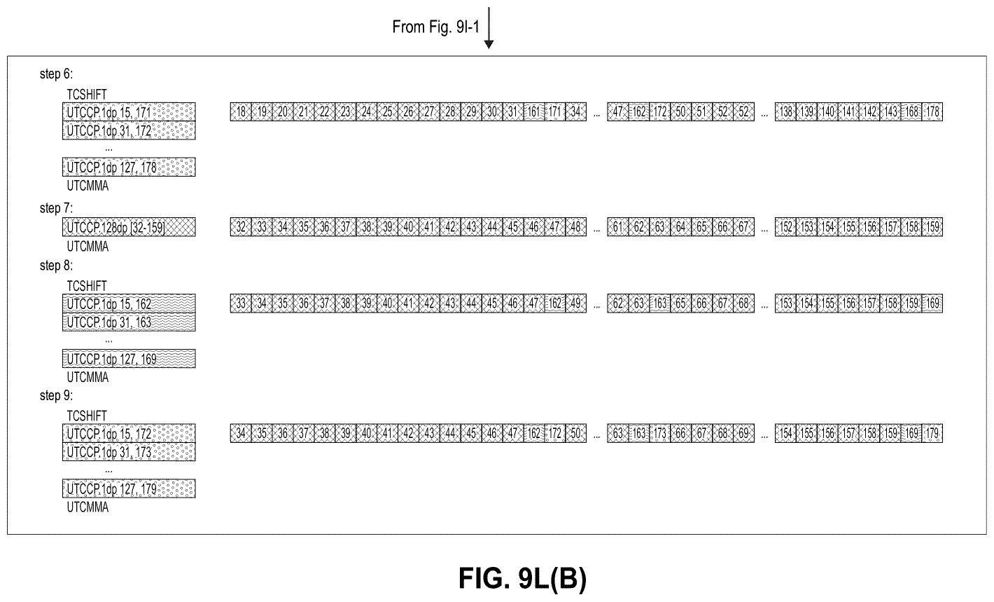

FIG. 9A illustrates a NHWC tensor layout that comprises multiple (e.g., N) images where each image is of size H×W×C. Any pixel in the N images can be referenced by its coordinates which comprises a coordinate along each of the 4 dimensions-n, h, w, and c where h and w refer to the height and width of an image respectively, c refers to the channel number (each pixel includes data for a plurality of channels), and n refers to an image number from among the number (e.g., N) of images included in the tensor. The vector of activation elements for the datapath is constructed to include some image pixels from each image in a sequence of images from the N images such that in total 128 pixels are in the vector.

FIG. 9A also illustrates a step in an MMA calculation involving an input activation matrix 909, a weights matrix 910, and a results matrix 912. As illustrated, the input activation vector 908 is formed from pixels along the W dimension, and, for example, each indicated D0, D1, D2, . . . D127 element shown is a pixel in the W-dimension in the same column of pixels from the N images 902. Each image in the N images 902 contributes one or more pixels in the same row of pixels from respective images to the 128-element input activation vector 908. Each image in the N images 902, except perhaps the first and the last images, may contribute the same number of pixels to the input activation vector 908. The first and last images may sometimes contribute numbers of pixels that are different from the number of pixels contributed by the other images. As noted above, each pixel can be identified by a <n, h, w, c> coordinate 906.

FIG. 9B shows two possible layouts of the row of pixels shown in FIG. 9A in 2D in the set of images 902. Each of the images consists of 9×9 pixels in H×W dimensions. Each image has 7×7 image pixels 916 surrounded by a single-pixel wide halo 918 along the H and W dimensions. The TMAU 1250 may define a bounding box 920 of fixed width, with a fixed starting point 921 and an end point 922 within the image. Beginning at any specified location in one of the N images, the TMAU may select contiguous pixels from a sequentially continuous plurality of the N images until 128 pixels are selected. In the first illustrated layout (in the top row of images in FIG. 9B), the starting element 923 of the row is within the bounding box of the first image. In an alternative layout as shown in the bottom row of images in FIG. 9B, the starting element 923′ may be outside any bounding box and in the halo of an image. The coordinates of the starting element may be specified in relation to the starting point of the bounding box. For example, the coordinate for starting point 923 may be 3 indicating that it is the fourth element inside the bounding box (the first element within the bounding box being element 0), and the coordinate of starting point 923′ may be −1 indicating that it is the first element outside of the bounding box. Even in the case of starting outside of the bounding box, after starting with one or more contiguous halo elements, contiguous pixels from continuous images are selected for the 128-element vector. The halo can be defined based on the stride and/or dilation of the MMA operation.

FIG. 9C illustrates pixels from bounding boxes 920 from the images 902 in GMEM being arranged in contiguous memory space 924 in SMEM.

In some embodiments, as illustrated additional pixels 926, more than the 128 image pixels 925 are also loaded from the GMEM to SMEM to be adjacent to the contiguous memory in which the 128 image pixels 925 are arranged. In some embodiments, in addition to the additional pixels 926 that are obtained from pixels that sequentially follow the first 128 image pixels, a certain number of pixels from within the 128 pixels may be duplicate loaded in order to be subsequently used for handling certain implementation aspects that are caused by subpartition boundaries. The additional pixel sets 928 and 929 as arranged in SMEM, in example embodiments, may include at least one pixel in set 928 and at least one pixel in 929. In one particular embodiment in which there are no subpartition-related constraints, only a single additional pixel is required in each set 928 and 929, and in another implementation in which the datapath in an SM 1140 includes 4 subpartitions, each set 928 and 929 includes four pixels. Two of the additional pixels occur sequentially after the end of the 128 image pixels as arranged in GMEM, as, for example, shown by the pixel positions at the beginning of the two arrows pointing to pixels 928 and 929 shown in FIG. 9C. The other additional pixels, if required by the implementation, are obtained from respectively designated positions from within respective bounding boxes, where the respective positions correspond to subpartition boundaries or the like. In an example embodiment, the number of additional pixels required correspond to a number of pixels that is equal to the width of the halo multiplied by the number of shift operations required to traverse the weight matrix. In the illustrated example in which the halo is 1 pixel wide and the weights matrix is a 3×3 matrix that requires two shift operations (one shift when the considered weight changes from the first row of weights to the second row of weights, a the second shift operation when the considered weight changes from the second row to the third row) to be traversed, the additional pixels include two pixels sequentially extended beyond the first 128 image pixels of the activation vector.

In an embodiment, a single TMA instruction loads both the initial 128-long activation vector and the elements for all the shift refresh loads. There may be two types of the refresh loads: at the sub-partition boundaries (in embodiments in which the SM includes sub-partitions) and at the image boundaries. The 128-long vector is loaded in the first block 925 immediately followed by the block of the sub-partition refresh elements (not shown in FIG. 9C), which in turn is followed by the image refresh elements block 928 and 929.

In some embodiments in which sub-partitions exist, sub-partition boundary updates may be needed when, for example, the sub-partitions do not have direct interconnections between them to copy data across the sub-partitions. The shift operation moves data between the neighboring memory locations. When sub-partitions lack direct connection between them, the data update may be made from the SMEM to local memory buffer (e.g., local memory buffer 530) at the sub-partition boundaries. The updates may be done at the activation vector locations. A version of the copy instruction (e.g., UTCCP instruction) for which source element and target location can be specified for multiple elements can be used for supporting the update. In some embodiments, for each refresh cycle the data for all four sub-partitions is loaded in the contiguous SMEM space.

Like in im2col mode the starting traversal coordinate in the tensor in GMEM is specified within the bounding box. In some embodiments, when TMAU traverses the image elements it can detect the end of the bounding box. If detected, TMAU continues the load process within the image halo space. The halo elements are loaded to the image boundary SMEM refresh block. Once TMAU loads all the required elements from the halo space it switches to the bounding box of the next image and continues the activation vector load.

While within the bounding box, TMAU can detect if it loads the element which is at sub-partition boundary (e.g., at the distance of the module of 32 from the starting element). If detected, then wHalo number of elements are loaded to sub-partition SMEM refresh block. The elements are duplicated in the sub-partition SMEM refresh block in addition to the original SMEM destination. TMAU may handle the duplications by issuing the L2 requests for the same elements twice with different SMEM destination addresses.

In some embodiments, the TMAU may support any one or more of 4 different modes of preparing the input activation vector—that is, 4 different ways of preparing and using data. FIGS. 9D-9E provides a conceptual illustration of the loading of the input activation vector from a plurality of images in GMEM to the local memory buffer (e.g., local memory buffer 530) for use by the datapath, according to one of the 4 modes.

As shown in FIGS. 9D-9E, in the NQ approach (NQ mode) the activation vector is constructed from a single row of the activation image(s). The row could be taken from a single image, or multiple images depending on the image size and starting pixel within the image row. If the images are small, then preferably the image batch should be large enough to provide enough pixels for the 128-long pixel vector. The datapath would be underutilized if the vector length is less than 128.

In FIG. 9D the construction of the input activation vector 932 from 16 images (image n to image n+15) 930 is shown. Each image is of P=8 pixels and Q=9 pixels dimensions. Four channels C (C=4) may be loaded for each image. In some embodiments, each channel may provide 32 bytes of data. Each image pixel can be considered as 128 bytes because each has its own channel information. The activation tensor (e.g., the input images 930) layout in GMEM (shown in the left in FIG. 9D) may be the NHWC layout which was described above. The size of the weights matrix for the convolution MMA is 3×3 pixels.

The TMAU as described above defines a fixed-width bounding box, and the image pixels for the activation vector are obtained from within the bounding box in each image. In the illustrated example, the first element for the input activation vector 932 is the element 3 (i.e., column 4) in the third row of the first image (image n), and the pixels of the third row in each of the images image n+1 to image n+14 are represented in the input activation vector 932. Only the first five pixels of the third row of image n+15 are required to fill up the 128-pixel input activation vector. Then, the two pixels that sequentially follow the input activation vector elements 0 through 127 (note that the number illustrated within vector 932 represents the pixel position within the vector) in the images 930, specifically the pixels identified as pixel 128 and pixel 129 in image n+15, are also included as additional pixels in the input activation vector 932. As noted above, the additional pixels are used for facilitating the shift operation.

In one embodiment, in response to a GMEM to SMEM data load instruction (e.g., UTMALDG.W128) 934, the TMAU copies the input activation vector 932 to SMEM. The activation vector may be arranged in contiguous memory in SMEM so that a first area 935 in SMEM includes the image pixels 0-127 of the input activation vector 932 stored contiguously, with a second area 936 storing the additional pixels (e.g., pixels 128 and 129). The first and second areas may, but is not required to, be adjacent to each other. For example, in some embodiments, the first and second areas form a continuous block of memory in SMEM. In FIG. 9D, different fill patterns are used to distinctly identify the regular pixels (i.e., the first 128 image pixels of the input activation vector) in SMEM area 935 and the additional pixels (also referred to as “halo refresh pixels”) in the SMEM area 936. The additional pixels are shown in two distinctive fill patterns to illustrate that they represent additional pixels that are used for facilitating a first shift operation and a second shift operation. Thus, according to an embodiment a single GMEM to SMEM data load instruction (e.g., UTMALDG.W128) 934 loads both the initial activation vector and the halo refresh pixels from GMEM, arranged as shown on the left side of FIG. 9D, to SMEM and arranged as shown in the right side of FIG. 9D.

FIG. 9E illustrates convolution MMA execution instructions 938 on the left side and the activation data layout 942 in the local memory buffer (e.g., local memory buffer 530) as that data is arranged for the respective datapath lane inputs (i.e., datapath lanes 0 to 127) 940 on the right side. It also includes a write mask 944 (e.g., TCMMA instruction Write Mask, also “disable mask”) that is used in some embodiments.

The sequence of instructions 938 provides the data from the SMEM, as arranged in memory areas 935 and 936, to the local memory buffer (e.g., local memory buffer 530) for and during the MMA operations. The enumeration of steps in instruction sequence 938 corresponds to the graphically illustrated steps in FIG. 9F. FIG. 9F illustrates an example vector of activation elements 948 being obtained from a image tensor 945 at each of steps 1-9 that is required for the image tensor 945 to be used in a dot product calculation with the weights matrix 946 in order to yield the results matrix 947. Note that each step 1-9 corresponds to a different weight element 949 being used for the dot product calculation with vector 948. Each element in the result matrix 947 may be mapped to a respective datapath lane in the datapath.

The first SMEM to the local memory buffer (e.g., local memory buffer 530) copy instruction (e.g., UTCCP.128dp) from the sequence 938 copies the 128-pixel input activation vector 932 from SMEM to the local memory buffer. The input activation vector elements are arranged as inputs 942 to the respective datapath lanes 940. Initially (i.e., when the activation vector is first loaded from SMEM to the local memory buffer), the activation vector elements 942 that are provided as input to the datapath lanes 940 (e.g., datapath lanes 0 to 127) are the first 0-127 elements of the activation vector as arranged in the SMEM area 935. Then a sequence of MMA instructions (e.g., UTCMMA) cause dot product calculations of respective elements along a row of weights (see FIG. 9F) with that of input activation elements of vector 932 to contribute to the result matrix accumulator elements (e.g., shown, for example, in FIG. 9F). The datapath may also be provided with a disable mask (bitmask 944) to indicate that the masked pixel positions should not contribute to the calculated results of the dot product. That is, for example, results of multiplication of the masked pixel positions are not added to the corresponding accumulator. Note that following the above example, bitmask 944 indicates (i.e., illustrated in FIG. 9E by “x” in the respective pixel positions) that datapath lanes 5, 14, 32 etc. should not contribute to the accumulated result.

A shift instruction (e.g., UTCSHIFT) is issued at step 2 in the sequence 938, followed by a single element copy instruction (e.g., UTCCP.1dp 127,128). The shift, as also noted above, shifts the row elements by one element (e.g., shifted to the left in the illustration), thereby discarding the leftmost element and, then the copy instruction loads a single pixel 941 to the rightmost location of the input activations vector. The single pixel 941 is the first pixel in the additional pixels 936 that was previously loaded to SMEM. In an example, the single element copy instruction to copy data from the SMEM to the local memory buffer (e.g., local memory buffer 530) can specify a source address (e.g., address in SMEM) and a target position in the row of input activations 942. In the illustrated example, element 128 from SMEM arrangement 936 is copied to the location 127 in the input activations 942.

After a few more MMA operations (3 MMA operations for the example 3×3 filter), a second shift and a second single element copy is performed in enumerated step 3 in the sequence 938. The second shift leaves the 128th element of row 942 empty or stale. The second single element copy copies data from location 129 in SMEM arrangement 936 to the location 127 in the input activations 942. For example, single pixel 943 is copied from the second additional pixel in the additional pixel area 936 in SMEM to the 128th location in the activation vector 942. Three more MMA operations follow to complete the steps shown in FIG. 9F.

The above is for NQ mode. This works well when a sufficient number of pixels along N and Q dimensions exists for the 128 pixel input activation vector. Q indicates that the data is loaded along the Q dimension and N represents that the input activations include data from N images. Thus, in NQ mode, each GMEM to SMEM copy of the 128-pixel input activation vector copies pixels from the same row from each of a plurality of images until the 128 elements of the activation vector are filled.

The NQ method is the most efficient in terms of the memory reuse at all levels (e.g., GMEM/L2 to SMEM and SMEM to MMA unit/local memory buffer 530) of the memory hierarchy. For the 3×3 filter the data from GMEM, SMEM, and the local memory buffer (e.g., local memory buffer 530) are reused 9 times. A single UTCCP.128dp instruction is issued to load the initial activation vector from SMEM to the local memory buffer (e.g., local memory buffer 530). The other load instructions (TCCP.1dp) are used for the small updates of the halo pixels.

A second mode of TMAU operations to copy data from GMEM to SMEM is the PQ linear mode. The PQ-linear mode is sub-case of the NPQ when the batch size holds a single image (N=1). This case may be typical for automotive applications where a camera produces single image at a time. It is named PQ-linear to differentiate from PQ-tiled mode, which is a different mode.

FIG. 9G illustrates an example GMEM data layout 950 of the activation tensor, SMEM data layout 955-956, and an example data transfer instruction 954 for copying the activation vector between these two memories for a 3×3 filter. Multiple instructions are needed to transfer the data. An im2col mode load instruction (e.g., UTMALDG.IM2COL instruction) loads the initial activation vector. The loaded initial activation vector includes two extra rows for the image halo along image top/bottom edges. FIG. 9H illustrates convolution MMA execution instructions sequence 958 and activation data layout 962 in the local memory buffer (e.g., local memory buffer 530) as provided to the respective datapath lanes 960. It also includes a write mask (e.g., TCMMA instruction Write Mask) 964.

FIG. 9G illustrates the pixels of image 950 in GMEM/L2 for purposes of loading the row of activations. The example single image has dimensions 9×21. The loading of the activations begins at a selected pixel in image n and loads contiguous 128 pixels extending to a pixel in another image (e.g., image n+2). For example, in the illustrated example, the 128 pixels are obtained from images 950 such that rows 2-7 are from image n, rows 8-15 are from image n+1, and rows 16-18 are from image n+2.

In this mode, two additional rows of pixel are appended at the end to the vector of activations. Thus, in activation vector 952, pixels 0-127, 130-136, and 139-145 are image pixels, and 128-129, 137-138, and 146-147 are halo refresh pixels.

In one aspect, considering a single image, the parameters for the illustrated image(s) 950 may be considered as N=1, P=19 and Q=9.

A single GMEM to SMEM copy instruction (e.g., UTMALDG.IM2COL[0-147]) 954 copies all 148 pixels from GMEM to SMEM. The SMEM areas 955-956 includes the pixels 0-147 being arranged such that the image pixels and the halo refresh pixels are separately and contiguously arranged in SMEM.

The sequence 958 of instructions illustrates the moving of the input activation vector 952 from SMEM to the local memory buffer (e.g., local memory buffer 530), and the use of the activation vector in the TMEM.

The sequence 958 follows the step ordering illustrated in FIG. 9F. In step 1, a first SMEM to the local memory buffer (e.g., local memory buffer 530) copy instruction (e.g., UTCCP.128dp[0-127] instruction) copies the first 128 pixels (pixels 0-127) from SMEM to the local memory buffer (e.g., local memory buffer 530) to setup the input activations 962 as input to the datapath lanes 960. An MMA instruction (using the write mask 964) is performed to calculate the dot product of the activation vector elements in the datapath and the first element (e.g., row 1 column 1) in the weights matrix.

At step 2, a shift instruction causes the activation input elements 962 to be shifted, so that the left most input element is no longer considered and the rightmost element becomes stale due to the shift. A four pixel copy instruction (e.g., UTCCP.4dp [32, 64, 96, 128]) causes the first halo refresh pixel (pixel 128) to be copied from SMEM 940 to the rightmost position 128, and also to positions 32, 64 and 96, in the activation elements 944. These positions to which halo refresh pixels are copied are identified in the disable mask 964. Then an MMA is performed. Step 3 similarly includes a shift, a copy and an MMA, but following the shift a second halo refresh pixel (pixel 129) is copied along with additional halo refresh pixels to positions identified (e.g., 965) in the activation vector 962.

At the end of step 3, the first row of the 3×3 filter has been used for MMA with the activation vector 952.

Therefore, as shown in step 4 shown in FIG. 9F, the row of input activations is shifted down one row. Therefore, in sequence 958, at step 4 a copy instruction is issued to again copy 128 pixels from the SMEM 955-956, but this time starting at pixel 9 (instead of pixel 0 as in step 1) in order to load a new row (from area 956) at the end. Then an MMA is performed. Steps 5-6 are similar to steps 2-3. At step 7, in a manner similar to step 4, an entire 128 pixels are loaded from SMEM to the local memory buffer (e.g., local memory buffer 530), but now starting at pixel 18 so that the additional second row can be loaded to the end of the activations 952. The disable mask (bitmask 964) is adjusted at respective steps for MMA operations so that the datapath can mask out the dot products of the masked elements.

The above mode is referred to as the PQ mode.

Another mode is the NPQ mode (also referred to as “NPQ-linear” mode). NPQ mode may be used when multiple images are used to build the vector of activations. The NPQ mode can be used instead of NQ mode if the image batch size is too small to provide enough pixels for the 128-long activation vector. In this approach the activation vector is constructed from multiple rows of the activation image(s). The rows from the starting image are consumed first. If the vector construction is not completed, then rows from the next image are used. The process continues until enough pixels are found.

FIG. 9I illustrates GMEM data layout of the activation image tensor 970, the corresponding SMEM data layout 975-976, and the data transfer instruction 974 between these two memories for the example 3×3 filter. Multiple instructions are needed to transfer the data. A GMEM to SMEM copy instruction (e.g., UTMALDG.IM2COL instruction) loads the initial activation vector 972 to SMEM areas 975-976. The activation vector 972 includes an extra two rows for the image halo along image top/bottom edges. FIG. 9J illustrates convolution MMA execution instructions sequence 978 and data layouts in the local memory buffer 981 as arranged for input to respective datapath lanes 980. It also includes a write mask (e.g., TCMMA instruction Write Mask) 982.

The convolution operation is similar to the PQ mode, and the instruction sequence 978 is identical to the instruction sequence 958 utilized in the PQ mode. What is different is the use of the write mask 984.

A comparison of the write mask 964 in the PQ mode and the write mask 984 in the NPQ mode, shows that mask 984 has in some instances a sequence of continuous pixel positions being write-disabled. This is in contrast to the dispersed single pixels that were write-disabled in the mask 964 of the PQ mode.

For example, in the write mask specified for the MMA operation in Step 1, the element sequence 114-122 are write disabled. This is because the data loaded from SMEM includes row 7 of the of image n, but that is not to be considered for the dot product calculation in Step 1 (see FIG. 9F Step 1, the row immediately below the lower edge of activation vector 948).

Then when an updated set of 128 pixels are copied from SMEM to the local memory buffer (e.g., local memory buffer 530) in Step 4, due to the location of the activation vector (see FIG. 9F Step 4) there are no rows to be write-disabled. Therefore, the write mask in Step 4 does not have a continuous series of pixels write-disabled.

Again when another updated set of 128 pixels are copied from SMEM to the local memory buffer (e.g., local memory buffer 530) in Step 7, now due to the position of the activation vector 948 (see FIG. 9F Step 7, the row that is two rows above the top edge of the activation vector 948 is to be write-disabled), a row of pixels is to be disabled and thus the continuous sequence is disabled in the write mask 982 in Step 7 of the sequence of instructions 978.

The NPQ mode is less efficient in terms of memory reuse. For the 3×3 filter the data from GMEM and SMEM are reused 9 times; however, the local memory buffer (e.g., local memory buffer 530) data are reused only 3 times. Three UTCCP.128dp256b instructions are needed to load the activation vector from SMEM to the local memory buffer (e.g., local memory buffer 530). In addition, the TCCP.1dp instruction is used for the small updates of the halo pixels.

The PQ-tiled mode is used for the images with non-constant halo pixels. This is typical behavior when the convolution filter is required to stay within the image boundaries. In this case the write mask cannot be used to define the halo pixels. The convolution MMA processing is organized in fixed size tiles, like 16×8, 8×16, etc. along PQ dimensions, which explains the naming. The fixed sized tile may cause tile quantization. To minimize performance impact optimal tile size must be selected.

FIG. 9K illustrates GMEM tensor arrangement 984, SMEM data layout 986-988, and the data transfer instructions 985 between these two memories for a 3×3 filter and a 16×8 tile size. Multiple instructions are needed to transfer the data. The first UTMALDG.TILED instruction loads the initial activation vector, that is represented by the 16 column×8 row rectangle that is aligned with the top left corner of arrangement 984. It also includes two extra rows for the tile bottom edge halo (e.g., the last two rows in the illustrated arrangement 984). The 16×8 rectangle corresponds to the selected tile. FIG. 9L illustrates convolution MMA execution instructions sequence 989 and data layout 992 in the local memory buffer (e.g., local memory buffer 530) as it is provided for the respective datapath lanes 990. Multiple UTCCP.1dp instructions are used for the tile right edge halo elements updates after the shift operation.

In the instruction sequence 989, in Step 1, the 128-pixel input activation vector, the tile, is read from the SMEM to the local memory buffer (e.g., local memory buffer 530) using a SMEM to the local memory buffer (e.g., local memory buffer 530) load instruction (“UTCCP.128dp[0-127]”). Then an MMA operation is executed.

In Step 2, a shift instruction is issued. The shift moves the tile horizontally. The horizontal shift results in the elements of the first column inside the 16×8 rectangle at its left edge are no longer considered due to the shift, and new elements are required to be copied to the last column within the 16×8 rectangle. This is achieved by a series of 8 single element copy instructions that copy pixels from the SMEM area 987 to the input activation vector layout 992 in the local memory buffer (e.g., local memory buffer 530). In essence, when viewed in the GMEM layout 984, the pixels that are immediately outside the right edge of the 16×8 tile are copied to the activation vector layout 992 in the local memory buffer (e.g., local memory buffer 530) as respective pixel positions that correspond to the pixels of the last column of the 16×8 tile as viewed in the GMEM layout 984. Specifically, 8 separate instructions to copy a single pixel each are issued to copy pixels 160-167 from SMEM area 987 to the pixel positions 15, 31, 47, . . . , 127.

In Step 3, another horizontal shift is performed in effect moving the 16×8 tile to be aligned with the right edge of the input activation matrix as shown in FIG. 9F, and for reasons similar to that in Step 2, copies pixels 170-177 from SMEM area 988 to the pixel positions 15, 31, 47, . . . , 127.

In Step 4, the activation vector moves down a row. This means that the top row of the initial activation vector as seen in FIG. 9F is no longer in consideration, but the row that was immediately outside the bottom edge of the initial activation vector is included in the new initial activation vector. Thus, the new 128-pixel input activation vector, the tile, is read from the SMEM to the local memory buffer (e.g., local memory buffer 530) using a SMEM to the local memory buffer (e.g., local memory buffer 530) load instruction (“UTCCP.128dp[16-143]”) to copy 128 pixels starting at pixel 16. Similar to Steps 2-3, in each of Steps 5-6, a horizontal shift is followed by operations to copy pixels to the last column of the activation vector from SMEM areas 987 and 988.

In Step 7, similar to Step 4, the activation vector is moved down another row. In effect, this means that the bottom edge of the 16×8 tile is aligned with the bottom edge of the activation vector. Thus, the new 128-pixel input activation vector, the tile, is read from the SMEM to the local memory buffer (e.g., local memory buffer 530) using a SMEM to the local memory buffer (e.g., local memory buffer 530) load instruction (“UTCCP.128dp[32-159]”) to copy 128 pixels starting at pixel 32. Similar to Steps 2-3, in each of Steps 8-9, a horizontal shift is followed by operations to copy pixels to the last column of the activation vector from SMEM areas 987 and 988. At this point, the 16×8 tile is aligned with the bottom and right edges of the activation vector.

The PQ-tiled mode is less efficient in terms of memory reuse. For the 3×3 filter the data from GMEM and SMEM are reused 9 times; however, the the local memory buffer (e.g., local memory buffer 530) data are reused 3 times only. Three UTCCP.128dp instructions are needed to load the activation vector from SMEM to the local memory buffer (e.g., local memory buffer 530). In addition, the TCCP.1dp instructions are used to update the tile right edge halo pixels.

### Example GPU Architecture

An example illustrative architecture in which the efficient MMA disclosed in this application is incorporated will now be described. The following information is set forth for illustrative purposes and should not be construed as limiting in any manner. Any of the following features may be optionally incorporated with or without the exclusion of other features described.

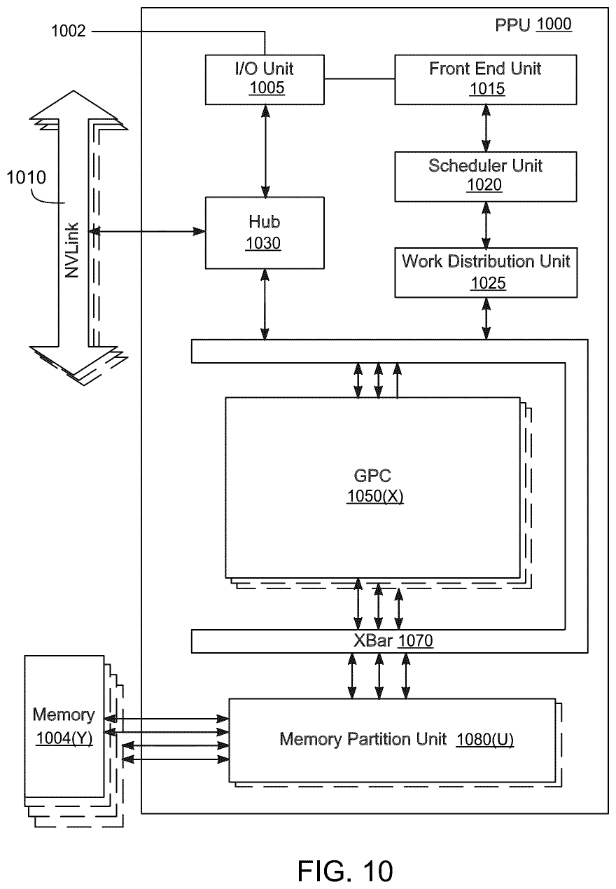

FIG. 10 illustrates a parallel processing unit (PPU) 1000, in accordance with an embodiment. In an embodiment, the PPU 1000 is a multi-threaded processor that is implemented on one or more integrated circuit devices. The PPU 1000 is a latency hiding architecture designed to process many threads in parallel. A thread (e.g., a thread of execution) is an instantiation of a set of instructions configured to be executed by the PPU 1000. In an embodiment, the PPU 1000 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 1000 may be utilized for performing general-purpose computations. In some other embodiments, PPU 100 configured to implement large neural networks in deep learning applications or other high performance computing applications.

One or more PPUs 1000 may be configured to accelerate thousands of High Performance Computing (HPC), data center, and machine learning applications. The PPU 1000 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

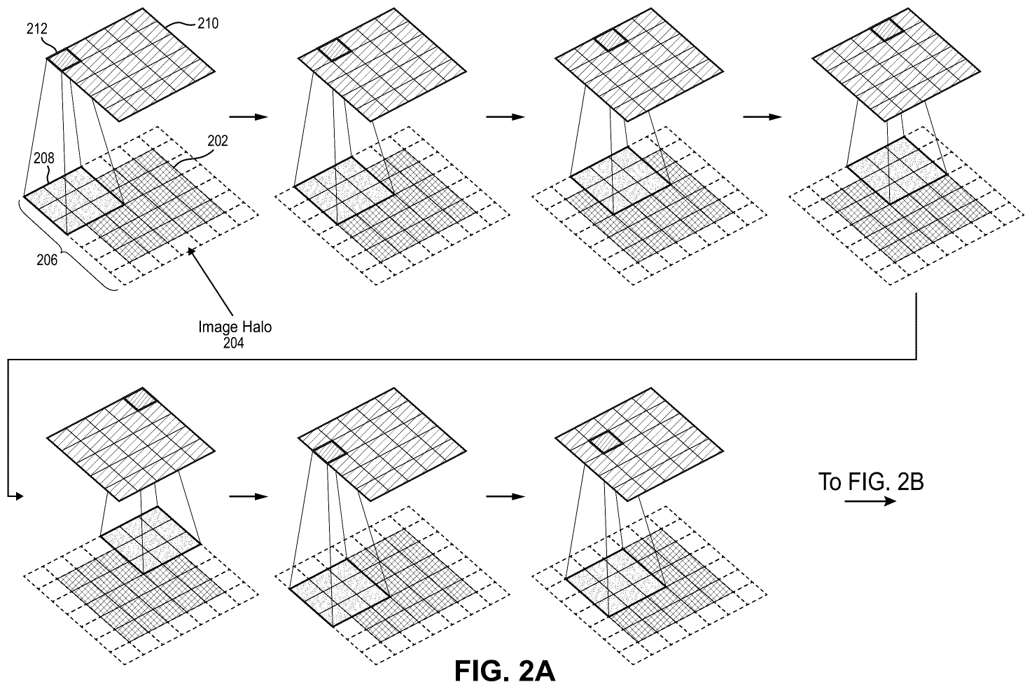

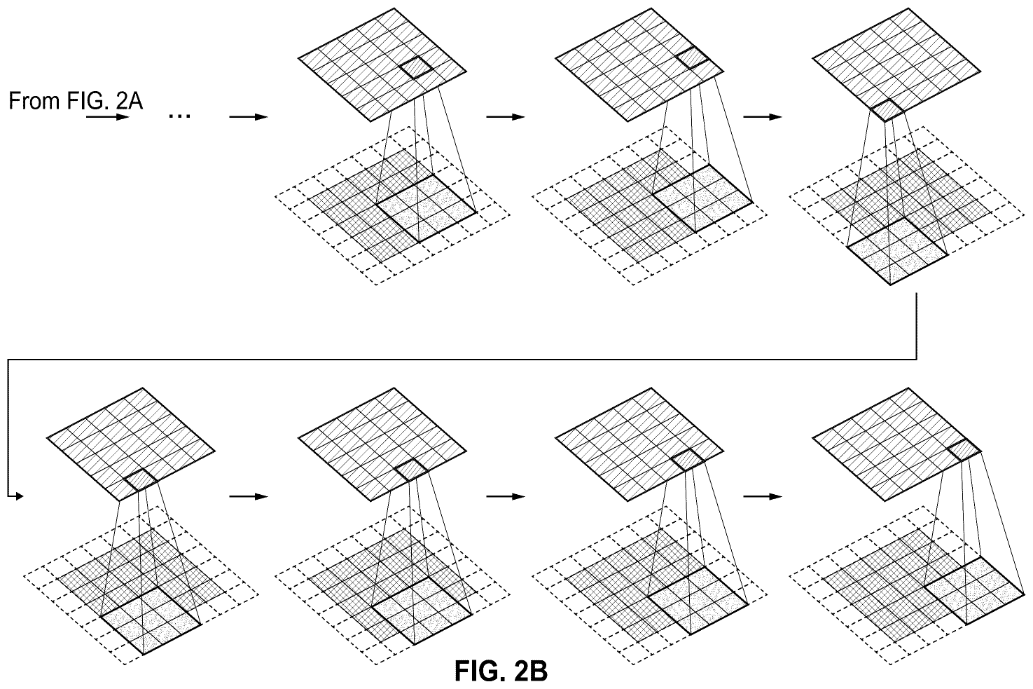

As shown in FIG. 10, the PPU 1000 includes an Input/Output (I/O) unit 1005, a front end unit 1015, a scheduler unit 1020, a work distribution unit 1025, a hub 1030, a crossbar (Xbar) 1070, one or more general processing clusters (GPCs) 1050, and one or more partition units 1080. An LRC 1080, such as, for example, described above in relation to FIGS. 2 and 2A, may be located between crossbar 1070 and the MPU 1080, and may be configured to support the multicast described above. The PPU 1000 may be connected to a host processor or other PPUs 1000 via one or more high-speed NVLink 1010 interconnect. The PPU 1000 may be connected to a host processor or other peripheral devices via an interconnect 1002. The PPU 1000 may also be connected to a memory comprising a number of memory devices 1004. In an embodiment, the memory 1004 may comprise a number of dynamic random access memory (DRAM) devices. The DRAM devices may be configured as a high-bandwidth memory (HBM) subsystem, with multiple DRAM dies stacked within each device.

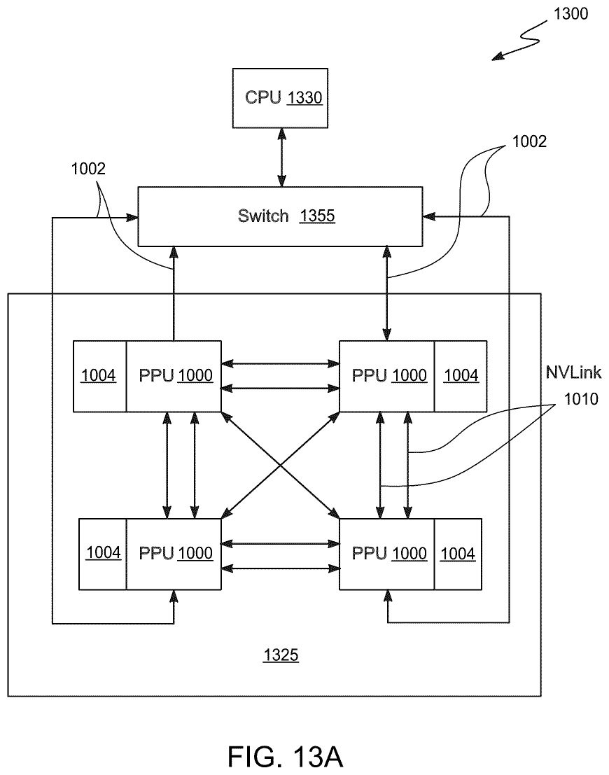

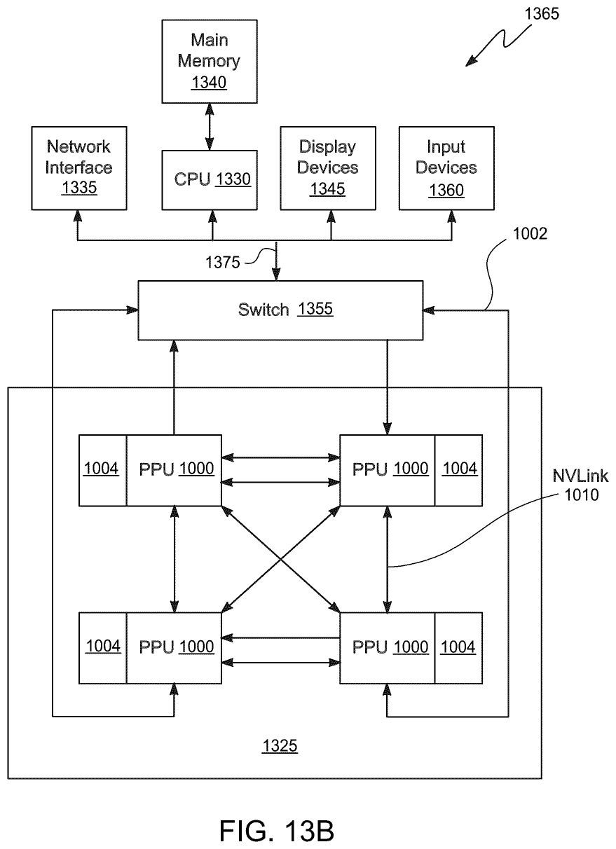

The NVLink 1010 interconnect enables systems to scale and include one or more PPUs 1000 combined with one or more CPUs, supports cache coherence between the PPUs 1000 and CPUs, and CPU mastering. Data and/or commands may be transmitted by the NVLink 1010 through the hub 1030 to/from other units of the PPU 1000 such as one or more copy engines, a video encoder, a video decoder, a power management unit, etc. (not explicitly shown). The NVLink 1010 is described in more detail in conjunction with FIG. 13A and FIG. 13B.

The I/O unit 1005 is configured to transmit and receive communications (e.g., commands, data, etc.) from a host processor (not shown) over the interconnect 1002. The I/O unit 1005 may communicate with the host processor directly via the interconnect 1002 or through one or more intermediate devices such as a memory bridge. In an embodiment, the I/O unit 1005 may communicate with one or more other processors, such as one or more of the PPUs 1000 via the interconnect 1002. In an embodiment, the I/O unit 1005 implements a Peripheral Component Interconnect Express (PCIe) interface for communications over a PCIe bus and the interconnect 1002 is a PCIe bus. In alternative embodiments, the I/O unit 1005 may implement other types of well-known interfaces for communicating with external devices.

The I/O unit 1005 decodes packets received via the interconnect 1002. In an embodiment, the packets represent commands configured to cause the PPU 1000 to perform various operations. The I/O unit 1005 transmits the decoded commands to various other units of the PPU 1000 as the commands may specify. For example, some commands may be transmitted to the front end unit 1015. Other commands may be transmitted to the hub 1030 or other units of the PPU 1000 such as one or more copy engines, a video encoder, a video decoder, a power management unit, etc. (not explicitly shown). In other words, the I/O unit 1005 is configured to route communications between and among the various logical units of the PPU 1000.

In an embodiment, a program executed by the host processor encodes a command stream in a buffer that provides workloads to the PPU 1000 for processing. A workload may comprise several instructions and data to be processed by those instructions. The buffer is a region in a memory that is accessible (e.g., read/write) by both the host processor and the PPU 1000. For example, the I/O unit 1005 may be configured to access the buffer in a system memory connected to the interconnect 1002 via memory requests transmitted over the interconnect 1002. In an embodiment, the host processor writes the command stream to the buffer and then transmits a pointer to the start of the command stream to the PPU 1000. The front end unit 1015 receives pointers to one or more command streams. The front end unit 1015 manages the one or more streams, reading commands from the streams and forwarding commands to the various units of the PPU 1000.

The front end unit 1015 is coupled to a scheduler unit 1020 that configures the various GPCs 1050 to process tasks defined by the one or more streams. The scheduler unit 1020 is configured to track state information related to the various tasks managed by the scheduler unit 1020. The state may indicate which GPC 1050 a task is assigned to, whether the task is active or inactive, a priority level associated with the task, and so forth. The scheduler unit 1020 manages the execution of a plurality of tasks on the one or more GPCs 1050.

The scheduler unit 1020 is coupled to a work distribution unit 1025 that is configured to dispatch tasks for execution on the GPCs 1050. The work distribution unit 1025 may track a number of scheduled tasks received from the scheduler unit 1020. In an embodiment, the work distribution unit 1025 manages a pending task pool and an active task pool for each of the GPCs 1050. The pending task pool may comprise a number of slots (e.g., 32 slots) that contain tasks assigned to be processed by a particular GPC 1050. The active task pool may comprise a number of slots (e.g., 4 slots) for tasks that are actively being processed by the GPCs 1050. As a GPC 1050 finishes the execution of a task, that task is evicted from the active task pool for the GPC 1050 and one of the other tasks from the pending task pool is selected and scheduled for execution on the GPC 1050. If an active task has been idle on the GPC 1050, such as while waiting for a data dependency to be resolved, then the active task may be evicted from the GPC 1050 and returned to the pending task pool while another task in the pending task pool is selected and scheduled for execution on the GPC 1050.

The work distribution unit 1025 communicates with the one or more GPCs 1050 via XBar 370. The XBar 1070 is an interconnect network that couples many of the units of the PPU 1000 to other units of the PPU 1000. For example, the XBar 1070 may be configured to couple the work distribution unit 1025 to a particular GPC 1050. Although not shown explicitly, one or more other units of the PPU 1000 may also be connected to the XBar 1070 via the hub 1030.

The tasks are managed by the scheduler unit 1020 and dispatched to a GPC 1050 by the work distribution unit 1025. The GPC 1050 is configured to process the task and generate results. The results may be consumed by other tasks within the GPC 1050, routed to a different GPC 1050 via the XBar 1070, or stored in the memory 1004. The results can be written to the memory 1004 via the partition units 1080, which implement a memory interface for reading and writing data to/from the memory 1004. The results can be transmitted to another PPU 1004 or CPU via the NVLink 1010. In an embodiment, the PPU 1000 includes a number U of partition units 1080 that is equal to the number of separate and distinct memory devices 1004 coupled to the PPU 1000. A partition unit 1080 will be described in more detail below in conjunction with FIG. 11B.

In an embodiment, a host processor executes a driver kernel that implements an application programming interface (API) that enables one or more applications executing on the host processor to schedule operations for execution on the PPU 1000. In an embodiment, multiple compute applications are simultaneously executed by the PPU 1000 and the PPU 1000 provides isolation, quality of service (QOS), and independent address spaces for the multiple compute applications. An application may generate instructions (e.g., API calls) that cause the driver kernel to generate one or more tasks for execution by the PPU 1000. The driver kernel outputs tasks to one or more streams being processed by the PPU 1000. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory (SMEM). Threads, cooperating threads and a hierarchical grouping of threads such as cooperating thread arrays (CTA) and cooperating group arrays (CGA) according to some embodiments are described in more detail in U.S. application Ser. No. 17/691,621, the entire content of which is hereby incorporated by reference in its entirety. The SMEM, according to some embodiments, is described in U.S. application Ser. No. 17/691,690, which is hereby incorporated in reference in its entirety.

FIG. 11A illustrates a GPC 1050 of the PPU 1000 of FIG. 10, in accordance with an embodiment. As shown in FIG. 11A, each GPC 1050 includes a number of hardware units for processing tasks. In an embodiment, each GPC 1050 includes a pipeline manager 1110, a pre-raster operations unit (PROP) 1115, a raster engine 1125, a work distribution crossbar (WDX) 1180, a memory management unit (MMU) 1190, and one or more Data Processing Clusters (DPCs) 1120. It will be appreciated that the GPC 1050 of FIG. 11A may include other hardware units in lieu of or in addition to the units shown in FIG. 11A.

In an embodiment, the operation of the GPC 1050 is controlled by the pipeline manager 1110. The pipeline manager 1110 manages the configuration of the one or more DPCs 1120 for processing tasks allocated to the GPC 1050. In an embodiment, the pipeline manager 1110 may configure at least one of the one or more DPCs 1120 to implement at least a portion of a graphics rendering pipeline, a neural network, and/or a compute pipeline. For example, with respect to a graphics rendering pipeline, a DPC 1120 may be configured to execute a vertex shader program on the programmable streaming multiprocessor (SM) 1140. The pipeline manager 1110 may also be configured to route packets received from the work distribution unit 1025 to the appropriate logical units within the GPC 1050. For example, some packets may be routed to fixed function hardware units in the PROP 1115 and/or raster engine 1125 while other packets may be routed to the DPCs 1120 for processing by the primitive engine 1135 or the SM 1140.

The PROP unit 1115 is configured to route data generated by the raster engine 1125 and the DPCs 1120 to a Raster Operations (ROP) unit, described in more detail in conjunction with FIG. 11B. The PROP unit 1115 may also be configured to perform optimizations for color blending, organize pixel data, perform address translations, and the like.

Each DPC 1120 included in the GPC 1050 includes an M-Pipe Controller (MPC) 1130, a primitive engine 1135, and one or more SMs 1140. The MPC 1130 controls the operation of the DPC 1120, routing packets received from the pipeline manager 1110 to the appropriate units in the DPC 1120. For example, packets associated with a vertex may be routed to the primitive engine 1135, which is configured to fetch vertex attributes associated with the vertex from the memory 1004. In contrast, packets associated with a shader program may be transmitted to the SM 1140.

The SM 1140 comprises a programmable streaming processor that is configured to process tasks represented by a number of threads. Each SM 1140 is multi-threaded and configured to execute a plurality of threads (e.g., 32 threads) from a particular group of threads concurrently. In an embodiment, the SM 1140 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 1140 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 1140 is described in more detail below in conjunction with FIG. 12A.

The MMU 1190 provides an interface between the GPC 1050 and the partition unit 1080. The MMU 1190 may provide translation of virtual addresses into physical addresses, memory protection, and arbitration of memory requests. In an embodiment, the MMU 1190 provides one or more translation lookaside buffers (TLBs) for performing translation of virtual addresses into physical addresses in the memory 1004.

FIG. 11B illustrates a memory partition unit 1080 of the PPU 1000 of FIG. 10 in accordance with an embodiment. As shown in FIG. 11B, the memory partition unit 1080 includes a Raster Operations (ROP) unit 1150, a level two (L2) cache 1160, and a memory interface 1170. The memory interface 1170 is coupled to the memory 1004. Memory interface 1170 may implement 32, 64, 128, 1024-bit data buses, or the like, for high-speed data transfer. In an embodiment, the PPU 1000 incorporates U memory interfaces 1170, one memory interface 1170 per pair of partition units 1080, where each pair of partition units 1080 is connected to a corresponding memory device 1004. For example, PPU 1000 may be connected to up to Y memory devices 1004, such as high bandwidth memory stacks or graphics double-data-rate, version 5, synchronous dynamic random access memory, or other types of persistent storage.

In an embodiment, the memory interface 1170 implements an HBM2 memory interface and Y equals half U. In an embodiment, the HBM2 memory stacks are located on the same physical package as the PPU 1000, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 1004 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 1000 process very large datasets and/or run applications for extended periods.

In an embodiment, the PPU 1000 implements a multi-level memory hierarchy. In an embodiment, the memory partition unit 1080 supports a unified memory to provide a single unified virtual address space for CPU and PPU 300 memory, enabling data sharing between virtual memory systems. In an embodiment the frequency of accesses by a PPU 1000 to memory located on other processors is traced to ensure that memory pages are moved to the physical memory of the PPU 1000 that is accessing the pages more frequently. In an embodiment, the NVLink 1010 supports address translation services allowing the PPU 1000 to directly access a CPU's page tables and providing full access to CPU memory by the PPU 1000.

In an embodiment, copy engines transfer data between multiple PPUs 1000 or between PPUs 1000 and CPUs. The copy engines can generate page faults for addresses that are not mapped into the page tables. The memory partition unit 1080 can then service the page faults, mapping the addresses into the page table, after which the copy engine can perform the transfer. In a conventional system, memory is pinned (e.g., non-pageable) for multiple copy engine operations between multiple processors, substantially reducing the available memory. With hardware page faulting, addresses can be passed to the copy engines without worrying if the memory pages are resident, and the copy process is transparent.

Data from the memory 1004 or other system memory may be fetched by the memory partition unit 1080 and stored in the L2 cache 1160, which is located on-chip and is shared between the various GPCs 1050. As shown, each memory partition unit 1080 includes a portion of the L2 cache 1160 associated with a corresponding memory device 1004. Lower level caches may then be implemented in various units within the GPCs 1050. For example, each of the SMs 1140 may implement a level one (L1) cache. The L1 cache is private memory that is dedicated to a particular SM 1140. Data from the L2 cache 1160 may be fetched and stored in each of the L1 caches for processing in the functional units of the SMs 1140. The L2 cache 1160 is coupled to the memory interface 1170 and the XBar 1070.

The ROP unit 1150 performs graphics raster operations related to pixel color, such as color compression, pixel blending, and the like. The ROP unit 450 also implements depth testing in conjunction with the raster engine 1125, receiving a depth for a sample location associated with a pixel fragment from the culling engine of the raster engine 1125. The depth is tested against a corresponding depth in a depth buffer for a sample location associated with the fragment. If the fragment passes the depth test for the sample location, then the ROP unit 1150 updates the depth buffer and transmits a result of the depth test to the raster engine 1125. It will be appreciated that the number of partition units 1080 may be different than the number of GPCs 1050 and, therefore, each ROP unit 1150 may be coupled to each of the GPCs 1050. The ROP unit 1150 tracks packets received from the different GPCs 1050 and determines which GPC 1050 that a result generated by the ROP unit 1150 is routed to through the Xbar 1070. Although the ROP unit 1150 is included within the memory partition unit 1080 in FIG. 11B, in other embodiment, the ROP unit 1150 may be outside of the memory partition unit 1080. For example, the ROP unit 1150 may reside in the GPC 1050 or another unit.

FIG. 12A illustrates the streaming multiprocessor 1140 of FIG. 11A, in accordance with an embodiment. As shown in FIG. 12A, the SM 1140 includes an instruction cache 1205, one or more scheduler units 1210, a register file 1220, one or more processing cores 1250, one or more special function units (SFUs) 1252, one or more load/store units (LSUs) 1254, an interconnect network 1280, a SMEM/L1 cache 1270.

As described above, the work distribution unit 1025 dispatches tasks for execution on the GPCs 1050 of the PPU 1000. The tasks are allocated to a particular DPC 1120 within a GPC 1050 and, if the task is associated with a shader program, the task may be allocated to an SM 1140. The scheduler unit 1210 receives the tasks from the work distribution unit 1025 and manages instruction scheduling for one or more thread blocks assigned to the SM 1140. The scheduler unit 1210 schedules thread blocks for execution as warps of parallel threads, where each thread block consists of at least one warp. In an embodiment, each warp comprises 32 threads. The scheduler unit 1210 may manage a plurality of different thread blocks, allocating the different thread blocks to different warps and then dispatching instructions from the plurality of different cooperative groups to the various functional units (e.g., cores 1250, SFUs 1252, and LSUs 1254) during each clock cycle.

Cooperative Group Arrays (CGAs) provide a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Group Arrays enable programmers to define groups of threads explicitly at sub-block (e.g., as small as a single thread) and multi-block granularities, and to perform collective operations on the threads such as synchronization in a cooperative group. The programming model supports clean composition across software boundaries, so that libraries and utility functions can synchronize safely within their local context without having to make assumptions about convergence. Cooperative Group Array primitives enable new patterns of cooperative parallelism, including producer-consumer parallelism, opportunistic parallelism, and global synchronization across an entire grid of thread blocks. Hierarchical grouping of threads such as cooperating thread arrays (CTA) and cooperating group arrays (CGA) according to some embodiments are described in more detail in U.S. application Ser. No. 17/691,621, the entire content of which is hereby incorporated by reference in its entirety.

A dispatch unit 1215 is configured to transmit instructions to one or more of the functional units. In the embodiment, the scheduler unit 1210 includes two dispatch units 1215 that enable two different instructions from the same warp to be dispatched during each clock cycle. In alternative embodiments, each scheduler unit 1210 may include a single dispatch unit 1215 or additional dispatch units 1215.

Each SM 1140 includes a register file 1220 that provides a set of registers for the functional units of the SM 1140. In an embodiment, the register file 1220 is divided between each of the functional units such that each functional unit is allocated a dedicated portion of the register file 1220. In another embodiment, the register file 1220 is divided between the different warps being executed by the SM 1140. The register file 1220 provides temporary storage for operands connected to the data paths of the functional units.

Each SM 1140 comprises multiple processing cores 1250. In an embodiment, the SM 1140 includes a large number (e.g., 128, etc.) of distinct processing cores 1250. Each core 1250 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic.

Tensor cores are configured to perform matrix operations, and, in an embodiment, one or more tensor cores are included in the cores 1250. In particular, the tensor cores are configured to perform deep learning matrix arithmetic, such as convolution operations for neural network training and inferencing.

In some embodiments, transposition hardware is included in the processing cores 1250 or another functional unit (e.g., SFUs 1252 or LSUs 1254) and is configured to generate matrix data stored by diagonals and/or generate the original matrix and/or transposed matrix from the matrix data stored by diagonals. The transposition hardware may be provided inside of the SMEM 1270 to register file 1220 load path of the SM 1140.

Each SM 1140 also comprises multiple SFUs 1252 that perform special functions (e.g., attribute evaluation, reciprocal square root, and the like). In an embodiment, the SFUs 1252 may include a tree traversal unit (e.g., TTU 1143) configured to traverse a hierarchical tree data structure. In an embodiment, the SFUs 1252 may include texture unit (e.g., Texture Unit 1142) configured to perform texture map filtering operations. In an embodiment, the texture units are configured to load texture maps (e.g., a 2D array of texels) from the memory 1004 and sample the texture maps to produce sampled texture values for use in shader programs executed by the SM 1140. In an embodiment, the texture maps are stored in the SMEM/L1 cache 1170. The texture units implement texture operations such as filtering operations using mip-maps (e.g., texture maps of varying levels of detail). In an embodiment, each SM 1140 includes two texture units.

Each SM 1140 also comprises multiple LSUs 1254 that implement load and store operations between the SMEM/L1 cache 1270 and the register file 1220. Each SM 1140 includes an interconnect network 1280 that connects each of the functional units to the register file 1220 and the LSU 1254 to the register file 1220, SMEM/L1 cache 1270. In an embodiment, the interconnect network 1280 is a crossbar that can be configured to connect any of the functional units to any of the registers in the register file 1220 and connect the LSUs 1254 to the register file 1220 and memory locations in SMEM/L1 cache 1270.

The SMEM/L1 cache 1270 is an array of on-chip memory that allows for data storage and communication between the SM 1140 and the primitive engine 1135 and between threads in the SM 1140. In an embodiment, the SMEM/L1 cache 1270 comprises 128 KB of storage capacity and is in the path from the SM 1140 to the partition unit 1080. The SMEM/L1 cache 1270 can be used to cache reads and writes. One or more of the SMEM/L1 cache 1270, L2 cache 1160, and memory 1004 are backing stores.

Combining data cache and SMEM functionality into a single memory block provides the best overall performance for both types of memory accesses. The capacity is usable as a cache by programs that do not use SMEM. For example, if SMEM is configured to use half of the capacity, texture and load/store operations can use the remaining capacity. Integration within the SMEM/L1 cache 1270 enables the SMEM/L1 cache 1270 to function as a high-throughput conduit for streaming data while simultaneously providing high-bandwidth and low-latency access to frequently reused data.

In the context of this disclosure, an SM or “streaming multiprocessor” means a processor architected as described in U.S. Pat. No. 7,447,873 to Nordquist including improvements thereto and advancements thereof, and as implemented for example in many generations of NVIDIA GPUs. For example, an SM may comprise a plurality of processing engines or cores configured to concurrently execute a plurality of threads arranged in a plurality of single-instruction, multiple-data (SIMD) groups (e.g., warps), wherein each of the threads in a same one of the SIMD groups executes a same data processing program comprising a sequence of instructions on a different input object, and different threads in the same one of the SIMD group are executed using different ones of the processing engines or cores. An SM may typically also provide (a) a local register file having plural lanes, wherein each processing engine or core is configured to access a different subset of the lanes; and instruction issue logic configured to select one of the SIMD groups and to issue one of the instructions of the same data processing program to each of the plurality of processing engines in parallel, wherein each processing engine executes the same instruction in parallel with each other processing engine using the subset of the local register file lanes accessible thereto. An SM typically further includes core interface logic configured to initiate execution of one or more SIMD groups. As shown in the figures, such SMs have been constructed to provide fast local SMEM enabling data sharing/reuse and synchronization between all threads of a CTA executing on the SM.

When configured for general purpose parallel computation, a simpler configuration can be used compared with graphics processing. Specifically, the fixed function graphics processing units shown in FIG. 11A, are bypassed, creating a much simpler programming model. In the general purpose parallel computation configuration, the work distribution unit 1025 assigns and distributes blocks of threads directly to the DPCs 1120. The threads in a block execute the same program, using a unique thread ID in the calculation to ensure each thread generates unique results, using the SM 1140 to execute the program and perform calculations, SMEM/L1 cache 1270 to communicate between threads, and the LSU 1254 to read and write global memory through the SMEM/L1 cache 1270 and the memory partition unit 1080. When configured for general purpose parallel computation, the SM 1140 can also write commands that the scheduler unit 1020 can use to launch new work on the DPCs 1120.

The PPU 1000 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 1000 is embodied on a single semiconductor substrate. In another embodiment, the PPU 1000 is included in a system-on-a-chip (SoC) along with one or more other devices such as additional PPUs 1000, the memory 1004, a reduced instruction set computer (RISC) CPU, a memory management unit (MMU), a digital-to-analog converter (DAC), and the like.

In an embodiment, the PPU 1000 may be included on a graphics card that includes one or more memory devices 1004. The graphics card may be configured to interface with a PCIe slot on a motherboard of a desktop computer. In yet another embodiment, the PPU 1000 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 13A is a conceptual diagram of a processing system 1300 implemented using the PPU 1000 of FIG. 10, in accordance with an embodiment. The exemplary system 1300 may be configured to implement the methods disclosed in this application (e.g., the TMAU in FIG. 1, 2, 6 or 11A). The processing system 1300 includes a CPU 1330, switch 1355, and multiple PPUs 1000 each and respective memories 1004. The NVLink 1010 provides high-speed communication links between each of the PPUs 1000. Although a particular number of NVLink 1010 and interconnect 1002 connections are illustrated in FIG. 13A, the number of connections to each PPU 1000 and the CPU 1330 may vary. The switch 1355 interfaces between the interconnect 1002 and the CPU 1330. The PPUs 1000, memories 1004, and NVLinks 1010 may be situated on a single semiconductor platform to form a parallel processing module 1325. In an embodiment, the switch 1355 supports two or more protocols to interface between various different connections and/or links.

In another embodiment (not shown), the NVLink 1010 provides one or more high-speed communication links between each of the PPUs 1000 and the CPU 1330 and the switch 1355 interfaces between the interconnect 1002 and each of the PPUs 1000. The PPUs 1000, memories 1004, and interconnect 1002 may be situated on a single semiconductor platform to form a parallel processing module 1325. In yet another embodiment (not shown), the interconnect 1002 provides one or more communication links between each of the PPUs 1000 and the CPU 1330 and the switch 1355 interfaces between each of the PPUs 1000 using the NVLink 1010 to provide one or more high-speed communication links between the PPUs 1000. In another embodiment (not shown), the NVLink 1010 provides one or more high-speed communication links between the PPUs 1000 and the CPU 1330 through the switch 1355. In yet another embodiment (not shown), the interconnect 1002 provides one or more communication links between each of the PPUs 1000 directly. One or more of the NVLink 1010 high-speed communication links may be implemented as a physical NVLink interconnect or either an on-chip or on-die interconnect using the same protocol as the NVLink 1010.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 1325 may be implemented as a circuit board substrate and each of the PPUs 1000 and/or memories 1004 may be packaged devices. In an embodiment, the CPU 1330, switch 1355, and the parallel processing module 1325 are situated on a single semiconductor platform.

In an embodiment, the signaling rate of each NVLink 1010 is 20 to 25 Gigabits/second and each PPU 1000 includes six NVLink 1010 interfaces (as shown in FIG. 13A, five NVLink 1010 interfaces are included for each PPU 1000). Each NVLink 1010 provides a data transfer rate of 25 Gigabytes/second in each direction, with six links providing 1000 Gigabytes/second. The NVLinks 1010 can be used exclusively for PPU-to-PPU communication as shown in FIG. 13A, or some combination of PPU-to-PPU and PPU-to-CPU, when the CPU 1330 also includes one or more NVLink 1010 interfaces.

In an embodiment, the NVLink 1010 allows direct load/store/atomic access from the CPU 1330 to each PPU's 1000 memory 1004. In an embodiment, the NVLink 1010 supports coherency operations, allowing data read from the memories 1004 to be stored in the cache hierarchy of the CPU 1330, reducing cache access latency for the CPU 1330. In an embodiment, the NVLink 1010 includes support for Address Translation Services (ATS), allowing the PPU 1000 to directly access page tables within the CPU 1330. One or more of the NVLinks 1010 may also be configured to operate in a low-power mode.

FIG. 13B illustrates an exemplary system 1365 in which the various architecture and/or functionality of the various previous embodiments may be implemented. The exemplary system 1365 may be configured to implement the methods disclosed in this application.

As shown, a system 1365 is provided including at least one central processing unit 1330 that is connected to a communication bus 1375. The communication bus 1375 may be implemented using any suitable protocol, such as PCI (Peripheral Component Interconnect), PCI-Express, AGP (Accelerated Graphics Port), HyperTransport, or any other bus or point-to-point communication protocol(s). The system 1365 also includes a main memory 1340. Control logic (software) and data are stored in the main memory 1340 which may take the form of random access memory (RAM).

The system 1365 also includes input devices 1360, the parallel processing system 1325, and display devices 1345, e.g. a conventional CRT (cathode ray tube), LCD (liquid crystal display), LED (light emitting diode), plasma display or the like. User input may be received from the input devices 1360, e.g., keyboard, mouse, touchpad, microphone, and the like. Each of the foregoing modules and/or devices may even be situated on a single semiconductor platform to form the system 1365. Alternately, the various modules may also be situated separately or in various combinations of semiconductor platforms per the desires of the user.

Further, the system 1365 may be coupled to a network (e.g., a telecommunications network, local area network (LAN), wireless network, wide area network (WAN) such as the Internet, peer-to-peer network, cable network, or the like) through a network interface 1335 for communication purposes.

The system 1365 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 1340 and/or the secondary storage. Such computer programs, when executed, enable the system 1365 to perform various functions. The memory 1340, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 1365 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

An application program may be implemented via an application executed by a host processor, such as a CPU. In an embodiment, a device driver may implement an application programming interface (API) that defines various functions that can be utilized by the application program in order to generate graphical data for display. The device driver is a software program that includes a plurality of instructions that control the operation of the PPU 1000. The API provides an abstraction for a programmer that lets a programmer utilize specialized graphics hardware, such as the PPU 1000, to generate the graphical data without requiring the programmer to utilize the specific instruction set for the PPU 1000. The application may include an API call that is routed to the device driver for the PPU 1000. The device driver interprets the API call and performs various operations to respond to the API call. In some instances, the device driver may perform operations by executing instructions on the CPU. In other instances, the device driver may perform operations, at least in part, by launching operations on the PPU 1000 utilizing an input/output interface between the CPU and the PPU 1000. In an embodiment, the device driver is configured to implement the graphics processing pipeline 1400 utilizing the hardware of the PPU 1000.

Various programs may be executed within the PPU 1000 in order to implement the various stages of the processing for the application program. For example, the device driver may launch a kernel on the PPU 1000 to perform one stage of processing on one SM 1140 (or multiple SMs 1140). The device driver (or the initial kernel executed by the PPU 1000) may also launch other kernels on the PPU 1000 to perform other stages of the processing. If the application program processing includes a graphics processing pipeline, then some of the stages of the graphics processing pipeline may be implemented on fixed unit hardware such as a rasterizer or a data assembler implemented within the PPU 1000. It will be appreciated that results from one kernel may be processed by one or more intervening fixed function hardware units before being processed by a subsequent kernel on an SM 1140.

The techniques disclosed herein may be incorporated in any processor that may be used for processing a neural network such as, for example, a central processing unit (CPU), a graphics processing unit (GPU), an intelligence processing unit (IPU), neural processing unit (NPU), tensor processing unit (TPU), neural network processor (NNP), a data processing unit (DPU), a vision processing unit (VPU), an application specific integrated circuit (ASIC), a field-programmable gate array (FPGA), and the like. Such a processor may be incorporated in a personal computer (e.g., a laptop), at a data center, in an Internet of Things (IoT) device, a handheld device (e.g., smartphone), a vehicle, a robot, or any other device that performs inference, training or any other processing of a neural network. Such a processor may be employed in a virtualized system such that an operating system executing in a virtual machine on the system can utilize the processor.

As an example, a processor incorporating the techniques disclosed herein can be employed to process one or more neural networks in a machine to identify, classify, manipulate, handle, operate, modify, or navigate around physical objects in the real world. For example, such a processor may be employed in an autonomous vehicle (e.g., an automobile, motorcycle, helicopter, drone, plane, boat, submarine, delivery robot, etc.) to move the vehicle through the real world. Additionally, such a processor may be employed in a robot at a factory to select components and assemble components into an assembly.

As an example, a processor incorporating the techniques disclosed herein can be employed to process one or more neural networks to identify one or more features in an image or to alter, generate, or compress an image. For example, such a processor may be employed to enhance an image that is rendered using raster, ray-tracing (e.g., using NVIDIA RTX), and/or other rendering techniques. In another example, such a processor may be employed to reduce the amount of image data that is transmitted over a network (e.g., the Internet, a mobile telecommunications network, a WIFI network, as well as any other wired or wireless networking system) from a rendering device to a display device. Such transmissions may be utilized to stream image data from a server or a data center in the cloud to a user device (e.g., a personal computer, video game console, smartphone, other mobile device, etc.) to enhance services that stream images such as NVIDIA Geforce Now (GFN), Google Stadia, and the like.

As an example, a processor incorporating the techniques disclosed herein can be employed to process one or more neural networks for any other types of applications that can take advantage of a neural network. For example, such applications may involve translating from one spoken language to another, identifying and negating sounds in audio, detecting anomalies or defects during production of goods and services, surveillance of living and/or non-living things, medical diagnosis, decision making, and the like.

As an example, a processor incorporating the techniques disclosed herein can be employed to implement neural networks such as large language models (LLMs) to generate content (e.g., images, video, text, essays, audio, and the like), respond to user queries, solve problems in mathematical and other domains, and the like.

All patents, patent applications and publications cited herein are incorporated by reference for all purposes as if expressly set forth.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A system comprising:
datapath processing circuitry comprising a first input interface, a second input interface, and a plurality of processing lanes;
an input memory connected to the second input interface; and
an output memory associated with the plurality of processing lanes,
wherein the datapath processing circuitry is configured to perform operations comprising:
loading a weights vector to the first input interface and an activations vector to the input memory connected to the second input interface, wherein the activations vector comprises a first plurality of activation elements from an activation input matrix and the weights vector comprises a first plurality of weight elements from a weights matrix; and
executing, by holding the weights vector constant, a first sequence of matrix multiply and add (MMA) operations using the activations vector and the weights vector as inputs and accumulating a result of the first sequence of MMA operations in the output memory.

2. The system according to claim 1, wherein the datapath processing circuitry is further configured to perform operations comprising:
forming, from the activations vector in the input memory, a shifted activations vector in the input memory, wherein the shifted activations vector comprises a second plurality of activations elements that includes a subset of the first plurality of activations elements from the input memory and at least one additional activations element loaded to the input memory from another memory; and
executing a second sequence of MMA operations using the shifted activations vector and a second weights vector as inputs and accumulating a result of the second sequence of MMA operations in the output memory, wherein the second weights vector comprises a second plurality of weight elements from the weights input matrix.

3. The system according to claim 2, wherein each MMA operation in the first sequence comprises multiplying the activations vector with a respective weight element from the weights vector, and each MMA operation in the second sequence comprises multiplying the second activations vector with a respective weight element from the shifted weights vector.

4. The system according to claim 2, wherein the forming, from the activations vector in the input memory, a shifted activations vector in the input memory, comprises:
in response to a first instruction, changing respective associations activation elements in the subset of activation elements to respective memory locations; and
in response to a second instruction, loading the at least one additional activation element from said input memory to one of the respective memory locations unoccupied by the subset after the changing.

5. The system according to claim 4, wherein the first instruction is a shift instruction causing the first plurality of first elements to be shifted by one activation element in a first direction of the activations vector, and the second instruction is a copy instruction causing the at least one additional activation element to be stored as a last element in the direction opposite to the first direction in the shifted activations vector.

6. The system according to claim 1, wherein the first plurality of weight elements and the second plurality of weight elements are respective rows or respective columns in the weight matrix, and the first plurality of activation elements and the second plurality of activation elements are from a same row or a same column in the activations input matrix, wherein the second plurality of activation elements is shifted in the same row or the same column in a direction in relation to the first plurality of activation elements.

7. The system according to claim 1, wherein the activations input matrix is from a tensor of input activations comprising a plurality of images, and the weights matrix is a tensor of filters comprising a plurality of filter matrices, and the first and second sequences of MMA operations are parts of a convolution operation for the plurality of images and the plurality of filters.

8. The system according to claim 7, wherein the activations vector and the second activations vector comprise pixels from a same image in the tensor of input activations.

9. The system according to claim 7, wherein the activations vector and the second activations vector each comprise pixels from a same plurality of images in the tensor of input activations.

10. The system according to claim 7, wherein the first plurality of activations elements and the second plurality of activations elements in the input memory are reused, without being reloaded to the input memory from another memory, as inputs to the first and second sequences of MMA operations

11. The system according to claim 1, further comprising:
a shared memory connected to the datapath circuitry through an interconnect network, wherein the input memory is connected to the shared memory.

12. The system according to claim 11, further comprising:
a tensor memory access circuitry configured to, in response to a single instruction of a first type, copy the first plurality of activation elements and additional activation elements from an external memory to the shared memory.

13. The system according to claim 12, wherein the system is further configured to:
in response to a first instruction of a second type, copy the first plurality of activation elements from the shared memory to the input memory as the activations vector; and
in response to a second instruction of the second type, copy at least one activation element from a specified location in the shared memory to a specified location in the shifted activations vector.

14. The system according to 13, wherein the system is further configured to perform the accumulating a result of the first sequence of MMA operations in the output memory and the accumulating a result of the second sequence of MMA operations in the output memory in accordance with a bitmask.

15. The system according to claim 14, wherein the bitmask is of a same length as the activations vector.

16. The system according to claim 15, wherein the bitmask is constructed in accordance with a type of layout of the tensor of input activations.

17. The system according to 13, wherein the tensor memory access circuitry is further configured to, in response to the single instruction of the first type, copy further additional elements from the external memory to the shared memory, in response to a third instruction of the second type, copy a plurality of said further additional elements from specified locations in the shared memory to specified locations in the shifted activations vector,
wherein the system is further configured to perform the accumulating a result of the second sequence of MMA operations in the output memory in accordance with shifted activations vector that includes the further additional elements.

18. A method performed in a system comprising datapath processing circuitry having a plurality of processing lanes, the method comprising:
loading a weights vector to the first input interface of the datapath processing circuitry and an activations vector to an input memory connected to a second input interface of the datapath processing circuitry, wherein the activations vector comprises a first plurality of activation elements from an activation input matrix and the weights vector comprises a first plurality of weight elements from a weights matrix; and
executing, by holding the weights vector constant, a first sequence of matrix multiply and add (MMA) operations using the activations vector and the weights vector as inputs and accumulating a result of the first sequence of MMA operations in the output memory.

19. The method according to claim 18, the method further comprising:
forming, from the activations vector in the input memory, a shifted activations vector in the input memory, wherein the shifted activations vector comprises a second plurality of activations elements that includes a subset of the first plurality of activations elements from the input memory and at least one additional activations element loaded to the input memory from another memory; and
executing a second sequence of MMA operations using the shifted activations vector and a second weights vector as inputs and accumulating a result of the second sequence of MMA operations in the output memory, wherein the second weights vector comprises a second plurality of weight elements from the weights input matrix.

20. A datapath processing method comprising:
executing a first sequence of matrix multiply and add (MMA) operations using as inputs (a) an activations vector comprising elements of a activations input matrix and (b) a weights vector comprising elements of a weights matrix, wherein the weights vector is loaded to an input of the datapath processing circuitry and held constant during the executing;
accumulating a result of the first sequence of MMA operations;
shifting the activations vector;
executing a second sequence of MMA operations using as inputs (c) a second weights vector comprising the shifted weights vector and at least one additional matrix element, and (d) a second activations vector comprising elements of the activations matrix, wherein the second weights vector is loaded to the input of the datapath processing circuitry and held constant during the executing; and
accumulating a result of the second sequence of MMA operations.
